(19) United States
(12) Patent Application Publication
(10) Pub. No.: US 2026/0266959 A1
(43) Pub. Date: Sep. 10, 2026

(54) LIDAR SYSTEM WITH RADIATIVE WAVEGUIDE ARRAY OR RADIATIVE WAVEGUIDE SURFACE AND FEED WAVEGUIDE

(71) Applicant: AUMOVIO Autonomous Mobility Germany GmbH, Ingolstadt (DE)

(72) Inventor: Markus Wintermantel, Lindau (DE)

(73) Assignee: AUMOVIO Autonomous Mobility Germany GmbH, Ingolstadt (DE)

(21) Appl. No.: 19/165,667

(22) PCT Filed: Apr. 8, 2024
(86) PCT No.: PCT/DE2024/200020

§ 371 Date: Sep. 16, 2025

(30) Foreign Application Priority Data
Apr. 13, 2023 (DE) 10 2023 203 373.9

(51) Int. Cl. G01S 7/481; G01S 7/497; G01S 17/34; G01S 17/931

(52) U.S. Cl. CPC G01S 7/4814; G01S 7/4817; G01S 7/497; G01S 17/34; G01S 17/931

(57) ABSTRACT

A lidar system sensing surroundings in which a waveguide array composed of multiple radiative waveguides each having multiple coupling points or a radiative wide waveguide surface having multiple, strip-shaped, coupling structures for transmitting and/or receiving light beams. The coupling points or coupling structures for radiative emission lie in an approximately equidistant grid, and the beam direction is swept in a first spatial direction, and the radiative waveguide array or the radiative waveguide surface is fed from a waveguide having numerous coupling points. By changing the frequency of the wave and/or the effective refractive index in this feed waveguide, the beam direction is swept in a second spatial direction, perpendicular to the first spatial direction. One of the two spatial directions is horizontal and the other is vertical and the waveguide array of the radiative waveguides or the radiative waveguide surface and also the feed waveguide are on a photonic chip.

### CROSS REFERENCE TO RELATED APPLICATIONS

This application is the U.S. National Phase Application of PCT International Application No. PCT/DE2024/200020, filed Apr. 8, 2024, which claims priority to German Patent Application No. 10 2023 203 373.9, filed Apr. 13, 2023, the contents of such applications being incorporated by reference herein.

### FIELD OF THE INVENTION

The invention relates to a lidar system in particular for sensing surroundings for motor vehicle applications. According to the invention, the lidar system has, for transmitting and/or receiving, a radiative waveguide array or a radiative waveguide surface and a feed waveguide in different arrangements, wherein two-dimensional beam sweeping is realized by means of frequency change.

### BACKGROUND OF THE INVENTION

Motor vehicles are increasingly being equipped with driver assistance systems which capture the surroundings with the aid of sensor systems and deduce automatic reactions of the vehicle and/or instruct, in particular warn, the driver as a result of the traffic situation recognized therefrom. A distinction is made between comfort and safety functions.

In the meantime, however, developments are going in an even more far-reaching direction. The driver is no longer only assisted, but rather the driver's task is increasingly being handled autonomously by the vehicle, i.e. the driver is increasingly being replaced; this is referred to as autonomous driving.

In particular, autonomous driving requires sensors with highly accurate information about the surroundings, which is easy to evaluate by machines. Radar systems are limited in their angular accuracy and separation capability and cannot satisfactorily meet these high capturing requirements on their own or even in combination with camera systems, at least not yet. For this reason, lidar systems, which have a similarly high angular resolution (horizontally and vertically) to a camera, but which additionally supply distance information and separation capability in each pixel, are also deployed in parallel. Today, so-called time-of-flight lidar systems which deal with electromagnetic radiation in the sense of particles and which can, thus, only measure the distance, but not the relative speed directly, are mostly deployed. However, the focus is now also increasingly on coherently working lidar systems which deal with electromagnetic radiation in the sense of waves (like radar systems) and, therefore, can also directly measure the relative speed of objects via the Doppler effect. Further advantages of coherent lidar systems are that they are, on the one hand, robust to extraneous radiation from other sources (e.g., due to other lidar systems or sunlight) and that, on the other hand, they have a higher sensitivity at higher distances and, therefore, allow higher ranges. In addition, coherent lidar systems are credited with a higher potential for high semiconductor integration, which promises lower manufacturing costs.

In the case of coherent lidar systems, the emitted electromagnetic wave is modulated, i.e., it changes in at least one of the parameters of amplitude, frequency or phase over time—otherwise no distance measurement would be possible. The most commonly used modulation in coherent lidar systems is linear frequency modulation (FMCW=frequency modulated continuous wave), which mostly consists of two frequency ramps, the slopes of which have opposite algebraic signs. However, said modulation does have ambiguity problems in particular in the case of multiple reflections in the same beam direction and, in addition, the production of a highly linear frequency change is complicated. Said disadvantages do not occur or occur less in the case of a phase modulation (e.g., with pseudo-random change over discrete phase values at a fixed transmit frequency), but the digital evaluation of the received signals is, however, more complicated and the approaches proposed in the prior art are associated with disadvantages, in particular in terms of sensitivity and, therefore, range. So far, no modulation forms are known which include or allow a continuous frequency change within the data acquisition of one pixel and over pixels, which would be advantageous for a beam direction change with the aid of a waveguide. The beam direction change is frequently still realized mechanically in both spatial directions, which is complicated, results in large construction forms and has disadvantages in terms of robustness. For the most part, real-valued mixers are utilized (since they require considerably less outlay compared with complex-valued mixers); however, determining the sign of the receive frequency is then, generally, problematic or not possible, so that there are two hypotheses for the relative speed and, if necessary, for the distance of objects. The potential of semiconductor integration is only insufficiently exploited in current coherent lidar systems.

### Problem, Solution and Advantages of the Invention

An aspect of the invention aims to provide, in a lidar system, a simple possibility for a two-dimensional change in the beam direction.

A core idea here is to enable two-dimensional beam sweeping solely by frequency change with the aid of a radiative waveguide array or a radiative waveguide surface and a feed waveguide.

The advantages of aspects of the invention arise in particular from the fact that a two-dimensional change in beam direction can be realized in a simple manner and potentially completely by semiconductor integration.

The lidar system according to an aspect of the invention for sensing surroundings is characterized in that, firstly, there is a waveguide array or array comprising multiple or numerous radiative waveguides, preferably of the same type and parallel, each having multiple coupling points or a radiative wide waveguide surface having multiple, in particular strip-shaped, coupling structures for transmitting and/or receiving light beams, wherein the coupling points or coupling structures serving for radiative emission preferably lie in an approximately equidistant grid, secondly by changing the frequency of the wave and/or the effective refractive index in the radiative waveguides or in the radiative waveguide surface the beam direction is swept in a first spatial direction, thirdly the radiative waveguide array or the radiative waveguide surface is fed from a waveguide having multiple or numerous coupling points, fourthly by changing the frequency of the wave and/or the effective refractive index in this feed waveguide the beam direction is swept in a second spatial direction, which is preferably perpendicular to the first spatial direction, fifthly preferably one of the two spatial directions is horizontal and the other is vertical, and sixthly preferably the waveguide array or the radiative waveguides or the radiative waveguide surface and the feed waveguide are realized on a photonic chip.

Further, the lidar system can operate in a coherent manner, wherein a continuous frequency change can preferably be superimposed on a modulation, in particular a phase modulation, wherein the continuous, in particular linear, frequency change can be carried out within and across pixels.

Furthermore, the feed waveguide can be designed at least approximately as a uniform meander and be coupled per meandering period via a connecting waveguide to a radiative waveguide of the array or to an input of the radiative waveguide surface, wherein the length of the connecting waveguides changes at least approximately linearly across the connected radiative waveguides or inputs of the radiative waveguide surface, preferably realized in that the axis of the feed waveguide runs straight and the connecting waveguides consist of one or more straight sections and one or more bends, wherein these bends are in each case of the same type across the connecting waveguides and these straight sections run parallel and have the same or a linearly varying length.

Advantageously, the feed waveguide can be designed at least approximately as a uniform meander and be coupled per meandering period via connecting waveguides to radiative waveguides of the array or inputs of the radiative waveguide surface, wherein the length respectively traveled by the wave in the feed waveguide and in the connecting waveguide changes at least approximately linearly via the connected radiative waveguides or inputs of the radiative waveguide surface, preferably realized in that the axis of the feed waveguide runs straight and the connecting waveguides consist of one or more straight sections and one or more bends optionally with the exception of the region at the feed waveguide, wherein these bends are in each case of the same type over the connecting waveguides and these straight sections run parallel and have the same or a linearly varying length.

The feed waveguide and a respective section of the connecting waveguides preferably have a width that is increased compared to the rest of the waveguides in order to reduce the conduction losses, wherein the section of the connecting waveguides with increased width respectively has such a length that the length traveled by the wave in the feed waveguide and this section of the connecting waveguide extends at least approximately linearly over the connected radiative waveguides or inputs of the radiative waveguide surface.

In an expedient embodiment of the invention, the beam direction is scanned in both spatial directions by means of a frequency change, wherein the meandering feed waveguide is much longer than the transverse extent of the radiative waveguides or of the radiative waveguide surface, so that during a scan in the first spatial direction, multiple or numerous scans are performed in the second spatial direction in order to realize a two-dimensional capturing region.

Furthermore, liquid crystal material may be located in the immediate vicinity of the radiative waveguide or the radiative waveguide surface, the connecting waveguides and/or the feed waveguide, in particular superficially above said liquid crystal material, the optical properties of which are influenced in each case by means of an applied voltage in order to determine the effective refractive index of the radiative waveguide or of the radiative waveguide surface, of the connecting waveguides and/or of the feed waveguide in order to thereby realize a change in the beam direction in the first and/or second spatial directions.

In an advantageous embodiment of the invention, different frequencies are used to change the beam direction in a coarse grid, while by changing the effective refractive index only a smaller region is scanned in each case, whereby a reduced ability to change the effective refractive index is sufficient.

Advantageously, amplitude and/or phase occupancy, i.e. so-called tapering, in amplitude and/or phase can be provided over the radiative waveguide array or the radiative waveguide surface in preferably both spatial directions, in order to minimize or avoid side lobes in the radiation, wherein the amplitude tapering is implemented via couplings of different strengths and the phase tapering is implemented via an arrangement of coupling points and/or of radiative waveguides or inputs into the radiative waveguide surface which is not exactly equidistant.

In a preferred embodiment of the invention, there are further waveguides of the same type parallel to the radiative waveguides and possibly parallel to the connecting waveguides, which are not coupled to the feed waveguides, in order to avoid or at least reduce the effects of coupling between waveguides.

Furthermore, a signal that includes a plurality of frequencies at the same time can be used such that sending and receiving occurs over a radiative waveguide array or a radiative waveguide surface in parallel in different beam directions.

Expediently, there may be a plurality of radiative waveguide arrays or radiative waveguide surfaces with associated feed waveguides which are preferably connected in series or parallel operation to the same modulated laser source and have different structures, so that they open in different beam directions at least in one spatial direction at the same frequency, whereby the required region of the change in frequency and/or effective refractive index is reduced.

In an advantageous embodiment of the invention, there are a plurality of radiative waveguide arrays or radiative waveguide surfaces with associated feed waveguides and, for beam deflection, prisms or prismatic partial regions of a larger, preferably common body are located in each case above the radiative waveguide array or radiative waveguide surfaces, in particular in order to obtain a large capturing range and/or a high resolution even in the edge regions thereof.

In the case of a lidar system in which deviations in the beam directions can occur, in particular due to misalignment, frequencies which are not precisely known and/or a dependence of the actual refractive indeces on the respective control variable, which is not precisely known, said deviations are advantageously determined from the measured radial relative speeds of stationary objects, in order to later take said deviations into account and/or to correct them.

The road surface can be expediently utilized for stationary objects, preferably with determination of its angle in the vertical direction from the measured distance and the sensor installation height.

Advantageously, devices for changing the beam direction (e.g. a focusing and beam sweeping device and/or the like) can be preferably provided and used to compensate for a misalignment and/or to adjust the capturing range adaptively, in particular depending on the traffic situation.

In a further advantageous embodiment of the invention, monitoring of the devices for changing the beam direction and/or of the devices for beam direction change, in particular for ensuring eye safety, is provided by checking changes in received signals in the respective spatial direction in terms of object reflections or in terms of the components of internal reflections and couplings as well as reflections from a cover.

### BRIEF DESCRIPTION OF THE DRAWINGS

FIG. 1 shows the coherent lidar system with binary phase modulation.

FIG. 2 shows the progression of the pseudo-random binary phase modulation.

The real part of the low-frequency, analog received signal for one object is depicted in FIG. 3.

FIG. 4 shows the two-dimensional correlation of the received signal for two objects.

The linear change in the transmit frequency during the phase modulation is depicted in FIG. 5.

FIG. 6 shows the receive frequency temporally shifted to the transmit frequency in the case of no Doppler shift (that is to say, at zero relative speed).

FIG. 7 shows the two-dimensional correlation of the received signal for two objects for a linear frequency change superimposed on the phase modulation.

FIGS. 8A-8D show the outlay-optimized hardwired digital circuit for realizing the two-dimensional correlation filtering. FIG. 8A shows an overview and FIGS. 8B-8D show the three blocks in detail.

The outlay-optimized realization of a complex-valued multiplier for an exemplary twiddle factor is depicted in FIG. 9.

FIGS. 10A-10D show the outlay-optimized hardwired digital circuit for realizing the two-dimensional correlation filtering when applying a frequency shift and decimation prior to the FFT; FIG. 10A shows an overview and the three blocks are depicted in detail in FIGS. 10B-10D.

FIG. 11 illustrates an implementation of the rotational factors for the frequency shift.

FIG. 12 shows a progression of the transmit frequency with a squared error for the ideal linear change.

FIG. 13 shows the receive frequency range over the object distance as well as, hatched, the region where ambiguity occurs in the case of a real-valued mixer due to an unknown algebraic sign.

FIG. 14 shows the receive frequency range over the object distance with an inverted modulation bandwidth.

FIG. 15 shows the receive frequency range over the object distance with an inverted and doubled modulation bandwidth.

A waveguide having equidistant coupling locations, which is used for focusing and scanning by way of a frequency change in the first spatial direction is depicted in FIG. 16.

FIG. 17 shows a temporal linear progression of the beam angle and the associated transmit frequency over which the beam angle is swept.

FIG. 18 shows a temporal progression of the beam angle having a different scanning speed and the associated transmit frequency.

FIG. 19 shows an arrangement having a waveguide and a lens for focusing in a second spatial direction in two different perspectives.

FIG. 20 shows the arrangement according to FIG. 19 with an additional prism-shaped element made of material having an electrically controllable dielectric constant for scanning in a second spatial direction.

FIG. 21 shows an arrangement having a waveguide and a transparent one-dimensional liquid crystal array for focusing and for scanning in a second spatial direction in three different perspectives.

FIG. 22 shows an arrangement having a waveguide and a reflective one-dimensional liquid crystal array for focusing and for scanning in a second spatial direction in three different perspectives.

A two-dimensional liquid crystal array is depicted in FIG. 23.

FIG. 24 shows an arrangement having 32 parallel and equidistant waveguides.

FIG. 25 shows a two-dimensional pixel field for 32 similar equidistant waveguides having a small spacing.

FIG. 26 shows a two-dimensional pixel field for 32 similar equidistant waveguides having a 32-fold larger spacing.

FIG. 27 shows a two-dimensional pixel field for 32 similar waveguides having a different spacing.

FIG. 28 shows a two-dimensional pixel field for 32 different equidistant waveguides with a small spacing and, furthermore, stepwise scanning in a second spatial direction.

FIG. 29 shows a two-dimensional pixel field for 32 different equidistant waveguides having a small spacing and continuous scanning in a second spatial direction.

FIG. 30 shows the derivation for the radial component of the relative speed of a stationary object for elevation angle 0°.

FIG. 31 shows the derivation for the radial component of the relative speed of a stationary object for any angular position as well as the derivation of the angle in the vertical direction at which the road surface is seen.

A region of the road surface which a beam hits is depicted in FIG. 32.

FIG. 33 shows a realization for three equidistant phase values having a changeover switch between three line sections of different lengths.

FIG. 34 shows a realization for four equidistant phase values having a switchable inverter and a changeover switch between two line sections of different lengths.

FIG. 35 shows a modulation sequence according to the prior art, which is sequentially composed of two subsequences.

A new modulation sequence having two periodically interleaved subsequences is depicted in FIG. 36.

FIG. 37 shows the two FFTs regarding the first modulation subsequence for the example of two objects.

FIG. 38 shows the two correlations regarding the second modulation subsequence for the example of two objects.

An alternative new modulation sequence having two periodically interleaved subsequences is depicted in FIG. 39.

FIG. 40 shows, according to an aspect of the invention, a new modulation sequence having two periodically interleaved subsequences as well as a superimposed linear frequency modulation.

FIG. 41 shows an array of radiative waveguides fed according to an aspect of the invention by a common meandering and therefore very long waveguide, whereby two-dimensional scanning via frequency can be realized.

FIG. 42 shows a first scanning pattern for two-dimensional scanning via frequency.

FIG. 43 shows a second scanning pattern for two-dimensional scanning via frequency, wherein ambiguities arise in the second spatial direction for negative angles in the first spatial direction.

FIG. 44 shows an arrangement with a pulled apart and curved meandering feed waveguide.

FIG. 45 shows an arrangement having a pulled apart and straight meandering feed waveguide for an inherent geometric consistency.

FIG. 46 shows an arrangement having a pulled apart and straight but presently oblique meandering feed waveguide for an inherent geometric consistency.

FIG. 47 shows a meandering feed waveguide, in which a plurality of connecting waveguides and hence a plurality of radiative array waveguides are coupled per meandering period.

FIG. 48 shows a complete scan pattern that is formed by three individual arrays with slightly different structures and feed waveguides that are shortened by a factor of three.

In contrast to FIG. 47, FIG. 49 shows, instead of a radiative waveguide array, a radiative wide waveguide surface which opens from the direction of its feed.

FIG. 50 shows a radiative waveguide with a voltage-controlled liquid crystal layer lying on top of it for influencing its effective refractive index and thus its beam angle; a cross section through the waveguide and its surroundings is shown on the left, and a longitudinal section thereof on the right.

FIG. 51 shows a voltage-controlled liquid crystal layer above the radiative waveguide array, by means of which the beam direction can be changed in the first spatial direction, while a meandering feed waveguide is used to scan via frequency in the second spatial direction.

FIG. 52 illustrates a possible scan pattern for the arrangement according to FIG. 51.

FIG. 53 shows a voltage-controlled liquid crystal layer above a purely straight feed waveguide, by means of which the beam direction can be changed in the second spatial direction, while the radiative waveguide array is used to scan via frequency in the first spatial direction.

FIG. 54 shows voltage-controlled liquid crystal layers both above the feed waveguide and above the radiative waveguide array, by way of which the beam directions can be changed in both spatial directions.

FIG. 55 shows a voltage-controlled triangular liquid crystal layer above the connecting waveguides, via which the beam direction can be changed in the second spatial direction; for scanning in the first spatial direction, a further liquid crystal layer lies above the radiative waveguide array.

FIG. 56 shows two mutually complementary triangular liquid crystal layers above the connecting waveguides, which are controlled with complementary voltages; in addition, the connecting waveguides are pulled apart to avoid couplings and are fed from a cascaded splitter network.

In FIG. 57, in comparison with FIG. 56, the feeding cascaded splitter network is replaced by an oblique straight waveguide.

FIG. 58 shows an arrangement according to an aspect of the invention with a planar lens for realizing parallel sending and receiving, a radiative waveguide array for frequency scanning in the first spatial direction, and connecting waveguides in between, over which two complementary triangular voltage-controlled liquid crystal layers are located for scanning in the second spatial direction.

In FIG. 59, as compared with FIG. 58, the connecting waveguides and the radiative array waveguides are replaced in each case by a wide waveguide surface which opens from the feed thereof.

In FIG. 60, in contrast to FIG. 58, a voltage-controlled liquid crystal layer, which lies over the waveguide array, is also scanned in the first spatial direction.

In FIG. 61, a voltage-controlled liquid crystal layer lies only above the radiative waveguide array, while the scanning in the second spatial direction is realized via frequency via connecting waveguides with a linearly changing length.

FIG. 62 shows an approach to parallel sending and receiving with a signal that includes multiple frequencies, as a result of which different beam directions in the first spatial direction are realized simultaneously with the aid of the radiative waveguide array; scanning in both spatial directions is realized with the help of voltage-controlled liquid crystal layers over radiative waveguide array and connecting waveguides.

### DETAILED DESCRIPTION OF EXEMPLARY EMBODIMENTS

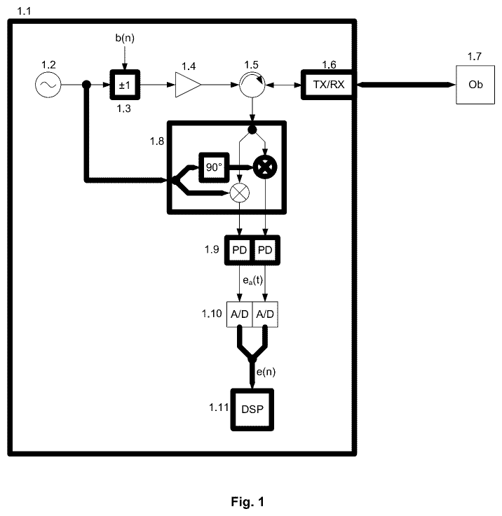

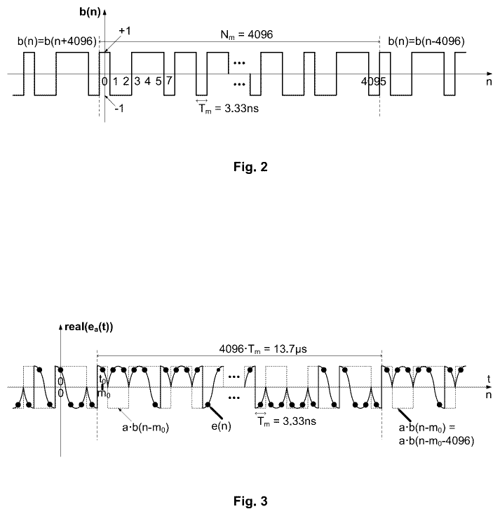

FIG. 1 schematically shows a coherent lidar system 1.1. A coherent signal in the wavelength range of roughly λ=1550 nm is produced with the laser source 1.2; the coherence length is at least multiple microseconds and the frequency is constant according to the prior art. Subsequently, the signal enters a switchable inverter 1.3, with which the algebraic sign of the signal can be changed, which corresponds to a phase shift of 180°. Changes in algebraic sign only take place in a fixed grid of, e.g., 3.33 ns and are, according to the prior art, e.g., pseudo-random, i.e., the algebraic sign is only changed with a frequency or probability of 50% following Tₘ=3.33 ns. A progression of said modulation sequence b(n), which consists of the values +1 and −1 and is also referred to as binary, is depicted in FIG. 2; it is repeated with the period Nₘ=4096, that is to say every 13.6 μs. The modulated signal passes through an amplifier 1.4, a circulator 1.5 (that is to say, a transceiver switch), is radiated via a transceiver unit 1.6 and partially reflected back from an object 1.7; with a delay which is dependent on the object distance r and, therefore, variable

$${t}_{0} = 2 r / c , \qquad ( 1 a )$$

wherein c=3·10⁸ m/s is the speed of light, and with a frequency shift which is dependent on the radial relative speed v and, therefore, variable, which is produced by the Doppler effect

$${f}_{D} = 2 v / λ \qquad ( 1 b )$$

said signal is then acquired by the transceiver unit 1.6 and is routed via the circulator 1.5 into the further receive path. In a complex-valued mixer 1.8 (also referred to as an IQ mixer), the modulated received signal is superimposed with the unmodulated laser signal and is converted with the aid of the photodiode unit 1.9 into a complex-valued, low-frequency signal; the frequency fₑ of said signal corresponds to the Doppler shift f_{D} according to relationship (1b):

$${f}_{e} = {f}_{D} = 2 v / λ , \qquad ( 2 )$$

the modulation of said signal is delayed by the signal transit time with respect to that of the transmit signal. The real part of said low-frequency, analog received signal eₐ(t) is depicted in FIG. 3 in the case of one object. Subsequently, the signal is sampled and digitized in an analog-to-digital convertor unit 1.10 with the sampling frequency fₛ=300 MHz, i.e., every Tₛ=3.33 ns—the resulting values of the real part are characterized in FIG. 3 as points; because here the sampling time Tₛ=3.33 ns and modulation time Tₘ=3.33 ns are equal, the number Ns of the sampling values per modulation period is also equal to the grid length Nₘ thereof, that is to say Nₛ=Nₘ=4096, so that a N=4096 without an index is utilized below for both. The complex-valued sampling signal e(n), also referred to hereinafter as the receive sequence, can be described as follows:

$$e ( n ) = a \cdot b ( n - {m}_{0} ) \cdot exp ( 2 π \hat{j} \cdot n / N \cdot {k}_{0} ) , \qquad ( 3 a )$$

wherein it is assumed here that the transit time to is an integral multiple m₀ of the modulation time Tₘ=3.33 ns and, therefore, the sampling time is Tₛ=3.33 ns as well:

$${m}_{0} = {t}_{0} / {T}_{m} = 2 r / c / {T}_{m} \qquad ( 3 b )$$

$$and$$

$${k}_{0} = N \cdot {T}_{s} \cdot {f}_{D} = N \cdot {T}_{s} \cdot 2 v / λ \qquad ( 3 c )$$

which corresponds to the Doppler shift is likewise integral; a is the complex-valued amplitude of the receive sequence, “exp” denotes the exponential function and ĵ is the imaginary unit.

The complex-valued receive sequence e(n) according to relationship (3) relates to an individual object without a longitudinal extent, and to an ideal receiver. In actual fact, there can be multiple and/or extended objects, and an additional noise rₑ(n) is generated in the receiver, in particular due to thermal noise; this then produces the receive sequence

$$e ( n ) = {sum}_{i = 1 , ... , I} [ {a}_{i} \cdot b ( n - {m}_{0 , i} ) \cdot exp ( 2 π \hat{J} \cdot n / N \cdot {k}_{0 , i} ) ] + {r}_{e} ( n ) , \qquad ( 4 )$$

wherein “sum_{i=1, . . . , 1}” constitutes the sum function over the index i=1, . . . , I of the I non-longitudinally extended individual objects.

The discrete transit times m_{0,i} and the discrete Doppler shifts k_{0,i} of the I objects are to be established from the receive sequence e(n) of the period of time n=0, 1, . . . , N−1. For a determination which is as accurate as possible, that is to say a separation of the signal and noise which is as good as possible and, therefore, for maximum sensitivity and range of the lidar system, so-called optimal filtering is to be applied, that is to say filtering by correlation between the receive sequence e(n) and the two-dimensional space ê_{m,k}(n) of the possible ideal amplitude-standardized receive sequences of an individual object:

$${\hat{e}}_{m , k} ( n ) = b ( n - m ) \cdot exp ( \hat{J} 2 π \cdot n / N \cdot k ) where m = 0 , ... , \\ M - 1 and k = 0 , ... , N - 1 ; \qquad ( 5 )$$

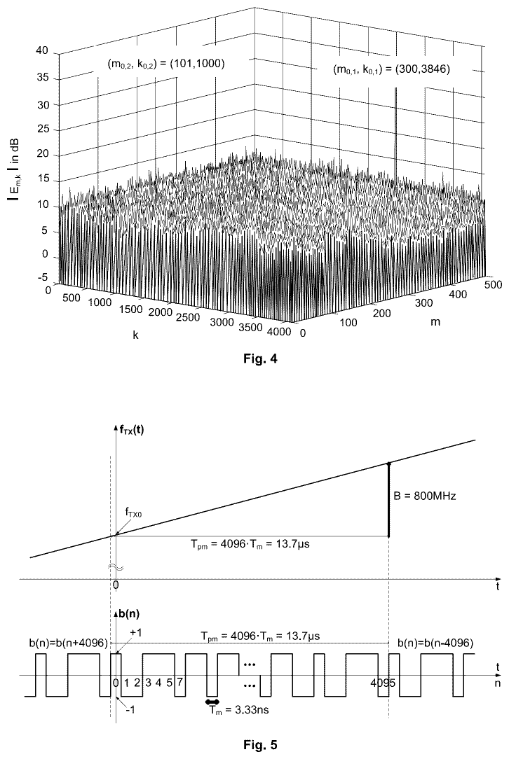

M−1 corresponds to the largest object distance which is to be assumed or is of interest, and it is assumed for the Doppler shift k that it can assume any values. This therefore produces the two-dimensional correlation E_{m,k}

$$\begin{matrix}{E}_{m , k} = {sum}_{n = 0 , ... , N - 1} ( e ( n ) \cdot conj ( {\hat{e}}_{m , k} ( n ) ) \\ = {sum}_{n = 0 , ... , N - 1} ( e ( n ) \cdot b ( n - m ) \cdot exp ( - \hat{J} 2 π \cdot n / N \cdot k ) ) , m = \\ 0 , ... , M - 1 and k = 0 , ... , N - 1\end{matrix} , \qquad ( 6 )$$

wherein “conj” denotes the complex conjugation and the modulation sequence b(n) does not change because of its real-valuedness. The correlation E_{m,k} has peaks (often also referred to as power peaks) at the positions (m,k)=(m_{0,i},k_{0,i}) of objects; FIG. 4 shows the amount of the two-dimensional correlation for two objects of the same receive amplitude at (m_{0,1},k_{0,1})=(300,3846) and (m_{0,2},k_{0,2})=(101,1000), which corresponds to their distances r₁=150 m and r₂=50.5 m and the radial relative speeds v₁=−14.2 m/s and v₂=56.8 m/s (in the case of the range k=0, . . . , N−1 unsymmetrically selected above for k, k>N/2 negative Doppler frequencies and, therefore, negative relative speeds are assigned; a negative relative speed means that the object is moving away relatively).

That is to say, in order to determine the distance r₁ and the radial relative speed v₁ of objects, the peaks of the two-dimensional correlation E_{m,k} are to be established, wherein peaks are only used, which lie above a detection threshold, in order to distinguish them from the system noise. According to relationships (3b) and (3c), rᵢ and vᵢ can be calculated from the positions of the peaks, that is to say the discrete transit times m_{0,i} and the discrete frequency shifts k_{0,i} as follows:

$${r}_{i} = {m}_{0 , i} \cdot c \cdot {T}_{m} / 2 , \qquad ( 7 a )$$

$${v}_{i} = {k}_{0 , i} \cdot λ / ( 2 N \cdot {T}_{s} ) . \qquad ( 7 b )$$

That is to say, the distance and relative speed of multiple objects can be directly and clearly determined from a modulation sequence. This is a great advantage over the linear frequency modulation frequently utilized in the case of coherent lidar systems, which has two frequency ramps, the slopes of which have opposite algebraic signs—ambiguities are unavoidable there in the case of multiple objects.

The calculation of said two-dimensional correlation and its downstream evaluation take place in the digital signal processing unit 1.11. It constitutes a high outlay with the order of N·M·N. However, the above relationship (6) can also be considered as a discrete Fourier transform over the product e(n)·b(n−m), n=0, . . . , N−1 which is to be determined for each m=0, . . . , M−1; the discrete Fourier transform (DFT) is calculated by way of the fast Fourier transform (FFT):

$${E}_{m , k} = {FFT}_{k} ( e ( n ) \cdot b ( n - m ) ) where m = 0 , ... , M - 1 , \qquad ( 8 )$$

wherein k=0, . . . , N−1 is the output dimension of the FFT, that is to say the discrete frequency, so that the computational outlay is reduced to the order of M·N·log₂(N).
Phase Modulation with Superimposed Linear Frequency Modulation

So far, it has been assumed in accordance with the prior art that the frequency on which the phase modulation sequence b(n) is imprinted is constant, that is to say does not change. The approach according to an aspect of the invention will now be considered below that the frequency changes continuously, wherein an ideal linear change is initially assumed, this is depicted in FIG. 5, where the frequency of the laser source 1.2 and, therefore, the transmit frequency f_{TX}(t) increases linearly by B=800 MHz (that is to say, with an increase of B/Tₚₘ=58.6 MHz/μs) within a modulation period of the duration Tₚₘ=N·Tₘ=13.7 μs. That is to say, the general rule for the transmit frequency f_{TX}(t) is:

$${f}_{TX} ( t ) = {f}_{TX 0} + t \cdot B / {T}_{pm} where {T}_{pm} = N \cdot {T}_{m} . \qquad ( 9 )$$

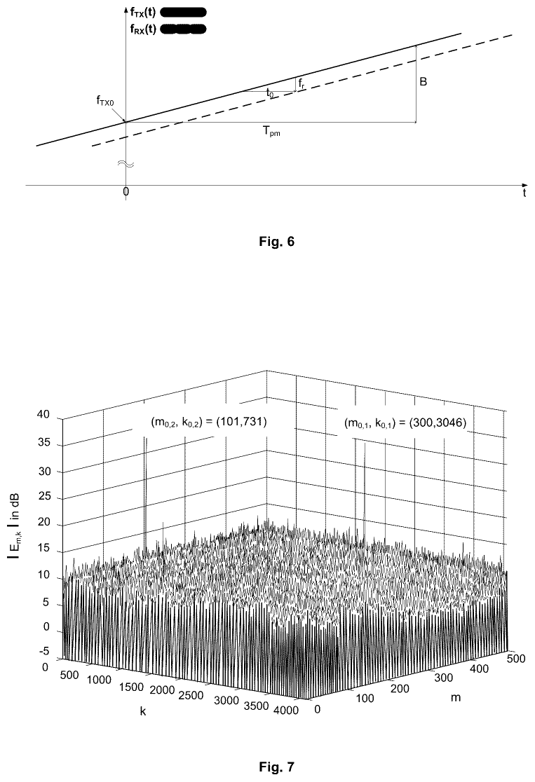

Without a Doppler shift (that is to say, if the initially assumed relative speed is zero) and, as shown in FIG. 6, the frequency f_{TX}(t) of the received signal is correspondingly delayed because of the transit time to:

$${f}_{RX} ( t ) = {f}_{TX} ( t - {t}_{0} ) = {f}_{TX 0} + ( t - {t}_{0} ) \cdot B / {T}_{pm} , \qquad ( 10 )$$

and is therefore shifted downwards with respect to the transmit frequency f_{TX}(t). Said frequency shift fᵣ due to the transit time is

$${f}_{r} = - {t}_{0} \cdot B / {T}_{pm} \qquad ( 11 a )$$

and where the transit time to according to relationship (1a) is:

$${f}_{r} = - 2 r / c \cdot B / {T}_{pm} ; \qquad ( 11 b )$$

for the example of an object distance r=150 m and, therefore, a transit time to =1 μs as well as the above modulation values, the frequency shift due to the transit time fᵣ=58.6 MHz. According to relationship (11b), the frequency shift due to the transit time fᵣ is proportional to the object distance r.

The entire frequency shift and, therefore, the frequency fₑ of the received signal following mixing is now composed of the Doppler shift f_{D} according to relationship (1b) and the above component due to the transit time fᵣ according to relationship (11b):

$${f}_{e} = {f}_{D} + {f}_{r} = 2 v / λ - 2 r / c \cdot B / {T}_{pm} . \qquad ( 12 )$$

This is a particular difference from the initially considered case of a constant transmit frequency according to the prior art. The phase modulation sequence shifted by the transit time is still imprinted on said receive frequency, so that the relationship (3a) still applies to the receive sequence e(n) following sampling and digitization, wherein the following now applies to the discrete receive frequency k₀ instead of relationship (3c):

$${k}_{0} = N \cdot {T}_{s} \cdot ( {f}_{D} + {f}_{r} ) = N \cdot {T}_{s} \cdot 2 \cdot v / λ - N \cdot {T}_{s} \cdot 2 \cdot r / c \cdot B / {T}_{pm} , \qquad ( 13 a )$$

and using the discrete transit time m₀ according to (3b) as well as Tₚₘ=N·Tₘ:

$${k}_{0} = N \cdot {T}_{s} \cdot ( {f}_{D} + {f}_{r} ) = N \cdot {T}_{s} \cdot 2 \cdot v / λ - {m}_{0} \cdot {T}_{s} \cdot B , \qquad ( 13 b )$$

wherein said discrete receive frequency k₀ is also initially assumed to be integral. Furthermore, the approach of optimal filtering, that is to say the filtering by correlation between the receive sequence e(n) and the two-dimensional space ê_{m,k}(n) of the possible ideal amplitude-standardized receive sequences of an individual object consequently remains valid, characterized by the relationship (6) and (8) for the two-dimensional correlation E_{m,k}; relationship (8):

$${E}_{m , k} = {FFT}_{k} ( e ( n ) \cdot b ( n - m ) ) where m = 0 , ... , M - 1 , \qquad ( ( 8 ) ) ,$$

that is to say the fast Fourier transforms over the respective product between the receive sequence e(n) and the respectively shifted modulation sequence b(n−m), is suitable for an outlay-effective calculation. FIG. 7 shows the amount of the two-dimensional correlation E_{m,k} for the above example of two objects having the distances r₁=150 m and r₂=50.5 m as well as the radial relative speeds v₁=−14.2 m/s and v₂=56.8 m/s; the discrete time shifts m_{0.1}=300 and m_{0.2}=101 remain unchanged, while the discrete frequency shifts according to relationship (13b) change by the components due to the transit time −m_{0,1}·Tₛ·B=−800 and −m_{0,2}·Tₛ·B=−269 to k_{0.1}=3846−800=3046 and k_{0.2}=1000−269=731.

Consequently, relationship (7a) still applies to the determination of the object distances rᵢ from the positions (m_{0,i}, k_{0,i}) of the peaks of the correlation:

$${r}_{i} = {m}_{0 , i} \cdot c \cdot {T}_{m} / 2 , \qquad ( ( 7 a ) )$$

while for the determination of the radial relative speeds vᵢ, the component due to the transit time of the discrete frequency shifts k_{0,i} is to be taken into account—with the aid of the relationship (13b), this results in:

$${v}_{i} = λ / ( 2 N \cdot {T}_{s} ) \cdot ( {k}_{0 , i} + {m}_{0 , i} \cdot {T}_{s} \cdot B ) ; \qquad ( 14 )$$

that is to say that, in contrast to the original relationship (7b), the contribution due to the transit time −m_{0,i}·Tₛ·B, which is proportional to the discrete transit time m_{0,i} is to be subtracted from the discrete frequency shift k_{0,i}.

The system approaches and the advantages which make it possible to combine a phase modulation and a changing frequency will be explained in more detail later.

### Computational Logic for Realizing the Two-Dimensional Correlation

It will first be discussed how the calculation of the two-dimensional correlation E_{m,k} can be realized in the digital signal processing unit 1.11. The previously considered receive sequence e(n) of the period of time n=0, 1, . . . , N−1 and the associated correlation E_{m,k} refer to an individual capturing direction, that is to say based on the horizontal and vertical direction, to one pixel. In actual fact, roughly 160,000 capturing directions, that is to say pixels, are covered in each capturing cycle, for which a duration of 100 ms is to initially be assumed; this is typically realized by a combination of parallel transmitter and receiver, that is to say parallel capturing of pixels, and scanning, that is to say sequential capturing of pixels. A parallel transmitter and receiver means that all of the elements 1.4-1.10 of the lidar system 1.1 in FIG. 1 (if necessary, apart from a joint focusing and beam sweeping device in the transceiver unit 1.6) exist multiple times, e.g., 32 times. The scanning can happen, e.g., thanks to continuous mechanical movement (e.g., of a mirror) or electronically, thanks to continuous changing or thanks to sequential switching (possibilities of electronic scanning will be explained later). During continuous scanning, it is also possible that pixels partially overlap, that is to say that the back ones of the N values of the receive sequence e(n) of one pixel are also utilized as front values of the next pixel. If it is now assumed that M=500 (corresponds to the maximum distance of 249.5 m in the case of the above design), then the FFT of length 4096 from relationship (8) is to be calculated 800 million times per second. It is not possible to realize this many FFT calculations by way of microprocessors or DSPs (Digital Signal Processors); the clock frequency of such processors typically lies in the range of 1 GHz, i.e., almost one complete FFT of length 4096 would have to be calculated per clock frequency, but modern processors can, as a general rule, only perform up to the order of 100 multiplications and additions per clock frequency, even when using parallel vectorial computing units, which is several orders of magnitude below the requirement for an FFT of length 4096. For this reason, it is only possible to implement this many FFTs by way of special computational logic realized in hardware. Since the FFT algorithm consists of many sub-elements which are referred to as butterflies, multiple butterflies, which contain a programmable multiplier, are frequently realized for a special computational logic of the FTT realized in hardware, since the twiddle factor to be multiplied changes over the sequence of the butterflies. However, the realization of programmable multipliers is complicated.

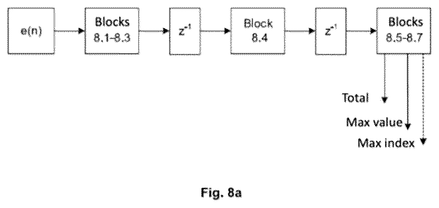

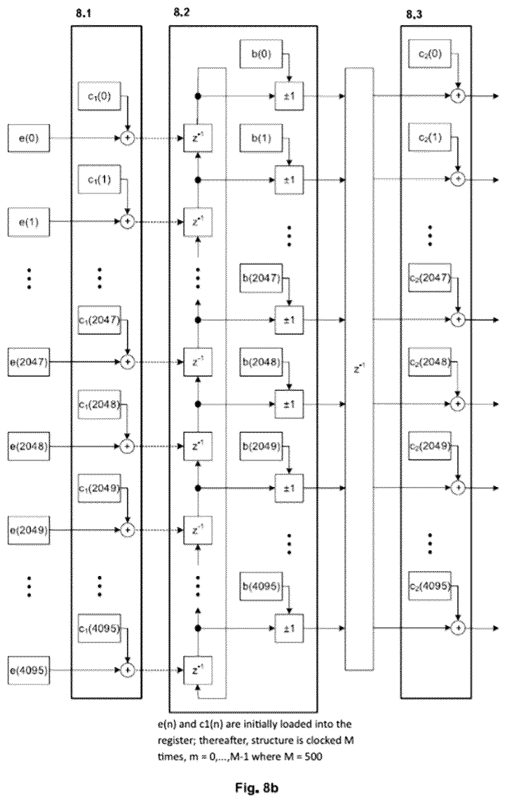

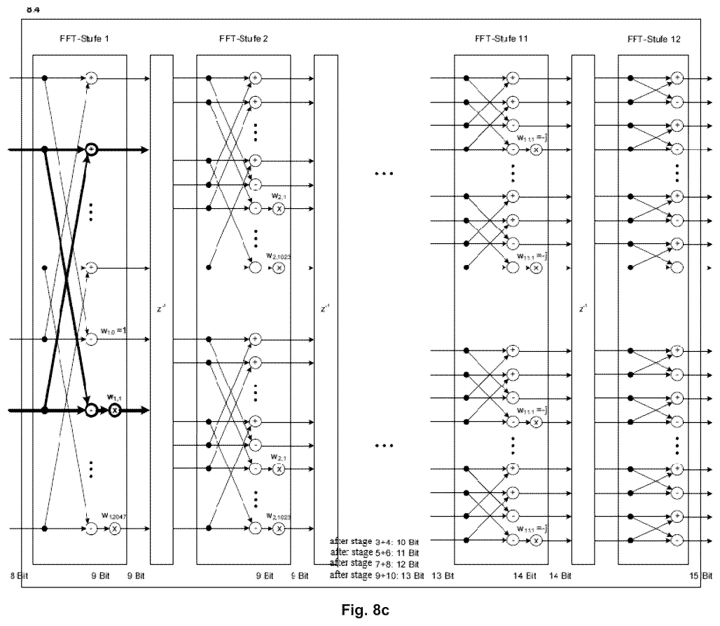

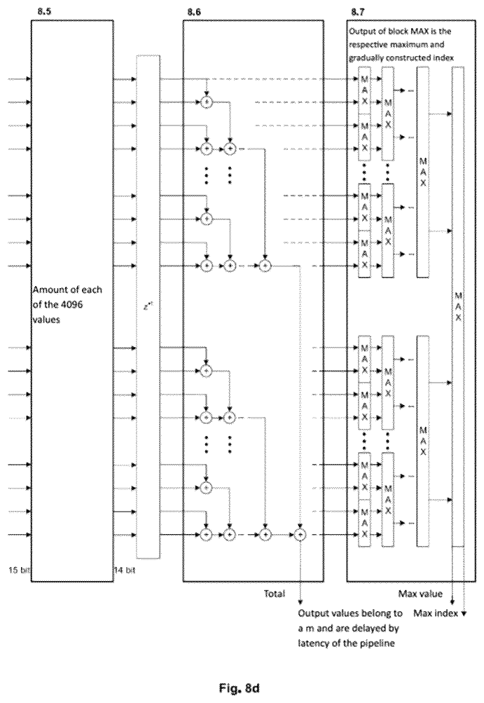

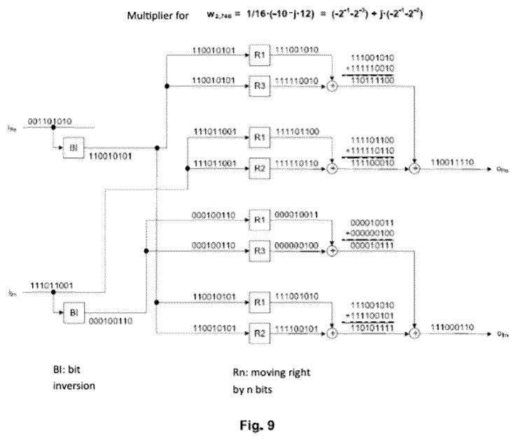

Since the number of the FFTs to be calculated per second, 800 million, roughly corresponds to the realizable clock frequency of 1 GHz of such computational logic, programmable multipliers can be dispensed with, by realizing each butterfly of the FFT and, consequently, each adder and multiplier contained therein (for the corresponding twiddle factor), in a dedicated manner, directly in the computational logic. This is depicted in block 8.4 in FIG. 8; an FFT of length 4096 consists of log₂(4096)=12 sequential stages, and in each of said stages there are 2048 butterflies which, in each case, determine two output values from two complex-valued input values via a complex-valued addition and subtraction as well as a complex-valued multiplication (in FIG. 8, a butterfly is highlighted, by way of example, by thick lines in the first FFT stage). Since the many sequential computing operations cannot be calculated in one clock frequency, registers for buffering must be inserted; such buffer memories, symbolized by the blocks z⁻¹, are inserted in FIG. 8 between each of the 12 FFT stages—in actual fact, it can be even more since, for example, the supply lines of the first stages are very long and, if necessary, further buffer memories are required there (the buffer memories adopt new values lying at their input each clock frequency). Therefore, the calculation takes place in a so-called pipeline—the calculation of an FFT runs over multiple clock frequencies and data from multiple FFTs are located in the computing circuit; each clock frequency, the input data of an FFT are fed into the computing circuit which is embodied as a pipeline, the result, that is to say the output data from said FFT, is then available at the output of the computing circuit following multiple clock frequencies, so that the result of a new FFT is obtained each clock frequency.

The multipliers represent the main outlay for realizing such computational logic. The product between complex-valued signals and the twiddle factors

$$\begin{matrix}{w}_{p , q} = exp ( - \hat{J} π \cdot {2}^{p} \cdot q / N ) \\ = cos ( π \cdot {2}^{p} \cdot q / N ) + \hat{J} \cdot sin ( - π \cdot {2}^{p} \cdot q / N ) where p = \\ 1 , ... , {log}_{2} ( N ) - 1 and q = 1 , ... , N / {2}^{p} - 1\end{matrix} , \qquad ( 15 )$$

that is to say unit indicators (amount=1), is formed in them; generally, four real-valued multipliers are needed for this. Each of these real-valued multipliers is typically realized by numerous additions of moved values. However, there is no requirement for a high degree of accuracy of the factors here; for example, an error of up to 1/32 can be tolerated, i.e., the quantized values

$${w}_{p , q} = 1 / 16 \cdot round ( 16 \cdot cos ( π \cdot {2}^{p} \cdot q / N ) ) + \hat{J} \cdot 1 / 16 \cdot round ( - 16 \cdot sin ( π \cdot {2}^{p} \cdot q / N ) ) \qquad ( 16 )$$

can be used; in this case, “round” designates the rounding function. The noise generated by said rounding at the output of the correlation E_{m,k} lies below the required dynamic range and also typically below the effect of the receiver noise; and the signal loss due to this noise can also be neglected. Therefore, multipliers by the factors ± 1/16, ±2/16, . . . , ± 15/16 still have to be realized. The multiplier by the factor 7/16 is considered as an example; due to

$$7 / 16 = 8 / 16 - 1 / 16 = 1 / 2 - 1 / 16 = {2}^{- 1} - {2}^{- 4}$$

it can be realized by a subtraction of the input value moved four places to the right from the input value moved one place to the right—this assumes a binary number representation; the above representation of 7/16 is called CSD code (Canonic Signed Digit Code). With the exception of the factors ± 11/16 and ± 13/16, all of the above factors can be realized in accordance with relationship (16) with a maximum of one addition or subtraction; in order to avoid having to deploy two additions or subtractions for said factors ± 11/16 and ± 13/16, they are approximated by ±10/16 and ±14/16, which still results in acceptable quantization noise.

The complex-valued multiplier for the twiddle factor

$${w}_{2 , 740} = 1 / 16 \cdot ( - 10 \cdot \hat{J} \cdot 12 ) = ( - {2}^{- 1} - {2}^{- 3} ) + \hat{J} \cdot ( - {2}^{- 1} - {2}^{- 2} )$$

is depicted in FIG. 9; the output value o=o_{Re}+ĵ·oₗₘ of the same length arises from the binary input value i=i_{Re}+ĵ·iₗₘ with length 9 bit, following multiplication, wherein numerical values are entered as an example. Two real-valued multipliers are to be realized in each case by one adder respectively for the real and imaginary part of the output value; thereafter, the two partial results for the real and imaginary parts are, in each case, to be added. Since the negative of the real and imaginary part of the input value is also required, an inversion takes place. Said inversion is simply realized here by bit inversion, i.e., the supplementary addition of 1, that is to say a so-called LSB (least significant bit) is omitted; the error arising can be compensated for by adding correction values to the input values of the FFT—to this end, the effect of said missing values 1 at the output of the FFT during the inversion can be determined and converted to the input via an inverse DFT. The back part is also simply omitted, including when moving the binary values to the right (for realizing the multipliers), that is to say no rounding is performed; the errors arising contain mean values, and their mean errors can also be compensated for again by way of adding correction values to the input values of the FFT. On being moved right, the bit length of the value remains unchanged; to this end, only the uppermost bit of the input value has to be extended accordingly, that is to say copied, in the case of the representation of the two complement's considered here. The process of moving to the right itself is simply realized by way of appropriate wiring and, consequently, does not require any outlay. Since the twiddle factors to be multiplied always have the amount 1, input and output values of the multipliers have the same value range; that is to say, no additional bits have to be extended upwards.

A complex-valued addition and subtraction of two complex-valued values takes place, in each case, in the butterflies; that is to say, the amount of the result can be twice as large as the amount of the input values, so that the value range has to be extended upwards by one bit. As a result, the bit length would increase by 12 over the 12 stages of the FFT. However, the noise component of the values originating from the receiver noise also increases over the additions and subtractions and, indeed, on average by √2 in terms of amplitude. That is to say that, following two stages, in each case, the noise amplitude doubles. For this reason, the least significant bit, that is to say the LSB, can be omitted in each second stage (that is to say, it is then scaled by the factor 0.5); the quantization noise generated by this lies below the effect of the receiver noise, since the value range at the input of the FFT is selected such that the receiver noise already has the amplitude of multiple LSBs there. The effect of the simple omission of the LSBs (that is to say, without rounding), that is to say the mean errors arising as a result, can also be compensated for again by adding correction values to the input values of the FFT. In the circuit according to FIG. 8, said scaling is omitted in the last stage since there are no further computing steps within the FFT, which would benefit from a reduction of the bit length; consequently, the bit length grows over the FFT from 8 bits at the input to 15 bits at the output.

According to FIG. 8, the FFT is executed in a structure with decimation in frequency (decimation-in-frequency FFT) in order to have the longest lines of the structure and the nontrivial multiplications in the front stages with their lower bit length (there are no multiplications in the back two stages; the factor-j only represents the corresponding wiring). In addition, with this structure, a resorting of the input data in the form of long lines is avoided; a resorting of the output data into their natural chronological order is not required here for the further processing. Therefore, this structure requires less realization outlay than the alternative FFT structure with decimation in time (decimation-in-time FFT).

According to relationship (8), the FFT is to be applied to the product between the receive sequence e(n) and the shifted modulation sequence b(n−m) in order to determine the correlation E_{m,k}. However, due to the cyclical nature of the modulation sequence b(n) (it has period N), the product can also be formed between the unshifted modulation sequence b(n) and the cyclically shifted receive sequence e(mod_{N}(n+m)), wherein “mod” constitutes the modulo function to module N, and the FFT applied thereto:

$${E}_{m , k} = {FFT}_{k} ( e ( {mod}_{N} ( n + m ) ) \cdot b ( n ) ) where m = 0 , ... , M - 1 ; \qquad ( 17 )$$

the values of said correlation differ from those of relationship (8) in phase, but are identical in amount and only the latter is relevant for the further evaluation, so that the same symbol is utilized here for the sake of simplicity (this relationship results from the time shift offset of the Fourier transform). The product between the cyclically shifted receive sequence e(mod_{N}(n+m)) and the modulation sequence b(n) is formed in block 8.2 in FIG. 8 and is realized via switchable inverters; for values of 1 of b(n), the input value remains unchanged, for values −1, it is simply inverted bit by bit—the effect of omitting the addition of a LSB, which is actually necessary during the inversion, is compensated for by adding correction values to the input values of the FTT in block 8.3. It should be noted that the switchable inverters are only necessary if the modulation sequences can change—if not, hard implementation of the inversion is then possible and, of course, only where it occurs. The cyclical shifting of the receive sequence is realized over the chain of the registers z⁻¹, into which the values of the receive sequence are initially loaded.

Previously, in block 8.1, correction values c₁(n) are added to the receive sequence, which is used to compensate for the effects of couplings and reflections within the lidar system or its immediate surroundings, in particular a cover; this will be discussed in even greater detail later.

As already explained above, in order to simplify calculations, pure truncation is utilized for quantization and purely bit inversion is utilized for inversion; the effects of the errors containing mean values which arise are compensated for by addition of correction values c₂(n) in block 5.3 prior to the FFT. Said correction stage could also be realized following the FFT instead of prior to the FFT.

Following the FFT, that is to say following the formation of the correlation E_{m,k}, the result is processed even further. The amount for each of the N=4096 complex values is initially formed in block 8.5. Since a high degree of accuracy is not required here, the following approximation can be utilized for the amount |i| of the complex value i=i_{Re}+ĵ·iₗₘ:

$$\vert i \vert = max ( u + v / 8 , u - u / 8 + v / 2 ) where u = max ( \vert {i}_{Re} \vert , \vert {i}_{Im} \vert ) and v = min ( \vert {i}_{Re} \vert , \vert {i}_{Im} \vert ) , \qquad ( 18 )$$

wherein “max” and “min” denote the maximum and minimum function; said calculation can be implemented with little logic outlay.

The amounts of the N=4096 values calculated in this way go both into block 8.6 for totaling and into block 8.7 for formation of the maximum. Both blocks are configured in a cascaded form; in each of the 12 stages, the sums or the maxima of value pairs are formed in each case. Required registers between the stages are not depicted.

The totaling is required to estimate the noise level in order to be able to distinguish peaks of the correlation, which are generated by objects, from noise peaks. Since there are only very few peaks generated by objects in the correlation, that is to say most of the values only represent noise, the sum following division by 4096, that is to say, moving right by 12 bits, supplies a good estimate of the noise level.

The determination of the maximum establishes the maximum amount and the associated index k over the N=4096 FFT output values for the respective time shift m (which corresponds to the distance), that is to say in the frequency shift dimension (which, in addition to the Doppler component caused by the relative speed, also has a component due to the transit time). If said maximum is above the estimated noise by a factor of at least 3, it is considered to be generated by an object; the distance and relative speed of the respective object i can be determined from the associated time shift m=m_{0,i} and the associated frequency shift index k=k_{0,i} with the aid of the relationships (7a) and (14), and its reflectivity can be determined from the level. If, as depicted in block 8.7, only the absolute maximum is determined, only the most reflective object in the respective pixel can be determined at a distance. If the aim is to cover the very unlikely case that there are two objects having different relative speeds in one pixel at one distance (that is to say, for instance, the range of half a meter), the respective maximum of multiple value blocks could also be output—due to the cascaded construction of the search for the maximum, e.g., of 8 equally long blocks. If the input data of the search for the maximum are arranged appropriately, multiple blocks can also be utilized so that an interpolation of the peak in the FFT can be performed for a more precise determination of the frequency shift; because said peak is typically seen in two adjacent FFT values (since it does not lie—as previously considered—at an integral index k₀) and, if the input data are arranged appropriately, these are in different blocks of the search for the maximum, both values are obtained thereafter.

It should also be noted that no window function, that is to say no multiplication of the input values of the FFT by a kind of bell curve, is utilized for the FFT; this would only be necessary or useful if two objects having a similar relative speed and considerably different reflectivity can occur at the same distance in one pixel and are to be separated. In particular, when no window function is utilized at the input of the FFT, the sensitivity at the output of the FFT is then reduced (that is to say, the detection capacity of objects having weak reflectivity and high distance) when the frequency shift index k₀ is not integral, that is to say the peak is divided between two adjacent FFT values. Said effect can be reduced by selecting a longer FFT length than that of its input signal, i.e., zeros are appended to the input signal, which is referred to as zero padding.

In terms of the index determination in the search for the maximum, it should be commented that this can be built up very easily bit by bit, beginning with the LSB due to the cascaded realization; at the output of each comparison of two values, in addition to the current maximum value, there is also an index value, the bit length of which corresponds to the number of the stage. The index thus arising refers to the linear numbering at the input of the search for the maximum; since the numbering at the output of the FFT is scrambled in terms of the frequency shift index k, another conversion/mapping has to be performed later.

For the output dimension of the FFT, that is to say the discrete frequency, the non-symmetrical range k=0, . . . , N−1 has been considered so far, as is generally the case; the actual frequency shift k can, however, assume both algebraic signs and is typically restricted by preceding low-pass filtering, e.g., as part of the analog-to-digital converter, wherein the range k=−N/2, . . . , +N/2 is assumed here, somewhat for the sake of simplicity, for this restriction, so that the upper half of k=0, . . . , N−1 is to be mapped for negative values by subtracting N.

In the case of the design considered here (sampling time Tₛ=3.33 ns and modulation bandwidth B=800 MHz of the linear frequency modulation), the relative speed range at the output of the FFT is approximately ±419 km/h for an object distance of zero (from relationship (14) where k_{0,i}=±N/2) and approximately −147 . . . +690 km/h for a maximum object distance of 249.5 m (from relationship (14) where k_{0,i}=±N/2 and m_{0,i}=M−1=499); therefore, the range of the relative speeds which is possible or of functional interest is completely covered and, except for negative speeds at large distances, even considerably overfilled—it will be shown later how a uniform excessive coverage of the relative speed range, that is to say for all distances, can be attained in order to realize a reduction of the FFT length with the aid of a subsequent decimation. In general, a decimation can be utilized prior to the FFT if the range of possible frequency shifts is smaller than the frequency range of the FFT, that is to say if, e.g., the sampling and modulation time is shorter and/or the length N of the modulation sequence is longer than previously considered; in the simplest case, such a decimation is carried out by formation of subtotals of the product sequence of the shifted receive sequence multiplied by the modulation sequence.

As already indicated above, a low-pass filtering of the received signal takes place following the mixer—this can happen in a dedicated filter or as part of the analog-to-digital converter (in particular, if it is realized as a delta-sigma converter). For optimal sensitivity (that is to say, optimal signal-to-noise ratio), an optimal filter is deployed therefor based on the modulation form: in the case of a rectangular modulation signal on the transmitting side, which also retains its form in the received signal (that is to say, following mixing), the impulse response of the low-pass also has said rectangular progression. Following the low-pass, a triangular progression of double the length is then obtained for the elements of the received signal-however, only exactly when the frequency shift is zero. For other frequency shifts, filtering with such a low-pass is all the less optimal (in the sense of maximum sensitivity) the larger the frequency shift; thanks to a smaller sampling time Tₛ (that is to say, higher sampling frequency), the relative range of the frequency shifts and, therefore, the loss of signal-to-noise ratio can be reduced in the case of the low-pass filtering, wherein the modulation time Tₘ can then also be selected to be higher than the sampling time in order not to significantly increase the required computational outlay in combination with a decimation prior to the FFT. Thanks to the low-pass filtering, peaks typically occur in the correlation E_{m,k} in two consecutive discrete distances m, so that an interpolation can be performed over the values of said peaks in order to determine the distance more accurately.

That is to say, at the output of the hardwired digital circuit, which is depicted in FIG. 8, information about whether and at which relative speed there is an object in the respective pixel and the distance considered in each case accumulates each clock frequency, that is to say roughly every nanosecond. The receive sequence e(n) of one pixel is loaded into the registers once and is then retained over M=500 clock frequencies with cyclical moving sideways (for the 500 different shifts m and, therefore, different distances). Following M=500 clock frequencies, the receive sequence of the next pixel is then loaded. In this way, all of the, e.g., 160,000 pixels of a capturing cycle with a 100 ms duration are gradually evaluated.

The logic of the digital circuit according to FIG. 8 mainly consists of adding—roughly 300,000 adders having the length 12 bits on average are required. Due to the ever-shrinking structural quantities of semiconductor technologies for digital circuits, the realization of such an extensive hardwired circuit is made possible-both in terms of costs and power consumption. Compared to frequency modulation in accordance with the prior art, phase modulation shifts the realization outlay for coherent lidar systems more into the digital realm (since the analog part becomes simpler, since—as explained later—no high-precision linearity of the frequency change and no complex-valued receivers are required, and—as also explained later—the frequency change overlapping the phase modulation allows an easily implementable scanning); due to the constant and rapid progress of semiconductor technology for digital circuits, this results in a more cost-optimal, i.e., less expensive solution.

Another alternative structure to FIG. 8 is to now be considered. The two-dimensional correlation E_{m,k} according to relationship (6) can also be seen as a one-dimensional temporal correlation between the receive sequence e(n) and sequence b(n)·exp(−j2π·n/N·k), which is performed for each k:

$${E}_{m , k} = {CC}_{m} ( e ( n ) , b ( n ) \cdot exp ( - \hat{J} 2 π \cdot n / N \cdot k ) ) where k = 0 , ... , N - 1 , \qquad ( 19 )$$

wherein “CCₘ” means the cyclical correlation between the two sequences of length N and where m=0, . . . , N−1 is the dimension at the output of the correlation (above, the component of discrete transit time m is already omitted in the twiddle factor, since it only influences the phase of the result, but not on the magnitude, which is here the only thing of interest). Since N>M in the design under consideration, more discrete distances m than required are processed by the cyclical correlation.

A cyclical correlation in the time range corresponds to a multiplication of the discrete Fourier transforms in the frequency range:

$${E}_{m , k} = {IFFT}_{m} ( FFT ( e ( n ) ) \cdot FFT ( b ( n ) \cdot exp ( - \hat{J} 2 π \cdot n / N \cdot k ) ) ) where k = 0 , ... , N - 1 , \qquad ( 20 )$$

wherein IFFTₘ means the inverse fast Fourier transform and m=0, . . . , N−1 is its output dimension (here, it is already assumed that the DFT is realized by way of an FFT). According to the set of frequency shifts of the Fourier transform, the factor exp(−j2π·n/N·k) applied to the modulation sequence b(n) in the time range means a shift in the frequency range, that is to say of the Fourier transform:

$${E}_{m , k} = {IFFT}_{m} ( E ( l ) \cdot B ( l + k ) ) \qquad ( 21 )$$

$$where E ( l ) = {FFT}_{l} ( e ( n ) ) , B ( l ) = {FFT}_{l} ( b ( n ) ) and k = 0 , ... , N - 1 ;$$

due to the set of frequency shifts of the Fourier transform and the cyclical nature of the discrete Fourier transform, the following further transformations can be conducted for the amount of the correlation:

$$\begin{matrix}\vert {E}_{m , k} \vert = \vert {IFFT}_{m} ( E ( l - k ) \cdot B ( l ) ) \vert \\ = \vert {IFFT}_{m} ( E ( {mod}_{N} ( l - k ) ) \cdot B ( l ) ) \vert\end{matrix} \qquad ( 22 )$$

$$where E ( l ) = {FFT}_{l} ( e ( n ) ) , B ( l ) = {FFT}_{l} ( b ( n ) ) and k = 0 , ... , N - 1.$$

This relationship can be converted into a structure similar to that depicted in FIG. 8. Input values of the structure are the FFT of the receive sequence which is to be calculated in advance. It is multiplied, in a form cyclically shifted by k, by the previously determined FFT of the modulation sequence b(n). This is followed by an inverse FFT (IFFT), which differs from the FFT only in the algebraic sign of the twiddle factors; the output dimension of said IFFT is the distance dimension m (in the case of the structure according to FIG. 8, it is the frequency shift dimension k), i.e., for a discrete frequency shift k, the two-dimensional correlation E_{m,k} is present over the distance dimension m=0, . . . , N−1. This is then followed again by an absolute-value formation and then a totaling and maximum formation, now over the distance dimension. It is true that there can be multiple reflections having a different distance in one pixel, but the probability that these have the same frequency shift (which is composed of contributions of relative speed and distance) is low, so that here as well the determination of the absolute maximum is sufficient; as an example, the case of fog plus, if necessary, a stationary object in one pixel is considered: it is true that all reflections then have the same relative speed, but they have a different frequency shift due to the different distance. The distance and relative speed of the respective object i can again be determined from the maxima lying above the detection threshold with indices m=m_{0,i} and k=k_{0,i}, with the aid of the relationships (7a) and (14).

If the same modulation sequence b(n) is always utilized, the multipliers can be implemented in a hardwired form for the realization of the product E(mod_{N}(I−k)). B(I)—thanks to approximation and CSD representation, only a small realization outlay is then necessary. If the modulation sequence changes, programmable multipliers can be necessary, which mean considerably more implementation outlay.

As explained above, in the case of N>M (N≈8M) assumed here, many more discrete distances m=0, . . . , N−1 than required are processed as a general rule. This can be circumvented by carrying out a decimation prior to the IFFT—in the case of a decimation by the factor 8, only 512 values then arise from the N=4096 values, which are fed into the IFFT; in the simplest case, the decimation is realized by adding, in each case, 8 adjacent values. Therefore, instead of the original dimension 4096, the IFFT only has the dimension 512 and, therefore, requires much less realization outlay; with its length 512, the full distance range of length M=500 is also still covered.

However, it should be taken into account that such a structure has to be cycled through N=4096 times per pixel (this is how many shifts have to be carefully calculated for the FFT of the input signal); that is a good factor 8 more than in the structure according to FIG. 8, which, with a clock rate of roughly 1 GHz, does however already lie at the maximum of what can be realized. For this reason, this alternative structure to relationship (22) would have to be built up multiple times, which more than nullifies the advantage of the shorter length of the IFFT. Such an alternative structure then makes sense if the product of the sampling length N (and therefore, according to the previously considered design of the modulation length) and the number of pixels is so low that the structure is only required a few times, preferably once.

### Optimized Computational Logic Using Twiddle Factors and Decimation

As explained above, the entire frequency shift and, therefore, the frequency fₑ of the received signal is composed of the Doppler shift and the component due to the transit time generated by the linear frequency modulation following mixing:

$${f}_{e} = {f}_{D} + {f}_{r} = 2 v / λ - 2 r / c \cdot B / {T}_{pm} , \qquad ( ( 12 ) )$$

and the following applies to the discrete frequency k₀ of the receive sequence e(n):

$${k}_{0} = N \cdot {T}_{s} \cdot ( {f}_{D} + {f}_{r} ) = N \cdot {T}_{s} \cdot 2 \cdot v / λ - {m}_{0} \cdot {T}_{s} \cdot B . \qquad ( ( 13 b ) )$$

The component due to the transit time (the second component for distance r or discrete transit time m₀ in the above relationships) results in the frequency range relevant for the evaluation depending on the distance and increasing therewith (relative to the frequency value with highest magnitude and in particular at greater distances). This means that a longer FFT and, therefore, more outlay is effectively required for the calculation structure according to FIG. 8, compared to pure phase modulation, that is to say no additional linear frequency modulation. This problem can be solved by eliminating the frequency component due to the transit time−m₀·Tₛ·B prior to the FFT; this will now be briefly derived, for which reason the two-dimensional correlation E_{m,k} according to relationship (6) is transformed as follows:

$$\begin{matrix}{E}_{m , k} = {sum}_{n = 0 , ... , N - 1} ( e ( n ) \cdot b ( n - m ) \cdot exp ( - \hat{J} 2 π \cdot n / N \cdot k ) ) , m = \\ 0 , ... , M - 1 and k = 0 , ... , N - 1 , \\ = {sum}_{n = 0 , ... N - 1} ( [ e ( n ) \cdot b ( n - m ) \cdot exp ( + \hat{J} 2 π \cdot n / N \cdot m \cdot {T}_{s} \cdot B ) ] \cdot \\ exp ( - \hat{J} 2 π \cdot n / N \cdot [ k + m \cdot {T}_{s} \cdot B ] ) ) \\ = {sum}_{n = 0 , ... , N - 1} ( [ e ( n ) \cdot b ( n - m ) \cdot exp ( + \hat{J} 2 π \cdot n / N \cdot m \cdot {T}_{s} \cdot B ) ] \cdot \\ exp ( - \hat{J} 2 π \cdot n / N \cdot \underline{k} ) )\end{matrix} \qquad ( ( 6 ) )$$

$$\begin{matrix}where \underline{k} & = & k + m \cdot {T}_{s} \cdot B & ( 23 ) \\ & = & {FFT}_{\underline{k}} ( [ e ( n ) \cdot b ( n - m ) ] \cdot exp ( + \hat{J} 2 π \cdot n / N \cdot m \cdot {T}_{s} \cdot B ) ) ; & ( 24 ) \\ & & & \end{matrix}$$

that is to say that the output dimension of the FFT is now the discrete frequency k, so that according to relationships (13b) and (24) the position k₀ of FFT peaks only corresponds to the relative speed of the respective object:

$${\underline{k}}_{0} = N \cdot {T}_{s} \cdot 2 \cdot v / λ . \qquad ( 25 )$$

The product between the receive sequence e(n) and the shifted modulation sequence b(n−m) is to be multiplied by the twiddle factors

$${d}_{n , m} = exp ( + \hat{j} 2 π \cdot n / N \cdot m \cdot {T}_{s} \cdot B ) \qquad ( 26 )$$

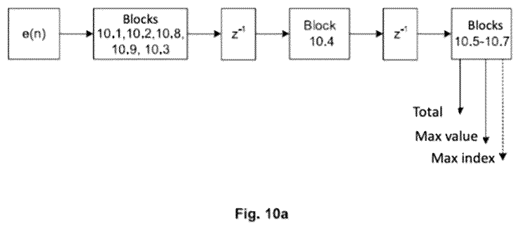

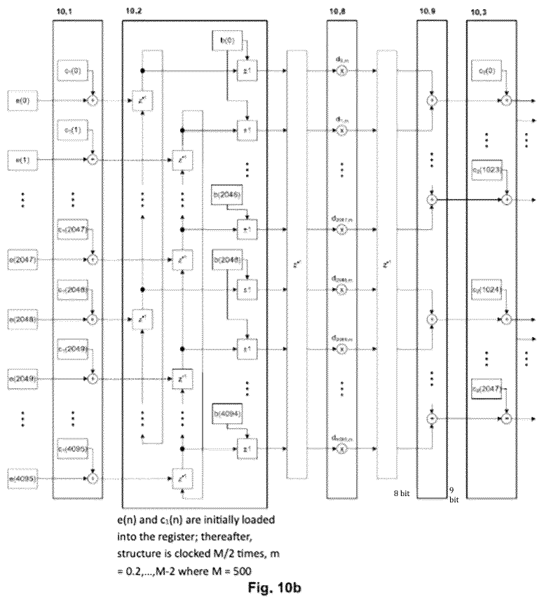

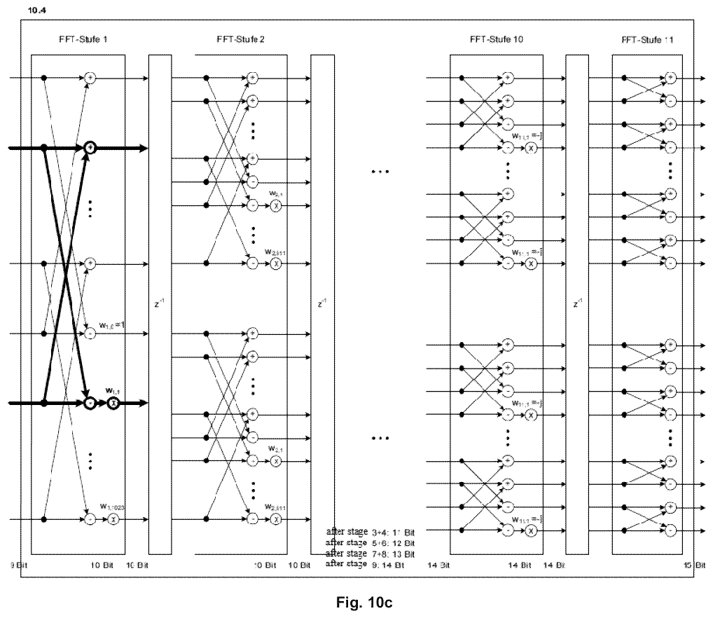

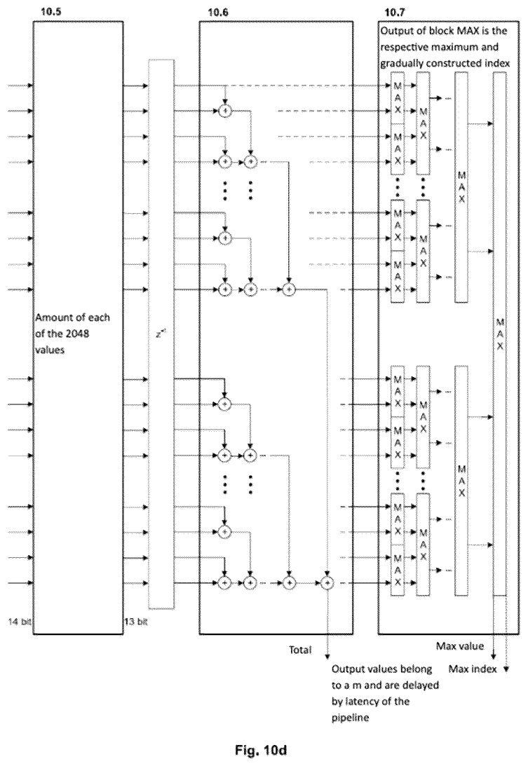

prior to the FFT. Said multiplication takes place in block 10.8 of the calculation structure depicted in FIG. 10, that is to say before the start of the FFT with the addition of correction values c₂(n) taking place in block 10.3 for errors containing mean values within the FFT by truncation and purely bit inversion, blocks in FIG. 10, which are substantially unchanged with respect to the calculation structure according to FIG. 8 (they primarily only change in dimension), are characterized by the same subnumbers. 0.1-0.7.

In the case of an unchanged dimension N=4096 of the FFT, which opens up the range k=−N/2, . . . , N/2 for the discrete frequency k, approximately the range ±419 km/h (from v=λ)/(2N·Tₛ)·k where k=±N/2) results for the relative speed v, which range lies considerably above the relevant speed range of, for example, vₘᵢₙ=−80 km/h to vₘₐₓ=+280 km/h—higher relative speeds, as regards amount, than for objects moving away (negative sign) are functionally relevant for objects moving relatively towards one another (positive sign of v). The corresponding asymmetrical range for the frequency k can be transferred by a corresponding shift by the offset frequency

$${\underline{k}}_{offset} = N \cdot {T}_{s} \cdot 2 \cdot ( {v}_{m ax} + {v}_{m i n} ) / 2 / λ = N \cdot {T}_{s} \cdot ( {v}_{m ax} + {v}_{m i n} ) / λ \qquad ( 27 )$$

into the frequency

$$\underline{\underline{k}} = \underline{k} - {\underline{k}}_{offset} \qquad ( 28 )$$

with a symmetrical range; with relationships (23) and (27), the following is obtained for this transit time-corrected and centered frequency:

$$\underline{\underline{k}} = k + m \cdot {T}_{s} \cdot B - N \cdot {T}_{s} \cdot ( {v}_{m ax} + {v}_{m i n} ) / λ . \qquad ( 29 )$$

When using said frequency k for the FFT, the two-dimensional correlation E_{m,k} is obtained similarly to the derivation of its representation according to relationship (24):

$$\begin{matrix}{E}_{m , k} = {FFT}_{{k}_{=}} ( [ e ( n ) \cdot b ( n - m ) ] \cdot exp ( + \hat{j} 2 π \cdot n / N \cdot [ m \cdot {T}_{s} \cdot B - {\underline{k}}_{offset} ] ) ) \\ = {FFT}_{{k}_{=}} ( [ e ( n ) \cdot b ( n - m ) ] \cdot exp ( + \hat{j} 2 π \cdot n / N \cdot [ m \cdot {T}_{s} \cdot B - N \cdot {T}_{s} \cdot \\ ( {v}_{m ax} + {v}_{m i n} ) / λ ] ) )\end{matrix} \qquad ( 30 )$$

so that prior to the FFT, the product sequence e(n)·b(n−m) is to be multiplied by the modified twiddle factors

$$\begin{matrix}{d}_{n , m} = exp ( + \hat{j} 2 π \cdot n / N \cdot [ m \cdot {T}_{s} \cdot B - {\underline{k}}_{offset} ] ) \\ = exp ( + \hat{j} 2 π \cdot n / N \cdot [ m \cdot {T}_{s} \cdot B - N \cdot {T}_{s} \cdot ( {v}_{m ax} + {v}_{m i n} ) / λ ] )\end{matrix} \qquad ( 31 )$$

The symmetrical range k=−881, . . . , +881 results for said frequency k at the output of the FFT for the exemplary relative speed range of vₘᵢₙ=−80 km/h to vₘₐₓ=+280 km/h. Said range is smaller than half the FFT length N/2=2048, so that a decimation by the factor of 2 can be performed prior to the FFT. In the simplest case, this can happen—as depicted in block 10.9 of FIG. 10—by adding, in each case, two consecutive values of the N values in total (due to the summation of two values, the required bitlength increases by 1). The N/2 total values then form the input values of the FFT, upstream of which is the block 10.3 for adding correction values c₂(n). Due to the halved length N/2=2048, the FFT has one less stage, that is to say only 11 stages (see FFT block 10.4 in the calculation structure according to FIG. 10). The frequency k at the output of the FFT only extends over the range k=0, . . . , N/2−1. The following blocks 10.5-10.7 for absolute-value formation, totaling and/or maximum formation likewise only have half the dimension N/2=2048.

As explained above, roughly 160,000 pixels are to be covered with the calculation structure; according to previous considerations, M=500 shifts m between the receive sequence and the modulation sequence are to be carefully calculated per pixel, which requires M=500 clock frequencies. In the case of a maximum realizable clock frequency of the computational logic of roughly 1 GHz, only one capturing cycle of roughly 100 ms is then possible (a certain overhead, e.g., for loading data and reconfiguring the system, is also taken into account). In actual fact, however, a cycle time of 50 ms is frequently required, which would then require the calculation structure to be realized twice. In order to avoid this, the modulation time Tₘ can be effectively doubled in order to only have to carefully calculate half as many shifts per pixel; this effective doubling can also be defined by the fact that, in the case of an unchanged Tₘ=3.33 ns, two consecutive values of the modulation sequence b(n) are, in each case, equal:

$$b ( n + 1 ) = b ( n ) where n = 0 , 2 , 4 , … , N - 2 , \qquad ( 32 )$$

with which the sampling time Tₛ and modulation time Tₘ are then still equal, and, therefore, the receive sequence e(n) and the modulation sequence b(n) still refer to the same discrete time n. The only difference in the above considerations and relationships is that now only every second value, that is to say only even-numbered values m=0, 2, 4, . . . , M−2, are to be considered for the shifts m. The representation of the two-dimensional correlation E_{m,k} underlying the calculation structures, in which the receive sequence is shifted instead of the modulation sequence, is then similarly to relationship (17) using the above relationship (30) as well as taking the decimation into account, and due to the irrelevance of a time shift (since only the magnitude of E_{m,k} is of interest), as follows:

$${E}_{m , k} = {FFT}_{{k}_{=}} ( s ( n ) \cdot exp ( + \hat{j} 2 π \cdot n / N \cdot [ m \cdot {T}_{s} \cdot B - {\underline{k}}_{offset} ] ) ) \\ where \\ s ( n ) = e ( {mod}_{N} ( n + m ) ) \cdot b ( n ) + e ( {mod}_{N} ( n + 1 + m ) ) \cdot b ( n + 1 ) , \\ n = 0 , 2 , 4 , … , N - 2 , m = 0 , 2 , 4 … , M - 2 \\ and \\ \underline{\underline{k}} = 0 , … , N / 2 - 1. \qquad ( 33 )$$

The product formation between the cyclically shifted receive sequence e(mod_{N}(n+m)) and the modulation sequence b(n) according to relationship (33) is depicted in block 10.2; the upstream addition of the correction values c₁(n) according to block 10.1 remains unchanged from the original structure according to FIG. 8.

Since the structure according to FIG. 10 only has to be clocked through M/2=250 times per pixel, that is to say half as often as the original structure according to FIG. 8, half the cycle time of 50 ms is made possible; moreover, the realization outlay is only roughly half as great, since the data dimension is halved for the essential blocks.

So far, the simplest realization by adding two consecutive values has been considered for the decimation. The first-order low-pass filter thereby realized (that is to say, length 2) has a large transition region having a less steep edge; on the one hand, this results in a significant change in the level in the relevant frequency range k=−881, . . . , +881 (by 2.15 dB between k=0 and k=±881), and, on the other hand, in a loss of sensitivity following decimation due to noise folding in from higher frequencies (up to 2.15 dB at k=±881). Its transition region can be made sharper by a higher order low-pass filter; in the case of a third order low-pass filter having the four coefficients [0.5, 1, 1, −0.5], the level difference is only 0.91 dB and the maximum sensitivity loss is 1.88 dB. Said third-order low-pass filter requires three additions, but still no multiplications, since the coefficients having the amount 0.5 can be realized by moving to the right by one bit, that is to say with pure wiring (for the negative sign of the coefficient −0.5, a bit inversion can again be utilized for the sake of simplicity). With high-order low-pass filters and coefficients which do not lie in a power of two grids (that is to say, require one or more additions themselves), considerably sharper edges can be realized. It should also be noted that frequencies k above ±881 can fundamentally also be considered and established (and, consequently, relative speeds outside the corresponding range −80 km/h, . . . , +280 km/h); however, level and sensitivity losses then increase and, above k=±1024, ambiguities arise (since frequencies are reflected in the range below ±1024).

The realization of the multiplications by the twiddle factors d_{n,m} described in relationship (31) will now be explained, that is to say unit vectors having phases from the full angular range 0 . . . 2π. The phases of the twiddle factors do not have to be realized with arbitrary precision, but rather the phase which is closest to the real phase of d_{n,m} from a limited set of phases can be used. The simplest approach would be to realize only the four phases 0, π/2, π and 3π/2, that is to say the twiddle factors 1, ĵ, −1 and −ĵ, which does not require any multiplication; however, the ensuing effects cannot then be neglected, that is to say the effective loss of sensitivity as well as noise generated at the output of the FFT or pseudo peaks. For this reason, the approach with the 8 phase values 0, π/4, . . . , 7π/4 is considered below, i.e., the realized twiddle factors are

$${\underline{d}}_{n , m} = exp ( + \hat{j} π / 4 \cdot {mod}_{8} ( round ( 8 \cdot n / N \cdot [ m \cdot {T}_{s} \cdot B - {\underline{k}}_{offset} ] ) ) ) . \qquad ( 34 )$$

Consequently, in addition to the simple twiddle factors ±1 and ±ĵ, there are the twiddle factors (±1±ĵ)/√2. The factor 1/√2=0.707 can be approximately realized by 1−2⁻²=0.75, that is to say effectively by an addition (in addition to inverting and moving to the right by 2 bits, which can be implemented easily or without outlay).

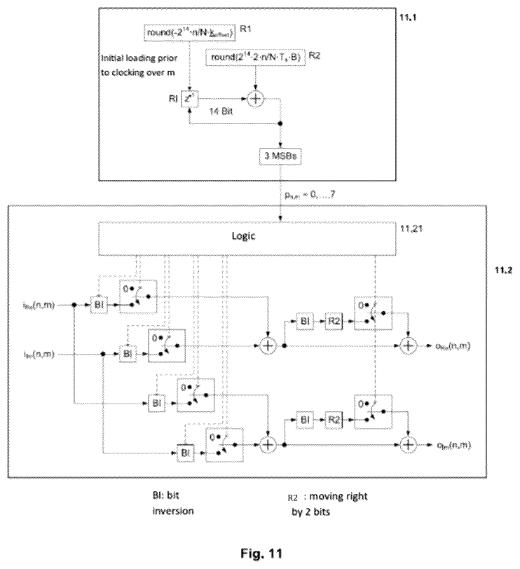

Since the twiddle factors d_{n,m} change over the shift m, that is to say when clocking through the computational logic, a programmable structure is required for their realization, which is depicted by way of example in block 11.2 of FIG. 11 for an n (in total, this structure exists N=4096 times). The complex output value with real part O_{Re}(n,m) and imaginary part oₗₘ(n,m) is formed from a complex input value with a real part i_{Re}(n,m) and imaginary part iₗₘ(n,m), by multiplying by a twiddle factor d_{n,m}; depending on which of the 8 twiddle factors

$${\underline{d}}_{p = 0 , … , 7} = 1 , 0.75 \cdot ( + 1 + \hat{j} ) , \hat{j} , 0.75 \cdot ( - 1 + \hat{j} ) , - 1 , 0.75 \cdot ( - 1 - \hat{j} ) , \hat{j} , 0.75 \cdot ( + 1 - \hat{j} ) \qquad ( 35 )$$

is to be used, the 6 changeover switches (between the value 0 or the respective input value) and the 4 switchable bit inverters from logic 11.21 are controlled. In said logic, the 10 required binary switching signals are calculated from the respective discrete phase value p_{n,m}=0, . . . , 7, that is to say, from 3 bit, lying at the input. The respective value p_{n,m}, that is to say, according to relationship (34):

$${p}_{n , m} = {mod}_{8} ( round ( 8 \cdot n / N \cdot [ m \cdot {T}_{s} \cdot B - {\underline{k}}_{offset} ] ) ) \\ where m = 0 , 2 , 4 … , M - 2 , \qquad ( 36 )$$

is determined in block 11.1 with the aid of an integrator (that is to say, a first-order recursive structure); the linear component with regard to the shift m (that is to say, which increases gradually during clocking through of the calculation structure) is realized by recursively adding the value in the register R2, the constant component (for −k_{offset}) is realized by initially loading the integrator register R1 from the register R1. The two values round (−2¹⁴·n/N·k_{offset}) and round (2¹⁴·2·n/N·Tₛ·B) of the registers R1 and R2 are scaled, with respect to those in relationship (36), by a factor of 211, that is to say effectively calculated with 11 decimal places, in order to attain sufficient accuracy, in particular during the successive integration of the value of register R2 (said value is, of course, integrated M/2=250 times, i.e., the initial rounding error of said register value is increased by a factor of 250; and it should be noted that due to the use of only even-numbered values of m, the additional factor 2 in round (2¹⁴·2·n/N·Tₛ·B) is necessary). Since the integrator is realized with 14 bits in arithmetic with two's complement and, consequently, ignores overflow over an effective value of 8, it inherently executes the modulo formation according to relationship (36). Quantization to the range p_{n,m}=0, . . . , 7 is realized by using the upper 3 bits, that is to say, the 3 MSBs; in actual fact, however, the rounding according to relationship (36) is not implemented as a result, but rather a truncation, which differs from rounding on average by 0.5—since said average error is made over all N twiddle factors (n=0, . . . , N−1), it only means a constant phase shift, which is not relevant from a functional point of view (a constant phase shift of the input data of the FFT only causes a constant phase shift of the FFT output data, with which the amount thereof, that is to say the only relevant size thereof, does not change).

Consequently, the realization of the multiplication by the twiddle factors d_{n,m} according to FIG. 11 only requires little outlay. With a little more outlay, a normal complex-valued multiplier (consisting of 4 real-valued multipliers) could alternatively also be used for programmable factors of length 3 bits (that is to say, for values −1, −0.75, . . . , 0.5, 0.75); because the value +1 cannot be realized, a scaling of the twiddle factors, e.g., by a factor of 0.875, can be advantageous. The factors to be applied, in each case, to the four real-valued multipliers can be deduced from the respective value p_{n,m} with the aid of a logic, similarly to FIG. 11, wherein said value can also be longer than 3 bits (since more than 8 different twiddle factors can be realized with such a multiplier).

### Compensating for a Non-Linear Frequency Progression

So far, an ideal linear progression has been assumed for the transmit frequency f_{TX}(t):

$${f}_{TX} ( t ) = {f}_{TX 0} + t \cdot B / {T}_{pm} \\ where {T}_{pm} = N \cdot {T}_{m} . \qquad ( ( 9 ) )$$

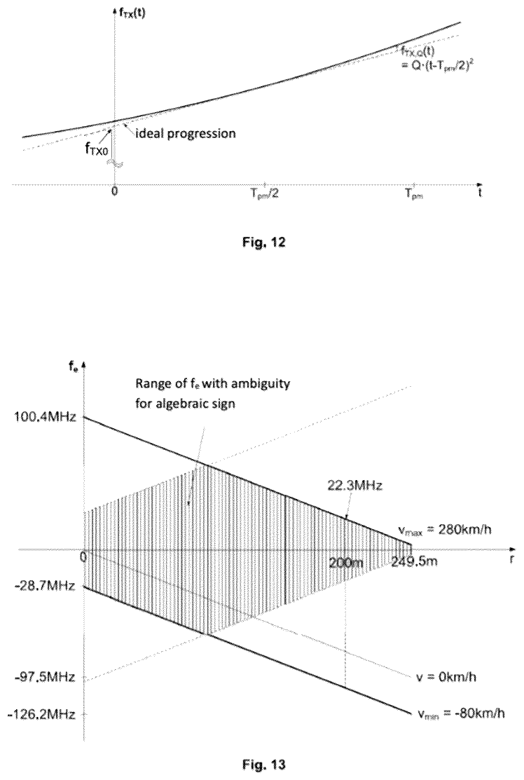

In reality, however, the modulation will not be perfect; it frequently has a squared error, as illustrated in FIG. 12

$${f}_{TX , Q} ( t ) = Q \cdot {( t - {T}_{pm} / 2 )}^{2} \qquad ( 37 a )$$

and the following is obtained for the transmit frequency:

$${f}_{TX} ( t ) = {f}_{TX 0} + t \cdot B / {T}_{pm} + Q \cdot {( t - {T}_{pm} / 2 )}^{2} . \qquad ( 37 b )$$

Without a Doppler shift, the receive frequency f_{TX}(t) corresponds to the transmit frequency f_{TX}(t−t₀) shifted by the transit time to; the following is then obtained for the frequency shift due to the transit time fᵣ(t) between the receive and transmit frequencies:

$$\begin{matrix}{f}_{r} ( t ) = {f}_{RX} ( t ) - {f}_{TX} ( t ) = {f}_{TX} ( t - {t}_{0} ) - {f}_{TX} ( t ) = \\ = {f}_{TX 0} + ( t - {t}_{0} ) \cdot B / {T}_{pm} + Q \cdot {( t - {t}_{0} - {T}_{pm} / 2 )}^{2} - [ {f}_{TX 0} + \\ t \cdot B / {T}_{pm} + Q \cdot {( t - {T}_{pm} / 2 )}^{2} ] \\ = - {t}_{0} \cdot B / {T}_{pm} - Q \cdot 2 ( t - {T}_{pm} / 2 ) \cdot {t}_{0} + Q \cdot {t}_{0}^{2}\end{matrix} ; \qquad ( 38 )$$

the two back terms describe the error

$${f}_{r , Q} ( t ) = {f}_{TX , Q} ( t - {t}_{0} ) - {f}_{TX , Q} ( t ) \qquad ( 39 a )$$

of the frequency shift due to the transit time (which is not contained in the frequency shift according to relationship (11a) for ideal linearity):

$${f}_{r , Q} ( t ) = - Q \cdot 2 \cdot ( t - {T}_{pm} / 2 ) \cdot {t}_{0} + Q \cdot {t}_{0}^{2} . \qquad ( 39 b )$$

Following mixing and digitization, said error is transferred directly to the receive sequence e(n), that is to say, into the error k_{0,Q} of the discrete receive frequency and similarly to relationship (13a) this results in:

$${k}_{0 , Q} = N \cdot {T}_{s} \cdot {f}_{r , Q} ( t ) = N \cdot {T}_{s} \cdot ( - Q \cdot 2 \cdot t \cdot {t}_{0} + Q \cdot {T}_{pm} \cdot {t}_{0} + Q \cdot {t}_{0}^{2} ) ,$$

and where t=n·Tₛ (where n=0, . . . , N−1), t₀=m₀·Tₘ (see also relationship (3b)) and Tₚₘ=N·Tₘ:

$${k}_{0 , Q} ( n ) = Q \cdot {N}^{2} \cdot {T}_{m}^{2} \cdot {T}_{s} \cdot {m}_{0} + Q \cdot N \cdot {T}_{m}^{2} \cdot {T}_{s} \cdot {m}_{0}^{2} - Q \cdot 2 \cdot N \cdot {T}_{m} \cdot {T}_{s}^{2} \cdot {m}_{0} \cdot n \qquad ( 40 )$$

$$where n = 0 , … , N - 1.$$

Over the N values of the receive sequence e(n), the first two terms are constant, i.e., they constitute a constant frequency error and only shift the position of the peak in the frequency dimension k in the two-dimensional correlation E_{m,k}; in contrast, the last term changes linearly over the discrete time n, i.e., the frequency changes during the receive sequence, which results in a broadened peak in the frequency dimension k in the two-dimensional correlation E_{m,k}—the width is roughly Q·2·N²·Tₛ²·Tₘ·m₀. The shift and broadening of the peak increase with the discrete transit time m₀, that is to say with the object distance. While the effect of the shift can easily be taken into account during the conversion of the frequency k₀ into relative speed, the broadening results in a loss of sensitivity (the height of the peak is reduced), in a less precise determination of the position of the peak and, therefore, the relative speed, and in a poorer separation of two objects having similar relative speeds at the same distance.

It is explained below how this broadening of the peak can be avoided. The phase error results from the frequency error f_{r,Q}(t) according to relationship (39)

$${φ}_{r , Q} ( t ) = 2 π \cdot {f}_{r , Q} ( t ) = 2 π \cdot ( {f}_{TX , Q} ( t - {t}_{0} ) - {f}_{TX , Q} ( t ) ) \qquad ( 41 a )$$

$$= - 2 π \cdot Q \cdot {t}_{0} \cdot {t}^{2} + 2 π \cdot Q \cdot {T}_{pm} \cdot {t}_{0} \cdot t + 2 π \cdot Q \cdot {t}_{0}^{2} \cdot t ; \qquad ( 41 b )$$

In the case of said integration, the integration constant is omitted because a constant phase component is not functionally relevant. The following is obtained in a representation for the discrete time n, where t=n·Tₛ, t₀=m₀·Tₘ and Tₚₘ=N·Tₘ:

$${φ}_{r , Q} ( t ) = - 2 π \cdot Q \cdot {T}_{m} \cdot {T}_{s}^{2} \cdot {m}_{0} \cdot {n}^{2} + 2 π \cdot Q \cdot {T}_{m}^{2} \cdot {T}_{s} \cdot {m}_{0} \cdot n + 2 π \cdot Q \cdot {T}_{m}^{2} \cdot {T}_{s} \cdot {m}_{0}^{2} \cdot n \qquad ( 42 )$$

$$where n = 0 , … , N - 1.$$

Said phase error for an object having the discrete transit time m₀ can be corrected by adding the negative of the above phase error for each shift m when calculating the two-dimensional correlation E_{m,k} by multiplying the product sequence e(n)·b(n−m) by the twiddle factor prior to the FFT

$$\begin{matrix}{d}_{n , m , Q} = exp ( - \hat{J} \cdot {φ}_{r , Q} ( n ) ) \\ = exp ( \hat{J} \cdot 2 π \cdot [ Q \cdot {T}_{m} \cdot {T}_{s}^{2} \cdot m \cdot {n}^{2} - Q \cdot N \cdot {T}_{m}^{2} \cdot {T}_{s} m \cdot n - Q \cdot {T}_{m}^{2} \cdot {T}_{s} \cdot {m}^{2} \cdot n ] )\end{matrix} \qquad ( 43 )$$

$$where n = 0 , … , N - 1 and m - 0 , … , M - 1$$

(it should be noted that in the case of an approach such as in FIG. 10, only the subset of the even-numbered values is to be utilized for m). The realization of said twiddle factors can be combined with the realization of the above twiddle factors d_{n,m} according to relationship (26) or (31) in order to compensate for the transit time-dependent frequency shift and, if necessary, an asymmetrical Doppler frequency range-twiddle factors having the sum of the phases of the two individual twiddle factors are then to be implemented. The first two phase components in d_{n,m},Q according to relationship (43) are linear in the shift m, so that when the twiddle factors are realized similarly to FIG. 11, they can be implemented as an additional part of the register R2, which is the input of the integrator:

$$R 2 = round ( {2}^{14} \cdot 2 \cdot [ n / N \cdot {T}_{s} \cdot B + Q \cdot {T}_{m} \cdot {T}_{s}^{2} \cdot {n}^{2} - Q \cdot N \cdot {T}_{m}^{2} \cdot {T}_{s} \cdot n ] ) ; \qquad ( 44 )$$

the additional part being the two back components proportional to the strength Q of the squared frequency error. The back component, which is squared regarding the shift m in relationship (43) is frequently negligible, since it is considerably smaller than the other components due to M<<N; if, however, it is to be realized, it requires a second order integrator—that is to say that there is then a third register which is integrated in an upstream integrator, and the output of said integrator then goes into the integrator according to FIG. 11 as a further input.

The correction of the frequency error can fundamentally take place following the FFT instead of prior to it; the multiplication by the twiddle factors d_{n,m},Q, n=0, . . . , N−1 prior to the FTT corresponds to a convolution of the spectrum (that is to say, of the DFT or FFT) of said twiddle factor sequence. In the case of the squared frequency error considered, said spectrum has a broad peak around zero (the width of the peak increases with shift m); the convolution can therefore be restricted to the totaling over a few values, weighted with complex factors-nevertheless, such a realization would be considerably more complicated than the approach presented above with correction prior to the FTT, including because said weighting factors depend on the shift m.

So far, a squared error of the transmit frequency according to relationship (37) has been considered. The above considerations can also be transferred to general errors f_{TX,Q}(t) of the transmit frequency, that is to say general deviations from a linear progression. The twiddle factors by which the product sequence e(n)·b(n−m) is to be multiplied in order to correct the transmit frequency error are, in general form, using relationship (41a) as well as t=n·Tₛ and t₀=m₀·Tₘ as follows:

$$\begin{matrix}{d}_{n , m , Q} = exp ( - \hat{J} \cdot {φ}_{r , Q} ( t ) ) \\ = exp ( - \hat{J} \cdot 2 π \cdot {\dot{f}}_{r , Q} ( t ) ) \\ = exp ( - \hat{J} \cdot 2 π [ {\dot{f}}_{TX , Q} ( t - {t}_{0} ) - {\dot{f}}_{TX , Q} ( t ) ] ) . \\ = exp ( - \hat{J} \cdot 2 π \cdot [ {\dot{f}}_{TX , Q} ( n - {T}_{s} - m \cdot {T}_{m} ) - {\dot{f}}_{TX , Q} ( n \cdot {T}_{s} ) ] ) .\end{matrix} \qquad ( 45 )$$

Said twiddle factors can again be combined with the twiddle factors d_{n,m} according to relationship (31) in order to compensate for the transit time-dependent frequency shift and an asymmetric Doppler frequency range. For a realization similar to FIG. 11, the discrete phase values p_{n,m} having a value range of 0, 1, . . . , 7 (that is to say, length of 3 bits) are then, in extension of the relationship (36), which referred to an ideal linear frequency modulation, as follows:

$${p}_{n , m} = {mod}_{8} ( round ( 8 \cdot n / N \cdot [ m \cdot {T}_{s} \cdot B - {\underline{k}}_{offset} ] - 8 \cdot ( {\dot{f}}_{TX , Q} ( n - {T}_{s} - m \cdot {T}_{m} ) - {\dot{f}}_{TX , Q} ( n \cdot {T}_{s} ) ) ) ) . \qquad 46 )$$

The block 11.1 in FIG. 11 for generating said discrete phase values can be replaced by a register in which the respective pre-calculated phase value is written. Instead of a register for only a one 3-bit phase value, a long register can also be utilized, into which the discrete phase values are written over all of the m, that is to say, in the example considered above, M/2=250 values of 3 bits in length, wherein said register is then clocked through, that is to say, shifted through, over m; the advantage of this is that no writing process has to be performed during the calculation of one pixel and that if the transmit frequency errors are the same over multiple pixels, writing only has to be done once (a cyclical shifting through is then to be used). Said approach with pre-calculated register values can also be combined with an approach according to FIG. 11 having an integrator circuit, so that only the component which cannot be realized with an integrator circuit needs to be in said registers and this may result in a register being made use of for the generation of multiple phase values p_{n,m}, that is to say, for different n and/or m, which reduces the number of registers required and the pre-calculation outlay (including a microcontroller).

In order to be able to compensate for a non-linear frequency progression, the errors, that is to say deviations from the linear progression, must be known. As already explained above, uncompensated errors of the frequency progression result in particular in broadened peaks in the frequency dimension k; there is a fixed relationship between the width of the peak and the error strength Q (see also above) for the assumption of a squared error, whereby Q can then be calculated. A non-linear frequency progression over pixels also results in angular errors (this will be considered in more detail later, including how such angular errors can be determined); if said angular errors are known, it is possible to extrapolate the error in the frequency progression therefrom—not only over pixels, but also within one pixel, since the error progression mostly has a quadratic form, at least in some sections.

### Compensation of the Internal Couplings and Reflections of a Cover

It was explained above that correction values c₁(n) are added to the receive sequence in order to compensate for the effects of couplings and reflections within the lidar system or its immediate surroundings, in particular a cover, in block 8.1 or 10.1 of the hardwired computational logic according to FIG. 8 or 10. It should be mentioned that it is known of radar sensors which are based on the same concept of coherent operation as coherent lidar sensors, but in another electromagnetic frequency range, that a compensation of such effects is advantageous. It shall now be explained how said correction values can be determined in the case of a coherent lidar system having phase modulation and how they can be easily realized.

If it is assumed that, on the one hand, the discrete distance m=0 lies precisely at the distance zero and, on the other hand, that the distance of said couplings and reflections is also negligibly small (therefore, the receive frequency fₑ=0; the Doppler component is, of course, also zero), then the level P of said couplings and reflections generated in the receive sequence can be determined by averaging over the product of the receive sequence e(n) and the unshifted modulation sequence b(n) (the signal component in the receive sequence originating from real objects has, on the one hand, a lower level and, on the other hand, is largely averaged out, because it corresponds to a shifted modulation sequence and also, generally, has a receive frequency fₑ≠0). The correction values c₁(n) are then obtained as the level P determined in this way multiplied by −1 and multiplied by the unshifted modulation sequence b(n) by the values +1. The determination of said mean value (by summing over the N=4096 values e(n)·b(n) and moving the result by 12 bits to the right) can either be carried out outside or inside the hardwired computational logic. In the case of a realization within the computational logic, either an additional block can be implemented for this purpose or the value of the two-dimensional correlation E_{m,k} at the discrete distance m=0 and the discrete frequency k=0, which corresponds to the sum of e(n)·b(n), is utilized directly with the existing computational logic. If the correlation result is utilized, it is then to be taken into account that the computational logic is executed in the form of a pipeline and the calculation therefore takes some cycles; that is to say that if the level value calculated over the two-dimensional correlation is to be utilized in the same pixel, the shifting of the input sequence in block 8.2 or 10.2, that is to say the clocking of said block, must be suspended for that time. Alternatively, the level value from the preceding cycle or from previously processed adjacent pixels could also be enlisted (provided that the value P does not change significantly from pixel to pixel). For the level value P determined in this way, the hardwired computational logic assigns the values ±P to the correction values c₁(n); if the same modulation sequence b(n) is always utilized, the respective algebraic sign can be realized in a hardwired manner (negative sign preferably only by bit inversion), b(n) can change, so switchable inverters are required.

Due to the distortion of the form of the received pulse described above and since the reflection of a cover in particular can have a not entirely negligible transit time, a signal component may still be visible even at the discrete distance m=1. The level in the receive sequence e(n) is then not only dependent on the respective value of b(n), but rather also on the preceding value b(n−1), so that two mean values must be determined: one over the time values n, at which b(n) and b(n−1) have the same algebraic sign, and one for unequal algebraic signs of b(n) and b(n−1). Said two level values are then assigned to the correction values c₁(n) with the correct sign in the hardwired logic, depending on whether b(n) and b(n−1) have the same or opposite sign for the respective n (if the modulation sequence b(n) can vary, then correspondingly configurable inverter and switches are required for this). Fundamentally, said two level values could also be determined from the two sums of e(n)·b(n) and e(n)·b(n−1) over all n, wherein said sums are either determined in an explicit calculation or are inferred from the two-dimensional correlation. If the received pulse is distorted and/or shifted to such an extent that a value of the receive sequence e(n) is influenced by three adjacent values of b(n), the method described above is to be extended accordingly.

Due to the linear frequency change superimposed on the phase modulation, the receive sequence can have a low frequency, in particular from the reflection of a cover; even if only a fraction of a period is passed through during the N=4096 values of one pixel, the compensation described above with its assumption of the receive frequency of zero and, therefore, a constant phase would no longer be fully effective. In order to reduce the effect of the frequency, level values could be determined in some sections, e.g., over 4 sections of length N/4=1024. Alternatively, if the small receive frequency is known, it could be eliminated prior to the determination of the level values by multiplying it by corresponding twiddle factors and then said twiddle factors could be applied again during the determination of the correction values c₁(n); however, this is fairly complicated. The level values can also be determined again from the two-dimensional correlation; an unknown frequency can also be established with the aid of interpolation.

If the effects of coupling and reflection are at least approximately constant over time and/or over small pixel regions, an average can be taken over capturing cycles and/or pixel regions. However, it is generally not the case that the effects are constant over all pixels, since, e.g., different phase positions of the reflections from a cover result from different beam directions.

Determining the Sign of the Receive Frequency in the Case of a Real-Valued Mixer with the Aid of Linear Frequency Modulation

The aim of the following sections is to explain the advantages and system approaches which make it possible to combine a phase modulation and a changing frequency.

In the lidar system considered so far according to FIG. 1, the mixer has a complex-valued design, which constitutes a considerable additional outlay (virtually double) with respect to a real-valued mixer (with only one real-valued output) for the receive path. However, when using a real-valued mixer, only the amount of the receive frequency can be established, not the algebraic sign, since there are two peaks at (m₀,+k₀) and (m₀,−k₀) in the correlation E_{m,k}. In the case of a constant transmit frequency according to the prior art, only the amount, but not the algebraic sign, of the radial relative speed can be determined. To establish the algebraic sign, according to the prior art, approaches by way of tracking, i.e., pursuing over multiple acquisition cycles and/or by way of plausibility checking, e.g., whether the measured amount of the radial relative speed corresponds to a stationary object, can be utilized, which is however associated with disadvantages. Said disadvantages can be reduced by the linear frequency modulation superimposed on the phase modulation. According to relationship (12):

$${f}_{e} = {f}_{D} + {f}_{r} = 2 v / λ - 2 r / c \cdot B / {T}_{pm} , \qquad ( ( 12 ) )$$

the receive frequency fₑ following mixing and also following digitization is composed of the Doppler shift f_{D} generated by the relative speed v and the frequency shift fᵣ caused by the linear frequency modulation, wherein fᵣ is proportional to the object distance r which is determined with the aid of the phase modulation. Consequently, the range of the receive frequency fₑ corresponding to the relevant relative speed range vₘᵢₙ, . . . , vₘₐₓ is shifted over the object distance r; this is depicted in FIG. 13 for vₘᵢₙ=−80 km/h and vₘₐₓ=+280 km/h as well as the design of the linear frequency modulation considered above, i.e., B=800 MHz and Tₚₘ=13.7 μs. As an example, the object distance r=200 m is considered; the relevant frequency range extends over fₑ=−106.8, . . . , 22.3 MHz. Since, in the case of a real-valued mixer, only the amount, but not the algebraic sign of the receive frequency can be determined, ambiguity occurs for the receive frequency in the range fₑ=−22.3, . . . , 22.3 MHz, which corresponds to the relative speed range v=156, . . . , 280 km/h—that is to say, e.g., no distinction is made between the two relative speeds v=156 km/h and v=280 km/h, or between v=186 km/h and v=250 km/h; for all receive frequencies having a measured amount |fₑ|>22.3 MHz, only the negative sign is possible, so that the relative speed can be determined clearly. The ambiguous range of the receive frequency is depicted hatched in FIG. 13. For the maximum object distance of 249.5 m, almost the entire relevant frequency range fₑ=−126.2, . . . , 2.9 MHz is negative, so that apart from the relative speed range v=265, . . . , 280 km/h, there are no ambiguities.

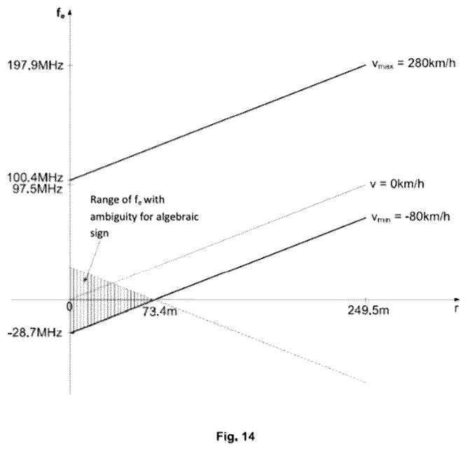

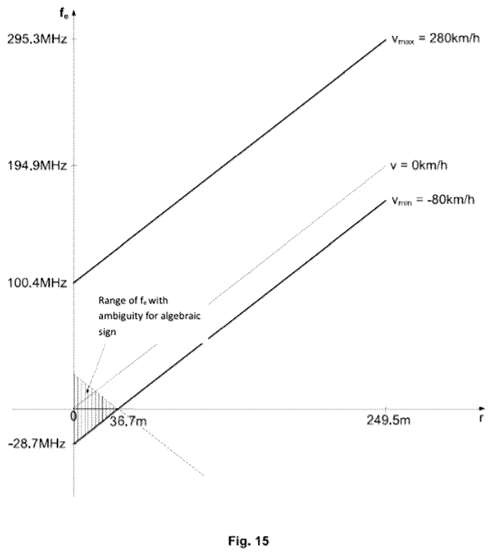

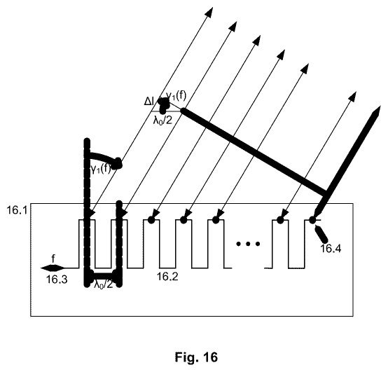

In order to reduce the range of the receive frequency having ambiguity, a negative modulation bandwidth, that is to say with the same amount as above B=−800 MHz, can be selected, i.e., the transmit frequency decreases linearly over time. The conditions for the receive frequency are depicted in FIG. 14; for object distances r>73.4 m there are no longer any ambiguities. However, the maximum receive frequency which occurs is now higher, as regards amount, than in the case of a positive modulation bandwidth (198.1 MHz instead of 126.2 MHz), so that a higher sampling frequency of at least roughly fₛ=450 MHz is necessary (instead of fₛ=300 MHz). By increasing the amount of the modulation bandwidth B, the distance range having ambiguities can be reduced even further; for double the amount and negative sign of the modulation bandwidth, that is to say B=−1600 MHz, according to FIG. 15, ambiguities only occur for object distances r<36.7 m; however, a further increase in the sampling frequency is then necessary. It should also be mentioned that a higher sampling frequency (and more sampling values per pixel, the data acquisition time of which should remain unchanged) means that the FFT for calculating the two-dimensional correlation can have an unchanged length if—as explained above—the component of the frequency shift, which is due to the transit time, is eliminated prior to the FFT by multiplying the corresponding twiddle factors and a corresponding decimation takes place thereafter.

That is to say that the ambiguity problem which occurs in the case of a real-valued mixer during the determination of the relative speed can be reduced to closer object distances with the aid of the transit time-dependent frequency shift effect of the linear frequency modulation. Since tracks are normally already set there in the tracking, the ambiguity can be resolved when the detections generated from a single capturing cycle are assigned to the tracks.

If the lowest possible sampling frequencies are to be deployed, only small modulation bandwidths are possible, so that ambiguities in the determination of the relative speed can arise over the entire distance range. This can be resolved by changing the modulation bandwidth over capturing cycles, in particular by alternating its algebraic sign. In the case of the modulation bandwidth +B, the following is obtained for the receive frequency:

$${f}_{e , 1} = {f}_{D} + {f}_{r} = 2 v / λ - 2 r / c \cdot B / {T}_{pm} , \qquad ( 47 a )$$

and in the case of the inverted modulation bandwidth −B:

$${f}_{e , 2} = {f}_{D} - {f}_{r} = 2 v / λ + 2 r / c \cdot B / {T}_{pm} , \qquad ( 47 b )$$

wherein the transit time-dependent frequency shift

$${f}_{r} = - 2 r / c \cdot B / {T}_{pm} \qquad ( ( 11 b )$$

refers to +B and is generally known, since the object distance r is of course determined with the aid of the phase modulation. The Doppler shift f_{D} is obtained by summing both these relationships to

$${f}_{D} = ( {f}_{e , 1} + {f}_{e , 2} ) / 2. \qquad ( 48 )$$

However, when using a real-valued mixer, only the amounts |f_{e,1}| and |f_{e,2}| of the two receive frequencies are measured. How the relative speed v can be clearly established therefrom is to now be derived for a positive frequency shift due to the transit time fᵣ (thus B<0). If the amount of the Doppler shift f_{D} is less than said fᵣ (that is to say |f_{D}|<fᵣ), then according to relationship (47) f_{e,1}>0, that is to say, f_{e,1}=|f_{e,1}|, and f_{e,2}<0, that is to say, f_{e,2}=−|f_{e,2}|, and the following then applies to the difference between the amounts of the receive frequencies using the relationship (47):

$$\vert {f}_{e , 1} \vert - \vert {f}_{e , 2} \vert = {f}_{e , 1} - ( - {f}_{e , 2} ) = {f}_{e , 1} + {f}_{e , 2} = 2 \cdot {f}_{D} for \vert {f}_{D} \vert < {f}_{r} ,$$

and to the amount of said difference where |f_{D}|<fᵣ:

$$\vert \vert {f}_{e , 1} \vert - \vert {f}_{e , 2} \vert \vert = 2 \cdot \vert {f}_{D} \vert < 2 \cdot {f}_{r} for \vert {f}_{D} \vert < {f}_{r} .$$

Both receive frequencies are non-negative for Doppler shift f_{D}≥fᵣ, that is to say, f_{e,1}=|f_{e,1}| and f_{e,2}=|f_{e,2}|, so that using the relationship (47), the following applies:

$$\vert {f}_{e , 1} \vert - \vert {f}_{e , 2} \vert = {f}_{e , 1} - {f}_{e , 2} = 2 \cdot {f}_{r} for {f}_{D} \geq {f}_{r} ,$$

while for Doppler shift f_{D}≤−fᵣ both receive frequencies are negative, that is to say f_{e,1}=−|f_{e,1}| and f_{e,2}=−|f_{e,2}|, and the following consequently applies:

$$\vert {f}_{e , 1} \vert - \vert {f}_{e , 2} \vert = - {f}_{e , 1} - ( - {f}_{e , 2} ) = - {f}_{e , 1} + {f}_{e , 2} = - 2 \cdot {f}_{r} for {f}_{D} \leq - {f}_{r} .$$

Consequently, the three cases |f_{D}|<fᵣ (that is to say −fᵣ<f_{D}<fᵣ), f_{D}≥fᵣ and f_{D}≤−fᵣ can be clearly distinguished and, therefore, determined from the difference |f_{e,1}|−|f_{e,2}| of the measured amounts of the two receive frequencies:

$$\vert \vert {f}_{e , 1} \vert - \vert {f}_{e , 2} \vert \vert < 2 \cdot {f}_{r} \to \vert {f}_{D} \vert < {f}_{r} , \qquad ( 49 )$$

$$\vert {f}_{e , 1} \vert - \vert {f}_{e , 2} \vert = 2 \cdot {f}_{r} \to {f}_{D} \geq {f}_{r} ,$$

$$\vert {f}_{e , 1} \vert - \vert {f}_{e , 2} \vert = - 2 \cdot {f}_{r} \to {f}_{D} \leq {f}_{r} .$$

For each of these three cases, the algebraic sign of the two receive frequencies is clearly defined (see above in each case), so that the Doppler shift f_{D} can be clearly determined with relationship (48):

$$\vert \vert {f}_{e , 1} \vert - \vert {f}_{e , 2} \vert \vert < 2 \cdot {f}_{r} \to \vert {f}_{D} \vert < {f}_{r} \to {f}_{e , 1} = \vert {f}_{e , 1} \vert , {f}_{e , 2} = - \vert {f}_{e , 2} \vert \to {f}_{D} = ( \vert {f}_{e , 1} \vert - \vert {f}_{e , 2} \vert ) / 2 , \qquad ( 50 )$$

$$\vert {f}_{e , 1} \vert - \vert {f}_{e , 2} \vert = 2 \cdot {f}_{r} \to {f}_{D} \geq {f}_{r} \to {f}_{e , 1} = \vert {f}_{e , 1} \vert , {f}_{e , 2} = \vert {f}_{e , 2} \vert \to {f}_{D} = ( \vert {f}_{e , 1} \vert + \vert {f}_{e , 2} \vert ) / 2 ,$$

$$\vert {f}_{e , 1} \vert - \vert {f}_{e , 2} \vert = - 2 \cdot {f}_{r} \to {f}_{D} \leq - {f}_{r} \to {f}_{e , 1} = - \vert {f}_{e , 1} \vert , {f}_{e , 2} = - \vert {f}_{e , 2} \vert \to {f}_{D} = ( - \vert {f}_{e , 1} \vert - \vert {f}_{e , 2} \vert ) / 2.$$

So far, a positive sign of the frequency shift due to the transit time fᵣ has been considered (that is to say, due to relationship (11b), modulation bandwidth B<0); the similar considerations are valid for a negative sign (that is to say, modulation bandwidth B>0):

$$\vert \vert {f}_{e , 1} \vert - \vert {f}_{e , 2} \vert \vert < 2 \cdot \vert {f}_{r} \vert \to \vert {f}_{D} \vert < \vert {f}_{r} \vert \to {f}_{e , 1} = - \vert {f}_{e , 1} \vert , {f}_{e , 2} = - \vert {f}_{e , 2} \vert \to {f}_{D} = ( - \vert {f}_{e , 1} \vert + \vert {f}_{e , 2} \vert ) / 2 , \qquad ( 51 )$$

$$\vert {f}_{e , 1} \vert - \vert {f}_{e , 2} \vert = 2 \cdot \vert {f}_{r} \vert \to {f}_{D} \leq - \vert {f}_{r} \vert \to {f}_{e , 1} = - \vert {f}_{e , 1} \vert , {f}_{e , 2} = - \vert {f}_{e , 2} \vert \to {f}_{D} = ( - \vert {f}_{e , 1} \vert - \vert {f}_{e , 2} \vert ) / 2 ,$$

$$\vert {f}_{e , 1} \vert - \vert {f}_{e , 2} \vert = - 2 \cdot \vert {f}_{r} \vert \to {f}_{D} \geq \vert {f}_{r} \vert \to {f}_{e , 1} = \vert {f}_{e , 1} \vert , {f}_{e , 2} = \vert {f}_{e , 2} \vert \to {f}_{D} = ( \vert {f}_{e , 1} \vert + \vert {f}_{e , 2} \vert ) / 2.$$

Both relationships can be summarized using the algebraic sign V_{B}=±1 of the modulation bandwidth B, and the radial relative speed v=λ/2·f_{D} is then clearly given as:

$$for \vert \vert {f}_{e , 1} \vert - \vert {f}_{e , 2} \vert \vert < 2 \cdot \vert {f}_{r} \vert : v = - {V}_{B} \cdot λ / 4 \cdot ( \vert {f}_{e , 1} \vert - \vert {f}_{e , 2} \vert ) , \qquad ( 52 )$$

$$for \vert {f}_{e , 1} \vert - \vert {f}_{e , 2} \vert \geq 2 \cdot \vert {f}_{r} \vert : v = - {V}_{B} \cdot λ / 4 \cdot ( \vert {f}_{e , 1} \vert + \vert {f}_{e , 2} \vert ) ,$$

$$for \vert {f}_{e , 1} \vert - \vert {f}_{e , 2} \vert \leq - 2 \cdot \vert {f}_{r} \vert : v = + {V}_{B} \cdot λ / 4 \cdot ( \vert {f}_{e , 1} \vert + \vert {f}_{e , 2} \vert ) ;$$

It is also taken into account that due to computational tolerances and small changes in the relative speed and/or distance over the two capturing cycles, values of |f_{e,1}|−|f_{e,2}| slightly outside of the actual limits ±2·|fᵣ| are also possible, which is why the comparison is made using “≥” or “≤” instead of “=”. That is to say that the relative speed v can be clearly determined by first calculating the difference |f_{e,1}|−|f_{e,2}| between the amounts of the two receive frequencies and comparing these with ±2·|fᵣ| in order to then apply the respective relationship to calculate v for the resulting one of the three ranges. It is solely in the case of fᵣ=0, that is to say distance zero, that the sign of the relative speed v cannot be determined, since then the second and third cases in relationship (52) above cannot be distinguished and are not possible (the ambiguity can also be explained by the fact that the receive frequency, which is only known from the amount, then consists solely of the Doppler shift). Due to tolerances and changes between two capturing cycles, this problem of the impossibility of determining the sign of the Doppler shift and, therefore, the relative speed can still arise even with very small values of fᵣ); however, such very small values of fᵣ correspond to the region immediately in front of the sensor, where no objects normally occur and, if they do, their algebraic sign of the relative speed is already known from history and/or is mostly approximately zero. It should be noted that for the derivation of relationship (52), the Doppler shift fb effectively averaged from two capturing cycles according to relationship (48) was utilized; the Doppler shift f_{D} based on only one capturing cycle according to relationship (47a) or (47b) can of course also be used. Furthermore, a slightly different frequency shift due to the distance in the two capturing cycles can also be taken into account; different values f_{r,1} and f_{r,2} are then to be used in relationships (47a) and (47b) and the difference thereof is then added as a small component in relationship (48).

Consequently, the ambiguity of the relative speed can be resolved by comparing the measured receive frequencies of two capturing cycles. As in the case of normal tracking, an assignment of detections over cycles is necessary. However, in the case of the conventional approach to resolving the ambiguity, pursuing over considerably more cycles is generally necessary via tracking since the measured distance progression, that is to say the distance change measured over cycles, is compared with the distance change expected by the respective speed hypothesis; however, in the case of a small receive frequency, as regards amount, and, consequently, two speed hypotheses which are not far apart, this takes many cycles.

However, the approach to resolving the speed ambiguities by varying the modulation bandwidth, e.g., by alternating algebraic signs, cannot only be applied over two capturing cycles. Alternatively, each pixel can also be acquired in one capturing cycle with two different values or algebraic sign of the modulation bandwidth B; however, in the case of the given hardware, this would halve the number of pixels, or the number of the parallel send-receive paths would have to be doubled. In order to avoid this, instead of the same pixels, pixels located near to one another, in particular adjacent pixels, having a different value or algebraic sign of the modulation bandwidth B can be acquired; since a real object is normally extended and is consequently acquired in multiple pixels and the relative speed and distance are at least approximately the same, the relationship (52) can be applied again to clearly determine the relative speed v, wherein the two receive frequencies belong to two pixels having different algebraic signs of the modulation bandwidth B. One approach for different B in the case of pixels which are located near to one another, in particular adjacent pixels, is to select a different B for different, in particular adjacent, scanning planes in the case of a system with scanning.

### Continuous Scanning by Changing the Frequency

One realization possibility for continuous scanning in one capturing plane is represented below. Elements are utilized, the beam direction of which (for transmitting and receiving) depends on the frequency; examples of such elements are dispersive materials, grid structures or waveguides, wherein the aim here is to focus on the latter (but the approaches shown can, of course, also similarly be transferred to other elements). FIG. 16 shows a waveguide 16.2 of length 1 cm realized in a photonic semiconductor chip 16.1 having a lateral feed 16.3 with a frequency f and having equidistant coupling locations 16.4 at a respective distance of λ₀/2 with λ₀=1550 nm (free-air wavelength for f₀=c/λ₀=194 THz); the coupling locations are depicted as points in FIG. 16, but they can also have a certain extent. The coupling locations serve to couple out the wave during transmitting and to couple in the wave during receiving. The structure of the waveguide is periodic, i.e., it assumes the same shape between two adjacent coupling locations in each case. For this reason, the phase difference Δφ(f) depending on the frequency f utilized is constant between two adjacent coupling locations in each case, so that the phase of the wave which is emitted at the k-th coupling location, k=0, . . . , K−1 where K=12900, is:

$${φ}_{k} ( f ) = k \cdot Δ φ ( f ) = k \cdot {\underline{mod}}_{2 π} ( Δ φ ( f ) ) where k = 0 , … , K - 1 \qquad ( 53 )$$

wherein “mod_{2π}” constitutes the symmetrical modulo function to module 2π, that is to say it maps to the symmetrical range −π, . . . +π; the modulo formation takes into account the fact that there are generally numerous wavelengths between two coupling locations, in order to also attain the strongest possible dependence of the phase difference on the frequency, which can be attained by the meandering structure indicated in FIG. 16 (the meanders can—as depicted in the image—go inwards or lie parallel to the surface of the chip). If the phase difference Δφ(f) is an integral multiple of 2π (that is to say, a whole number of wavelengths lies in each case between the coupling locations), then the beam direction is perpendicular to the waveguide. In the other case, that is to say mod₂(Δφ(f))≠0, an oblique beam direction with angle γ₁(f) results as depicted in FIG. 16, defined by the fact that the beam length difference Δl from adjacent coupling locations compensates for the phase difference mod_{2π}(Δφ(f)); since the phase difference −2π·Δl/λ having the free space wavelength λ=c/f corresponds to the beam length difference Δl and Δl=sin (γ₁(f))·λ₀/2 where λ₀=c/f₀, the following applies:

$$2 π \cdot sin ( {γ}_{1} ( f ) ) \cdot {λ}_{0} / ( 2 \cdot λ ) = π \cdot sin ( {γ}_{1} ( f ) ) \cdot f / {f}_{0} = {\underline{mod}}_{2 π} ( Δ φ ( f ) ) \qquad ( 54 )$$

and consequently

$${γ}_{1} ( f ) = a sin ( - {\underline{mod}}_{2 π} ( Δφ ( f ) ) / π \cdot {f}_{0} / f ) , \qquad ( 55 )$$

wherein “asin” constitutes the inverse sine function. If, for example, mod_{2π}(Δφ)=−π/2 and at least approximately λ=λ₀, this then produces the angle γ₁=30°. The beam angle applies both to transmitting and to receiving—this also follows from the principle of reciprocity.

A continuous spatial scanning is realized by a continuous frequency change, i.e., the frequency also changes during the data acquisition of one pixel, and does so at least approximately linearly. Therefore, the frequency change superimposed on the phase modulation according to FIG. 5 results directly as a consequence of the scanning by frequency change. As explained above, the required sampling frequency fₛ increases with the modulation width B, that is to say, the frequency change during one pixel, which de facto limits it—in the case of the pixel duration Tₚₘ=13.7 μs and the maximum range of just under 250 m considered here, its amount |B| should be ≤2 GHz (for a fₛ≤800 MHz). If the aim is to scan over 500 pixels (e.g., for the horizontal direction), then the frequency is to be changed by roughly 1 THz overall, which corresponds to roughly 0.5% of the average frequency f₀=c/λ₀=194 THz (for free-air wavelength λ₀=1550 nm). For an assumed scanning range of −20°, . . . , +20°, the phase difference Δφ(f) between two adjacent coupling locations must change by roughly +0.34π, . . . , −0.34π, that is to say by roughly 0.68π, which requires a high frequency-related sensitivity of the phase difference Δφ in the case of a frequency change of 0.5%, which, in addition to a meandering waveguide, can also be realized by a waveguide having a high dispersion in the frequency range utilized.

First, it should be assumed that the beam angle γ₁ should change linearly over time over the range −20°, . . . , +20, that is to say,

$${γ}_{1} ( t ) = {A}_{1} \cdot t , \qquad ( 56 )$$

and that the phase difference Δφ(f) has a constant slope in the small frequency range considered:

$$Δφ ( f ) = - {F}_{1} \cdot ( f - {f}_{0} ) + L \cdot 2 π where L is integral ; \qquad ( 57 )$$

it is taken into account that at the average frequency f₀, the beam direction should be zero (that is to say, mod_{2π}(Δφ(f₀)=0). The following is obtained with relationship (54):

$$- π \cdot sin ( {A}_{1} \cdot t ) \cdot f / {f}_{0} = - {F}_{1} \cdot ( f - {f}_{0} )$$

and, consequently, for the required time-dependent frequency progression f(t):

$$f ( t ) = {f}_{0} / ( 1 - π \cdot sin ( {A}_{1} \cdot t ) / ( {f}_{0} \cdot {F}_{1} ) ) . \qquad ( 58 )$$

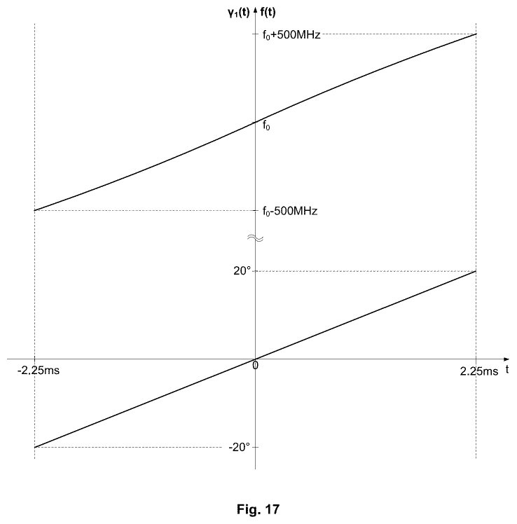

The temporal progression of the beam angle γ₁(t) and the frequency f(t) are depicted in FIG. 17 for a scanning duration of 4.5 ms (500 partially overlapping pixels at a distance of 9 μs) and a specified frequency change of 1 THz (→F₁=2.13 THz). It should be noted that the frequency f(t) for transmitting and receiving really has a small frequency difference (due to frequency shift of Doppler and transit time), wherein the beam angle difference caused as a result is considerably below the beam width itself.

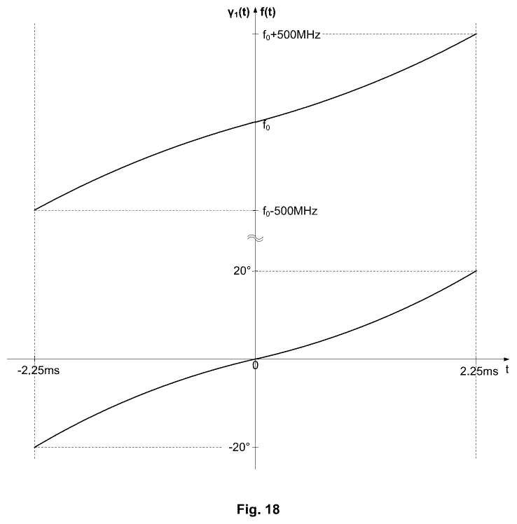

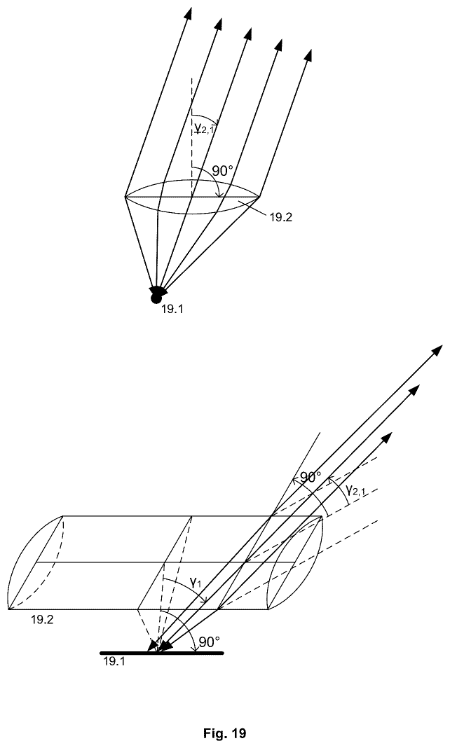

A temporally linear change in the beam angle γ₁(t) according to relationship (56) means a constant angular resolution over the entire capturing range in the case of a temporally equidistant pixel spacing. However, a different angular resolution can be advantageous, in particular in the case of lidar sensors facing forwards, that is to say in the direction of travel: a higher angular resolution is required in the direction of travel (γ₁=0) than towards the outside (γ₁=±20°; that is to say that γ₁ here refers, by way of example, to the horizontal direction), i.e., a higher scanning speed can be realized towards the outside by a quicker frequency change; this is depicted, by way of example, in FIG. 18. It should be mentioned that, during faster scanning, the region on an object swept over by the lidar beam also becomes larger, so that the signal received over the capturing duration of one pixel loses coherence (at least partially different points of the object are captured at different times); on the one hand, the reduced coherence slightly reduces the sensitivity and, therefore, the range, which is not, however, relevant in the outer region due to its reduced range requirements, and, on the other hand, the Doppler accuracy becomes slightly worse (because the peak in the two-dimensional correlation is slightly blurred in the Doppler dimension), which is not critical, however, due to the fundamentally very high accuracy of Doppler, that is to say the relative speed.

Even with a constant scanning speed according to relationship (56), the frequency progression according to relationship (58) is not completely linear in time (in particular due to the sine function contained therein). The non-linearity of the temporal progression of the frequency becomes considerably stronger due to the non-constant scanning speed (see also FIG. 18). A further cause of a temporally non-linear frequency progression is a strongly dispersive character of the waveguide (that is to say the linear relationship between the phase difference Δφ(f) and the frequency f according to relationship (57) is no longer valid). Such non-linearities in the temporal frequency progression over a capturing scan (that is to say, 500 pixels in the example above) can also result in a relevant non-linearity of the frequency progression even during a single pixel, that is to say, in a frequency error f_{r,Q}(t), in particular having a quadratic form according to relationship (39b). As presented above, such a frequency error can, however, be compensated for by way of a corresponding correction component in the twiddle factors d_{n,m}; in the case of a squared error, only the register R2 in the structure according to FIG. 11 is to be adjusted according to relationship (44). A modulation bandwidth B which changes over pixels (due to the changing slope of the frequency progression f(t)) can also be taken into account by adjusting said register value-then the output dimension of the FFT always corresponds to the same relative speeds.

In principle, almost any scan progressions can be realized by way of a corresponding frequency change progression—this is a major advantage of scanning by way of a frequency change. The capturing range can also be modified over cycles, in particular depending on the traffic situation; a wider capturing range than at high ego-speed (e.g., highway) can be of interest at low vehicle speeds (e.g., city traffic). A sensor misalignment (e.g., the sensor looks 2° to the right instead of in the direction of travel) can be taken into account simply by adjusting the frequency range utilized accordingly, that is to say substantially shifting it slightly.

Instead of the continuous scanning previously considered, stepwise scanning could also fundamentally be used, that is to say, the frequency is changed from pixel to pixel, but remains constant in each case within one pixel (a phase modulation according to the prior art with a constant frequency, that is to say without superimposed frequency modulation, could then also be applied). However, said stepwise scanning would bring with it some disadvantages (nevertheless, it should not be ruled out as a possible realization form here):
No overlapping pixels can be realized, which, given the hardware and cycle time, results in a reduced data acquisition duration of the individual pixel. The data acquisition time is additionally reduced by the fact that changing over the frequency takes a certain amount of time (in particular until the frequency has settled in at the new value) and that the maximum transit time of the received signals must be waited for thereafter (roughly 1.67 μs at a maximum distance of 249.5 m). In the case of the temporal pixel spacing of roughly 9 μs considered in the previous design, only a data acquisition time of roughly 6 μs remains, which is more than a halving compared to continuous scanning with a pixel duration of 13.7 μs. The main disadvantage of said considerably reduced data acquisition time per pixel is a reduction in sensitivity (by roughly 3.5 dB for the above conditions) and, therefore, in range (by roughly 19%); less critical is the reduced resolution and accuracy of the relative speed determination. The loss becomes even greater if the pixel spacing is, e.g., selected to be a factor of 2 smaller in order to be able to manage with half the number of parallel transmit and receive paths (16 instead of 32).
In the case of a real-valued mixer, the algebraic sign of the relative speed cannot be determined—the approaches presented above for resolving the ambiguity due to an unknown algebraic sign of the receive frequency were, of course, based on superimposed linear frequency modulation.
If the beam width is smaller than the beam movement during the data acquisition pause between two pixels due to very rapid scanning (e.g., towards the outside), an object which is very narrow in the scanning direction could be overlooked.
A continuous scanning of the frequency can be realized more easily or better than stepped scanning.
A continuous scanning of the frequency reduces the speckle effect (that is to say, a statistically varying receive level from a diffuse reflector) a little, since the speckle effect is frequency-dependent; the speckle effect is additionally slightly reduced by spatial scanning since the illuminated area changes slightly during the data acquisition of a pixel.

In order to realize a frequency change, e.g., a changing frequency can either be modulated onto the constant frequency of a laser source (which is, however, difficult here because of the large frequency range required) or a laser source having a directly controllable frequency can be used. Such lasers are typically controlled via a mechanical quantity (e.g., with the aid of a piezoelectric element) or via an electrical quantity (voltage, current). The generation of an electric control quantity can be realized by digital determination on a computing unit, e.g., a processor, and conversion into the analog range with the aid of a digital-analog converter (DAC), if necessary, followed by low-pass filtering; since the frequency progression and, therefore, the required progression of the control quantity is of fairly low frequency from a signal theory perspective, a delta-sigma approach can be utilized during the determination of the input values of the DAC, which reduces the requirements for the DAC, in particular in terms of its resolution. In addition to direct control, a control loop in the form of a PLL (Phase Locked Loop) can also be used. If a sufficiently large frequency tuning range cannot be realized with a laser source (in order, on the one hand, to address the frequency change required for the scanning of, e.g., 1 THz and/or, on the other hand, to cover temperature, aging and tolerance effects), multiple laser sources can be implemented, between which it is possible to change over and, thus, select the suitable source in each case. Alternatively, the frequency change required for the scanning can also be greatly reduced by using waveguides having a slightly different frequency behavior of the phase difference Δφ(f) of adjacent coupling locations for the parallel transceiver paths—at a frequency f, the waveguides then radiate in different directions and their small scanning regions, which are achieved in each case, adjoin one another (if necessary, with a certain overlap region); this approach will be explained in more detail later.

Finally, it should be mentioned that the waveguide—as depicted in FIG. 16—does not only implement the scanning, but of course also focusing in its associated spatial direction, i.e., in every sectional plane through the waveguide (more precisely, through the line on which its coupling locations lie), the wave has a planar wavefront.

### Scanning in the Second Spatial Direction

The aim of the following is to explain how focusing and scanning in the second spatial direction (perpendicular to the spatial direction defined by the waveguide) can be realized. As depicted in FIG. 19, focusing can be carried out with the aid of a lens 19.2; FIG. 19 above shows the arrangement from the direction in which the waveguide 19.1 extends. The waveguide lies in the focal plane of the lens, but offset from the focal line (this occurs because multiple waveguides located next to one another are later considered), so that the radiation which configures a planar wavefront following focusing through the lens is tilted with respect to the optical axis of the lens by the beam angle γ_{2,1} (in the view according to FIG. 19 above, the symbol γ_{2,1}, distinguished by underlining, is used for γ_{2,1}, since only the projected angle is depicted there). Since the focusing in the first spatial direction already takes place through the waveguide itself, the lens only has to focus in the second spatial direction which is perpendicular to the first, so that it has a constant cross-section in the direction of the waveguide; this is depicted at the bottom of FIG. 19. The definition of the two beam angles γ₁ and γ_{2,1} can also be seen there in the three-dimensional context—that is to say, they are not angles according to spherical coordination. at the bottom of FIG. 19, the refraction of the lens on both surfaces is combined in one place for the sake of simplicity.

It should be noted that a lens having a constant cross-section in one dimension is easier to manufacture than a lens without said property, that is to say in particular a lens for focusing in both spatial directions. Instead of a single lens, a lens system can also be utilized, wherein the property of the constant cross-section in the waveguide direction is also retained there.

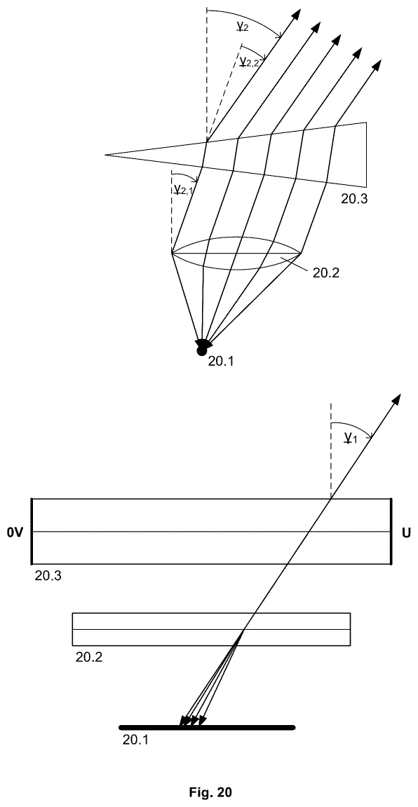

A material which is transparent for the wavelengths utilized, the dielectric constant of which can be changed by applying a voltage (which produces an electric field in the material) or by passing a current through it (in particular in order to produce a magnetic field in the material), can be utilized for scanning in this second spatial direction; liquid crystals and ferroelectric materials are examples of materials having such properties. FIG. 20 shows at the top—from the same perspective as at the top of FIG. 19—an exemplary arrangement having the body 20.3 consisting of such a material, which body, like the lens 20.2, has a constant cross-section (with a triangular form) in the direction of extension of the waveguide 20.1 and, consequently, has a prism-like shape; a side view, i.e., from a direction rotated by 90°, is depicted at the bottom in FIG. 20—the voltage U applied to the two sides of the prism-shaped body 20.3, which either changes its dielectric constant directly or via the current flow produced by it through the body, can also be seen there. By changing the applied voltage U, the difference γ_{2,2} between the input angle γ_{2,1} and the output angle γ₂ of the prism 20.3 and, therefore, the beam angle γ₂ itself can be changed, as a result of which scanning in the second spatial direction, which is orthogonal to the first, can be realized. It should also be mentioned that the prism-shaped body can preferably be larger than required for the actual beam path in order to attain electric fields which are as homogeneous as possible in the relevant region and, therefore, a dielectric constant which is as spatially constant as possible. In principle, it could also be considered that the lens and prism form a joint body having a constant cross-section in the waveguide direction; however, the change in the dielectric constant does not then have to be constant over the entire cross-section because, otherwise, the focusing property and, therefore, also the focal plane would be modified (that is to say that a suitable field progression which is not constant over the cross-section would be required). Instead of said prism-shaped body, a planar, irradiated liquid crystal element, in particular in the form of a one-dimensional grid structure, can also be applied, which deflects the beam in the second spatial direction by applying a voltage between the top and bottom.

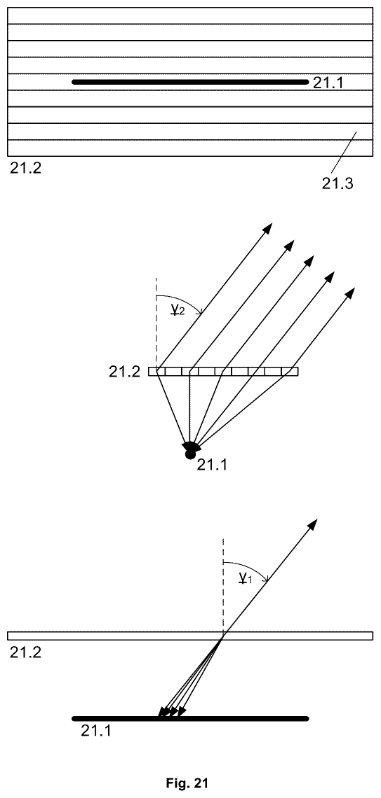

A liquid crystal array can be used as an alternative approach for focusing and scanning. A possible arrangement having a transparent one-dimensional array 21.2 with rod-shaped elements 21.3 is depicted in FIG. 21; the upper view in FIG. 21 shows the array from above, the middle view shows the arrangement and beam path from the direction of the waveguide 21.1, and in the lower view, which is rotated by 90°, the arrangement and beam path can be seen from the side. By applying a respective voltage to the individual rod-shaped elements (between their top and bottom), the phase difference between the wave entering on one side and the wave exiting on the other side can be changed—the phase difference realized depends on the value of the applied voltage. As a result, it can be ensured that the phase of the wave on the top side has a linear progression, as a result of which the focusing (that is to say, generation of a planar wave) and a specified beam angle γ₂ can be realized at the same time; by way of changing the applied voltages, the beam angle γ₂ and, consequently, the scanning in said second beam direction can be realized.

Liquid crystals frequently have the problem that they react slowly to a change in the control, i.e., it takes a fairly long time until they have settled into a new control state, which is very critical when using two-dimensional liquid crystal arrays for two-dimensional scanning, since a changeover has to be made following each pixel. In contrast, the one-dimensional liquid crystal array only has to be changed over following a complete scan in the first spatial direction, that is to say in the example after roughly 4.5 ms, which is completely unproblematic. Compared to a liquid crystal array for two-dimensional scanning, this has the further advantage that far fewer control voltages are required (since there is only one dimension).

The number of rod-shaped liquid crystal elements required and, consequently, the number of control voltages required can be reduced by deploying an additional lens, which substantially takes over the focusing in the second spatial direction and has a constant cross-section again in the direction of the waveguide; this is because the liquid crystal array then substantially only has to sweep the beam direction, which permits a distance which is well above the free space wavelength λ₀=1550 nm, in particular in the case of a small sweeping range.

One disadvantage of the first approach with a lens and a prism with controllable refraction, which is explained above, is that a high degree of precision of the lens geometry and of its distance from the waveguide is required (otherwise optical blurring occurs, for example due to a shift in the focal plane); the high precision required results in outlay in sensor manufacture and/or increased parts prices due to low mechanical tolerances. On the other hand, in the case of the second approach based on a liquid crystal array, position errors can be easily compensated for by appropriately controlling the elements of the liquid crystal array to correct the corresponding phase errors; the same applies to errors in the position and cross-section of any lens which may additionally be used.

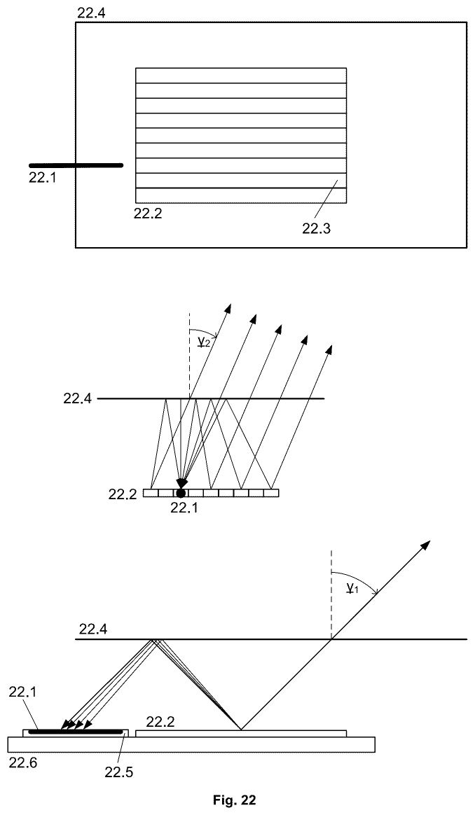

Instead of the previously considered transparent liquid crystal array according to FIG. 21, a reflective liquid crystal array can also be used; a phase difference between incoming and outgoing waves can also be effectively realized by way of a voltage which is applied in each case for a reflective liquid crystal array, which can also be seen as a change in the local angle of emergence relative to the angle of incidence. A corresponding arrangement is depicted in FIG. 22; the upper view shows the arrangement having a waveguide 22.1, a polarization-dependent mirror 22.4 (reflects for one polarization and lets radiation through for the polarization perpendicular thereto) and a one-dimensional reflective array 22.2 and having rod-shaped elements 22.3 and having a 90° polarization rotation from above, the middle view shows the arrangement and beam path from the direction of the waveguide 22.1, and in the lower view, which is rotated by 90°, the arrangement and beam path can be seen from the side. The mirror 22.4 for deflecting the beams makes it possible for the photonic chip 22.5, on which the waveguide is located, and the liquid crystal array 22.2 including its control to be located on a circuit board 22.6, which reduces complexity and manufacturing costs. Of course, an arrangement without a mirror 22.4, that is to say with a direct beam path between the waveguide and the reflective liquid crystal array, could also be realized, for which, e.g., two circuit boards would then be required.

One or more further mirrors can be deployed to deflect the beam, e.g., if the optical axis of the sensor is to be located perpendicularly to the circuit board.

All further considerations which have been made above in the case of the arrangement having a transparent liquid crystal array also apply to the arrangement having a reflective liquid crystal array-including in particular the fact that manufacturing tolerances of the optically relevant components and their arrangement with respect to one another can be compensated for by appropriately controlling the elements of the liquid crystal array.

So far, the liquid crystal array has been considered to be one-dimensional. However, due to tolerances (e.g., of the liquid crystal array itself with no constant thickness or no constant optical properties over the extent of the rod-shaped elements), it could be that no absolutely planar wave is generated in the first spatial direction (that is to say, the direction defined by the waveguide). In order to avoid this, the rod-shaped elements could be divided into multiple individual elements—as depicted in FIG. 23—and phase errors could be compensated for by appropriately controlling said elements. However, such a two-dimensional liquid crystal array is more complex and requires more control voltages. Compared to a two-dimensional liquid crystal array for two-dimensional scanning, however, considerably fewer elements are required in one dimension (in which rod-shaped elements are subdivided to compensate for errors).

Instead of a reflective liquid crystal array, a reflective liquid crystal element, in particular in the form of a one-dimensional grid structure, can also be applied, which deflects the beam in the second spatial direction by applying a voltage; the grid structure can optionally also have multiple regions controlled by different voltages, in particular in order to compensate for production tolerances of the optically relevant components and their mutual arrangement. To this end, the beam must then, however, have already been focused beforehand; compared to the arrangement in FIG. 22, either a focusing mirror (having an approximately parabolic form), a reflective lens (that is to say having a reflective coating on one side) or a combination of mirror and lens is required, wherein said elements still have a constant form in the direction of the waveguide.

Finally, it should be mentioned that materials, the optical properties of which can be changed by applying an electric control quantity, can also be deployed in arrangements other than those explained above in order to realize the scanning in the second spatial direction.

### Arrangement of the Waveguides and Scanning Pattern

As already mentioned multiple times above, there are parallel transceiver paths, e.g., 32, and, therefore, also 32 waveguides; the aim of the following is to explain how these can be arranged and designed with respect to one another on the photonic chip. Said waveguides can be fundamentally deployed in order to realize an additional parallelism during capturing in the first spatial direction (with scanning via waveguides with frequency change) and/or the second spatial direction (with scanning via material having electrically controllable optical properties, e.g., in the form of a liquid crystal array).

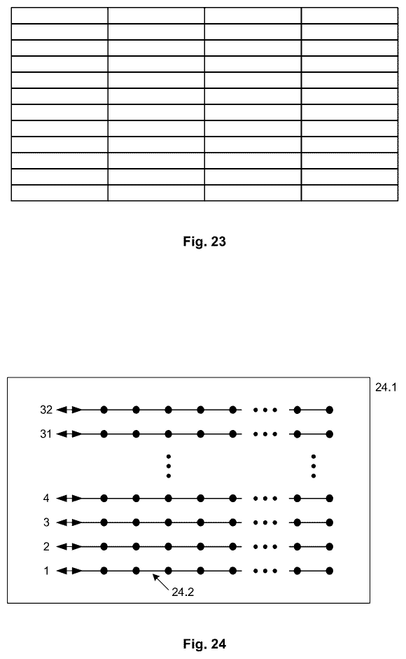

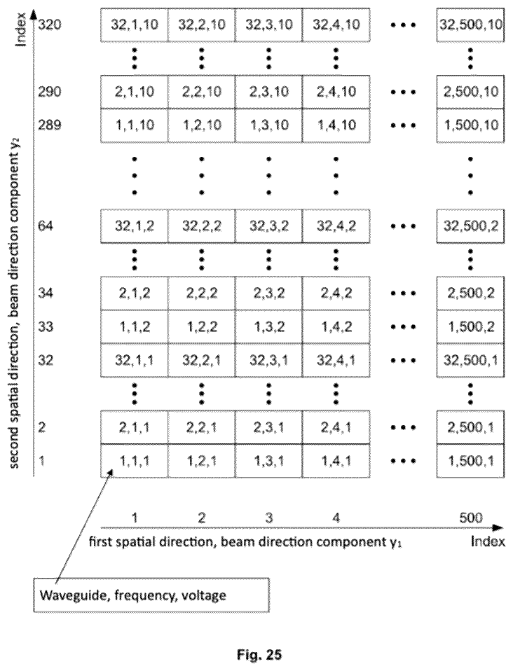

First, the approach that all waveguides are deployed for parallelism, that is to say parallel capturing in the second spatial direction, is to be considered. As depicted in FIG. 24, the 32 waveguides 24.2 are then arranged parallel next to one another on the photonic chip 24.1 (a possibly meandering progression is not shown there for diagrammatic reasons); all waveguides are designed in the same way so that they each realize the same beam angle γ₁ at the same frequency. Depending on the distance between the waveguides, they can address directly adjacent pixels or pixel lines, or pixel lines which are further apart, between which other pixel lines are located, with regard to the second spatial direction; it is at least approximately the case that the geometrical distance between the waveguides is proportional to the geometrical distance between the pixel lines realized by them (if larger angles are ignored). First, such a distance of the waveguides is assumed that they realize 32 directly adjacent equidistant pixel lines. FIG. 25 shows how the two-dimensional pixel field (i.e. the scanning pattern) is then opened up; the nomenclature utilized here for the individual pixel assignments, “w,f,u”, is defined as follows:
w denotes the number of the respective waveguide: w=1, . . . , 32,
f refers to scanning with the aid of the waveguides by continuous frequency change, that is to say, to continuous scanning in the first spatial direction and, consequently, for component γ₁ of the beam direction; said continuous scanning opens up all 500 pixels over said first spatial direction, wherein f=1, . . . , 500 is defined as the number of the respective frequency (more precisely, the respective center frequency, since the frequency does of course change continuously within one pixel),
u refers to stepwise scanning with the aid of a material having electrically controllable optical properties, e.g., in the form of a liquid crystal array controlled via voltages, that is to say stepwise scanning in the second spatial direction and, consequently, for component γ₂ of the beam direction; u denotes the number of said stepwise scanning (and, therefore, the gradually changed electric control quantities, e.g., of the applied voltages)—following a continuous frequency scan in the first spatial direction, which lasts roughly 4.5 ms, a step to a new γ₂ is made, i.e., the next continuous frequency scan is performed at a new γ₂; because each of the 32 waveguides already realizes a different γ₂ itself, only 10 scanning steps u=1, . . . , 10 are necessary for 320 pixels in said second spatial direction, that is to say for 320 different γ₂, and the beam direction jumps by 32 pixels from step to step.

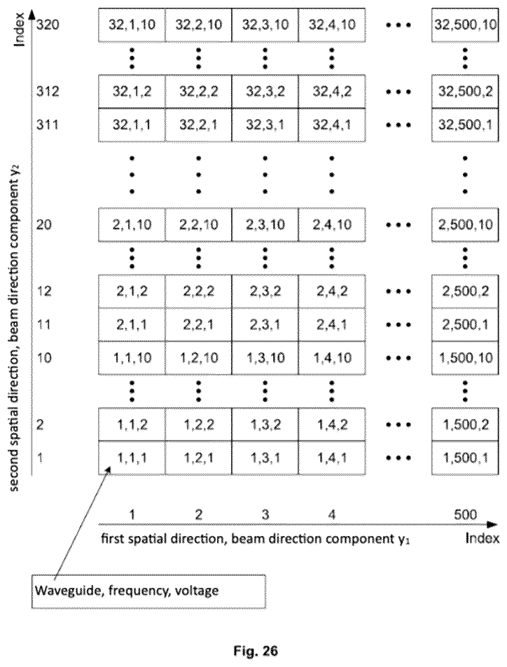

The small spacing of the waveguides required for this arrangement can be difficult to implement, in particular in the case of a strong meandering progression of the waveguides. Alternatively, the spacing can be increased by a factor of 32 so that the waveguides realize pixel lines at a distance of 32; this is depicted in FIG. 26. During scanning in the second spatial direction, only one pixel is jumped per step; this means a strong reduction in the required scanning region in the second spatial direction, that is to say by way of material having electrically controllable optical properties, which is advantageous for such an approach and can open up simpler or more realization possibilities. Such an arrangement also allows the approach mentioned above that by selecting a different frequency modulation bandwidth B in adjacent scanning planes, the sign determination of the receive frequency in the case of a real-valued mixer is made possible, provided that an object is seen in at least two adjacent pixels (that is to say from adjacent scanning planes, i.e., pixel lines); to this end, an alternating direction of the continuous frequency scanning is to be applied for the first spatial direction over the 10 scanning steps u=1, . . . , 10, which realizes an alternating algebraic sign of the modulation bandwidth B.

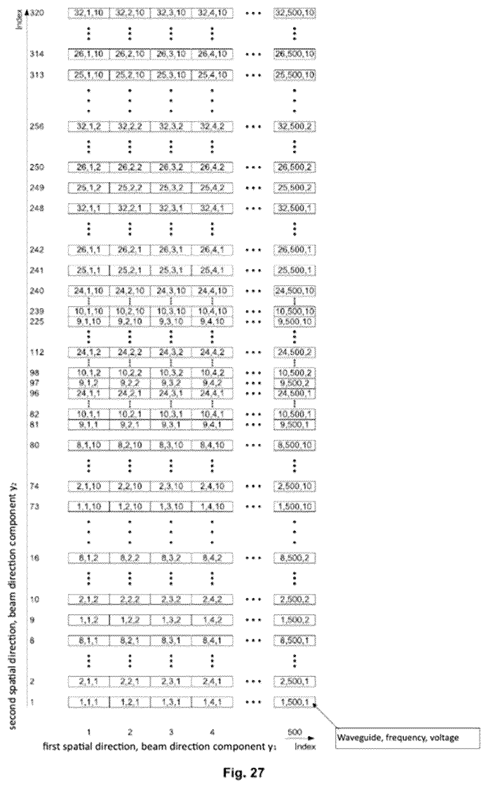

So far, it has been assumed that the waveguides are at least located approximately equidistant with respect to one another, which also results in an equidistant spacing of the pixels in the second spatial direction. However, maximum resolution is often only required in the central angular range, while it can decrease towards the outside-larger gaps between the pixels are also possible there. This can be achieved by a non-equidistant arrangement of the waveguides. As a simple case, a small spacing a, which is equal in each case, is assumed for the 16 middle waveguides (such that that there are no gaps between the pixel lines generated by them), while the 8 outer waveguides are, in each case, twice the distance 2.a between one another and there is a large distance 146.a between them and the group of the 16 middle waveguides. The resulting two-dimensional pixel field is depicted in FIG. 27; during scanning in the second spatial direction, a jump of 16 times the pixel distance (based on the pixel distance in the middle region) is made per step. In the upper and lower thirds of the pixel field, the capturing is now only half as dense as in the middle.

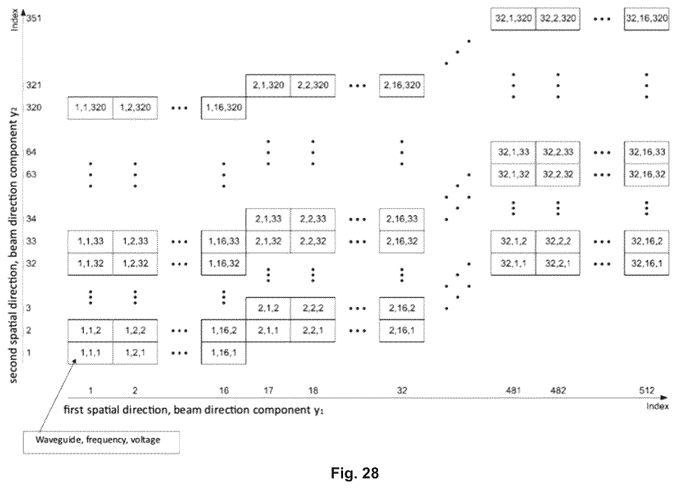

In contrast to the previous arrangements, the waveguides can also be deployed for parallelism, that is to say parallel capturing in the first spatial direction. To this end, the waveguides are designed differently so that they realize different beam angles γ₁ at the same frequency; the waveguides which are still arranged parallel to one another (as in FIG. 24) can also still have coupling locations at the same distance, only then is, e.g., the length of the meandering waveguide between two coupling locations to be designed differently. FIG. 28 shows the resulting two-dimensional pixel field for a small and constant distance between the waveguides; the distance is selected so that the pixel lines realized in the second spatial direction are each one pixel apart. The different configuration of the 32 waveguides is selected so that they realize a beam direction component γ₁ (in the first spatial direction) which differs by 16 pixels in each case at the same frequency; that is to say that, in order to capture the complete first spatial direction (now consisting of 16·32=512 pixels), only continuous frequency scanning over 16 pixels is necessary, so that the frequency number only extends over the range f=1, . . . , 16. The stepwise scanning in the second spatial direction (with the aid of a material having electrically controllable optical properties) must now completely cover this spatial direction, that is to say all 320 pixels, so that 320 steps are necessary. As can be seen in FIG. 28, the two-dimensional pixel field now no longer has a precise rectangular shape, but rather forms a parallelogram. An approximately rectangular shape with a slight rotation can be realized by slightly modifying the frequency range utilized for scanning in the first spatial direction in the case of each of the 320 steps for the second spatial direction. The slight rotation of said rectangle can be compensated for by arranging the photonic chip, rotated accordingly, on the circuit board or already rotating the arrangement of the waveguides on the chip itself.

The advantage of said approach is that either the frequency range required for scanning in the first spatial direction is much smaller (by a factor of roughly 32, which is an advantage for the realization of the laser source), or that with the same frequency range as previously, the waveguide requires a much lower frequency-related sensitivity of the phase difference Δφ, as a result of which its length becomes much shorter between two coupling locations, as a result of which its line losses also reduce; however, the frequency change per pixel is then much higher, so that continuous scanning could result in a sampling frequency which is too high, so that a stepwise scanning frequency change would then be necessary.

One disadvantage of said approach is that the increased number of steps results in a slightly higher overhead for reconfiguring the control quantities for scanning (for the material having electrically controllable optical properties and for the frequency modulation of the laser source).

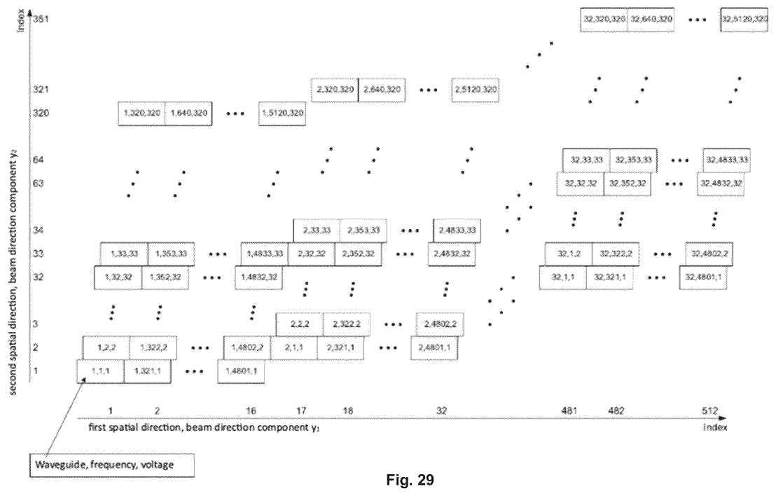

This disadvantage of the increased overhead for reconfiguring the control quantities for scanning and also the above-mentioned problem of the too high sampling frequency can be remedied by carrying out a continuous scanning instead of the stepwise scanning in the second spatial direction—that is to say, the control quantity for the material having electrically controllable optical properties is not changed in a stepwise manner, but rather continuously. During a continuous scan over the entire capturing region in the second spatial direction, the continuous scanning by way of frequency only moves one pixel further in the first spatial direction; this is depicted in FIG. 29. That is to say that a total of 16 continuous scans are required in the second spatial direction. This approach makes the continuous frequency scanning much slower, so that when using a simple waveguide having a low frequency-related sensitivity of the phase difference Δφ, the temporal frequency change (that is to say the approximately linear frequency modulation superimposed on the phase modulation) is small enough in order to manage with a moderate sampling frequency. During said continuous scanning in the second spatial direction, the frequency scanning for the first spatial direction could also be designed in a stepwise manner, that is to say keeping the frequency constant during each scan in the second spatial direction and thereafter setting it to a new value for the next scan in the second spatial direction; that is to say, 16 different frequencies would then be used. Instead of one laser source which can be adjusted in frequency, 16 laser sources having different constant frequencies could, e.g., also be utilized, where the changeover would then take place between said laser sources.

The continuous scanning in the second spatial direction can be carried out at a non-constant scanning speed, for example in order to realize a higher angular resolution in the direction of travel in the case of a lidar sensor facing in the direction of travel than towards the edges of the capturing region.

The parallel capturing by the 32 waveguides can, of course, also be divided into both spatial directions in order to combine the resulting advantages (with a reduced range of advantages, of course).

The approach with multiple different waveguides for different beam direction regions in the first spatial direction can also be realized in the case of simpler lidar systems with fewer pixels so that there is in particular only one transceiver path which can be changed over to multiple waveguides; as a result, the required frequency tuning range of the laser source is in particular reduced.

### Alternative Approaches for Scanning in the Second Spatial Direction

So far, the use of a material having electrically controllable optical properties has been assumed for scanning in the second spatial direction. Of course, other approaches are also conceivable.

In the previous example of continuous scanning in the second spatial direction (that is to say, the scanning pattern according to FIG. 29), a mechanical approach could, for example, also be utilized (e.g., with a rotating mirror or prism).

The scanning patterns according to FIGS. 25-27 with stepwise switching in the second spatial direction could be realized in that there is not only one waveguide lying on each of the 32 parallel transceiver paths, but rather, e.g., 10 waveguides, between which it is possible to change over; this then results in an arrangement having 320 waveguides lying next to one another, of which only 32 are utilized in each case during a frequency scan for the first spatial direction. It should also be mentioned that in the case of such an approach, cascaded single switches (that is to say having two inputs and one output) are utilized for changing over, so that the entire switching matrix then has a power of two of inputs, that is to say, e.g., 8, which in the above example would mean 256 waveguides and, consequently, 256 pixels in the second spatial direction. If the pixels in the second spatial direction are to be located less densely towards the outside, that is to say, have a larger angular distance, then the distance between the waveguides lying next to one another is to be increased towards the outside. If the pixels are located less densely towards the outside, then in order to avoid capturing gaps it can be advantageous, in general (that is to say, not only in this exemplary embodiment), if the beam width in the respective spatial direction increases towards the outside, which is frequently already inherent due to optical focusing errors or can otherwise be realized in this example by positioning the waveguides outside the focal plane.

For a simple lidar system, in particular with a reduced number of pixels in the second spatial direction, it may also be sufficient to use one transceiver path with switching matrix on multiple adjacent waveguides for detecting the two spatial directions.

It should subsequently be mentioned that for all of the above approaches, the two spatial directions which are perpendicular to one another are advantageously placed in the horizontal and vertical capturing direction, that is to say, virtually assigned to azimuth and elevation, wherein—as already mentioned above—the two beam direction components γ₁ and γ₂ do not correspond to the definition of azimuth and elevation in spherical coordinates. Fundamentally, both assignments are possible, i.e., both spatial directions can be utilized for the vertical or horizontal capturing direction; there may be an advantageous assignment due to different capturing range and/or different resolution.

### Determination of Angular Errors

The beam direction having the components γ₁ and γ₂ depends on the control quantities and the hardware properties, in particular on:
the relationship between the beam angle γ₁ of the waveguide and the frequency,
the relationship between the laser frequency and its control quantity,
the relationship between the beam angle γ₂ and the control quantity or quantities for the material having electrically controllable optical properties.

Such relationships can, in particular, vary from sensor to sensor, over temperature and over aging. In order to correctly capture the surroundings, said relationships must be known precisely, otherwise angular errors will occur (measured and actual angle do not match), that is to say in particular distorted and shifted capturing images. While the variations between the sensors can be determined initially in production, this can often not be realized for temperature dependencies (as otherwise measurement outlay in production becomes too high), and aging effects can on principle only be determined during the lifetime of a sensor. For this reason, a method is required, which can determine angular errors during operation; based on this, they can be compensated for by changing the control, that is to say changing the selection of the control quantities.

In addition to angular errors of the sensor due to changed hardware properties, the sensor can also have a misalignment in the vehicle (in particular due to mechanical tolerances, vehicle loading and aging effects). Such a misalignment has a constant effect over all capturing directions of the associated spatial direction, while the imaging errors due to the hardware can be angle-dependent.

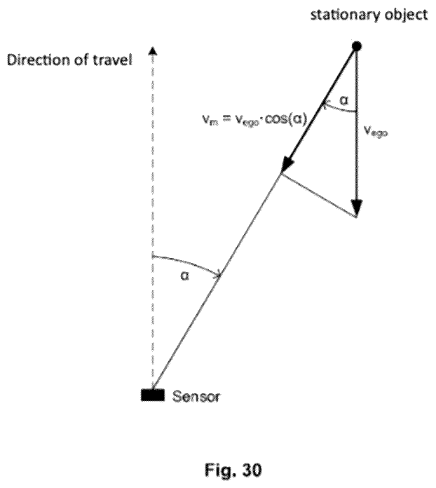

The aim is to now explain how imaging errors can be established for sensors facing the direction of travel. It is known of radar sensors that angular errors (in particular due to misalignment) can be determined by comparing the measured radial relative speed of stationary objects with the vehicle's own speed. The radar sensor measures the radial component of the relative movement of an object; a stationary object relatively moves towards the sensor parallel to the travel direction at the vehicle's own speed v_{ego} so that for the measured radial component vₘ of said movement—as depicted in FIG. 30—v_{ego} must be multiplied by the cosine of the azimuth angle α of the stationary object:

$${v}_{m} = {v}_{ego} \cdot cos ( α ) . \qquad ( 59 )$$

However, said relationship only applies at the elevation angle of zero; since radar sensors only have a small capturing range in elevation around roughly 0° and the above relationship also applies to small elevation angles with very good approximation, it is mostly the only one utilized for radar sensors. If the radar sensor is misaligned, the azimuth angle αₘ measured by the sensor does not correspond to the real azimuth angle α, i.e., the expected measuring speed v_{ego}·cos(αₘ) does not correspond to the really measured speed v_{ego}·cos(α). The real angle α can be fundamentally determined with the aid of the relationship (59) and the difference from the measured angle then constitutes the misalignment. However, it must also be taken into account that radar sensors frequently only capture objects for small azimuth angular ranges (at least in good quality), the cosine for small angles (that is to say around zero) is very flat and the ego speed measured by the vehicle itself and communicated to the sensor is, as a general rule, not of good quality. For this reason, a parabolic regression (cosine corresponds to a parabola for small values) is performed over the measured relative speeds vₘ(αₘ) of many stationary objects and the angle of the misalignment then results from the parabolic shift.

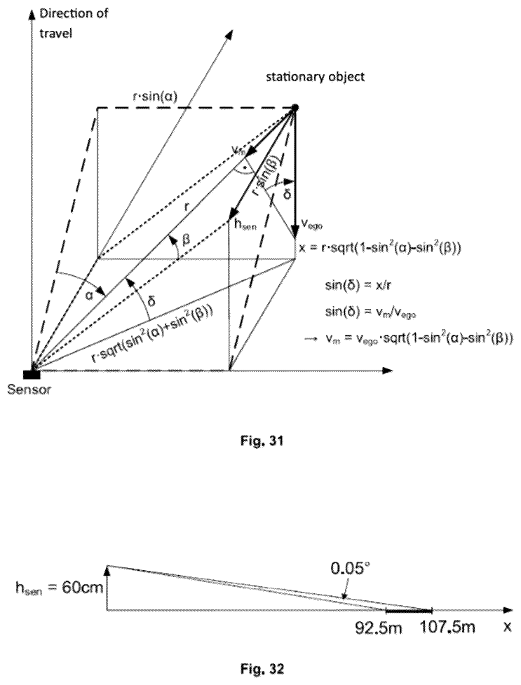

Like a radar system, a coherent lidar system can directly measure the Doppler, that is to say the radial relative speed (both systems work coherently and only differ de facto in the frequency range). Consequently, the above approach can be transferred to lidar systems. For lidar systems, in addition to misalignment, angle-dependent imaging errors due to changed hardware properties can also be recognized, both in the horizontal and vertical spatial direction; that is to say that, instead of relationship (59), the relationship is required which takes into account the beam direction component α in the horizontal spatial direction as well as the beam direction component β in the vertical spatial direction and is deduced in FIG. 31:

$${v}_{m} = {v}_{ego} \cdot sqrt ( 1 - {sin}^{2} ( α ) - {sin}^{2} ( β ) ) . \qquad ( 60 )$$

If one of the two angles is zero, this results with the aid of cos²(γ)+sin²(γ)=1 in:

$${v}_{m} = {v}_{ego} \cdot cos ( α ) for β = 0 , \qquad ( 61 a )$$

$${v}_{m} = {v}_{ego} \cdot cos ( β ) for α = 0 , \qquad ( 61 b )$$

which also corresponds to the above relationship (59). The following applies with very good approximation to small absolute values of the angles α and β:

$${v}_{m} = {v}_{ego} \cdot cos ( α ) \cdot cos ( β ) for small \vert α \vert and \vert β \vert . \qquad ( 61 c )$$

According to relationships (60) and (62c), the measured relative speed depends on both angles α and β of the respective pixel; for this reason, it is not possible to determine the relative speed from a pixel if the angular errors in both spatial directions are not known. However, the angular errors in both spatial directions are independent of one another (they are only determined by hardware properties or control quantities for the respective spatial direction); in the case of a pixel field of size 500×320, there is then a total of 820 error quantities (if the extreme case is assumed that the errors of adjacent pixels are, in each case, independent in the two spatial directions). If there were a stationary object in each pixel, then there would be 500.320 measured values in order to determine only 820 error quantities, that is to say much more than necessary (820 measured values would be sufficient). In actual fact, on the one hand, there are stationary objects in a smaller number of pixels, but on the other hand, within one spatial direction, the errors of adjacent pixels are not independent, but rather the progression of the angular error can be described with sufficient accuracy by way of an error curve having few parameters (e.g., a polynomial, or multiple sections with a linear or parabolic progression) so that only said few unknown parameters are to be determined; for this, there are typically enough measured values per capturing cycle- and if necessary, the determination can also be extended over multiple or many cycles since temperature and aging effects occur comparatively slowly.

Stationary reflections are obtained very reliably from the road surface in the immediate region; they cover a large region or the entire region in the horizontal spatial direction. Because the sensor measures the distance r of the reflections of the road surface and the installation height hₛₑₙ is known, the real angle β in the vertical spatial direction is also known, for which the following applies according to FIG. 31:

$$sin ( β ) = {h}_{sen} / r . \qquad ( 62 )$$

Using relationships (60) and (61c), in which there is therefore only one unknown, the progression of the angular error for the horizontal spatial direction α can then be determined, wherein in the case of the typically given small elevation angles and, therefore, when using relationship (61c) following division by cos(β), it is possible to simply average over road reflections of different β (that is to say from different distances) before establishing the angular error from the resulting progression in the horizontal spatial direction α. If the angular errors in the horizontal spatial direction and, therefore, the actual value of a for each pixel are known, then the angular error in the vertical spatial direction β can be determined from each pixel (that is to say including those which cannot be assigned to the road surface) (there is then only one unknown in relationships (60) or (61c)).

To determine the angular errors with the aid of stationary objects, the vehicle's own speed v_{ego} is required with high accuracy, which is mostly not guaranteed by the own speed measured by the vehicle itself and communicated to the sensor. For this reason, the lidar sensor must determine the own speed itself. In the simplest case, this is done by determining the maximum of the measured radial relative speeds since, according to relationship (60), the measured relative speed can assume a maximum of the vehicle's own speed—this is the case in the direction of travel (that is to say, at α=β=0°). However this approach assumes that there are stationary reflections in the direction of travel or at least close thereto and that the relative speed measurement is very precise (that is to say in particular not noisy due to a poor signal-to-noise ratio). As mentioned above, the progression of the angular errors per spatial direction can be described sufficiently precisely by way of an error curve having few parameters (e.g., a polynomial, or multiple sections having a linear or parabolic progression) so that only said few unknown parameters are to be determined from the measured values (that is to say the measured relative speeds of stationary objects); if the vehicle's own speed is unknown, this is added as a further unknown and is then established at least implicitly.

If the angular errors are known, they can be corrected in the detection list established by the sensor, that is to say the real angles can be indicated for the detections. The progression of the control quantities utilized for scanning can be additionally adjusted for following capturing cycles in order to eliminate the angular error (if necessary, in an iterative manner)—including in particular in order to precisely realize the capturing range of the two-dimensional pixel field, which is striven for.

### Determining the Position of the Road Surface at Greater Distances

It was explained above that the road surface can be utilized to determine angular errors; reflections of the road surface in the closer region were utilized.

Reflections of the road surface at greater distances provide information about the exact position of the road surface at the respective distance (that is to say in which pixel and, consequently, at which vertical angle the road surface is located there, if necessary, further improved to subpixel accuracy by interpolation), which can be helpful for interpreting the captured data. The precise determination of the height of an object lying on the road is indicated as an example; if not only the measured reflection points of the object, but also the precise position of the road surface is known in the case of this object, the height determination is more accurate. It should be noted that the position of the road surface is only known a priori in the near range from the known sensor height and because of the assumption of a non-curved road progression which is valid over short distances; that no longer applies at greater distances (a curved road progression, e.g., in a depression, then has a strong effect) and in addition, even small modifications in the vertical sensor alignment (e.g., due to a slight vehicle inclination when braking and accelerating) already have a significant effect there. However, a lidar sensor generally captures the reflections of the road surface at greater distances too weakly in order to be able to detect them; FIG. 32 shows a key reason for this (representation not to scale in the vertical direction for better understanding). There, a beam having a width of 0.05° is depicted, the center of which hits the planar road at a distance of 100 m, wherein the sensor installation height hₛₑₙ=60 cm; due to the very low angle of incidence on the road, the beam is projected onto the road over a distance range of roughly 15 m. This means that in the two-dimensional correlation E_{m,k} the road surface is visible over roughly 30 discrete distances m (that is to say not only at one m₀), so that the received power is divided into a corresponding number of values in the two-dimensional correlation, which results in a very poor signal-to-noise ratio and can therefore prevent a detection. Said reduction in the received power per distance value m of the two-dimensional correlation can also be explained by the fact that only roughly 1/30 of the beam width and, therefore, of the emitted power is effective per distance value.

For a better detection of the road surface, it is possible to exploit the fact that it is seen over many pixels based on the horizontal spatial direction α, that is to say that there are many pixels in which the beam center hits the road surface at the same distance; due to relationship (62), said pixels have the same beam angle β, that is to say for the vertical spatial direction. A first approach consists of accumulating the two-dimensional correlation E_{m,k} non-coherently over said pixels (in the region of the predicted direction of travel), that is to say in particular by using their absolute-values or power values, wherein this is done at least for all of the values of the discrete distance m where the road can be located. The road is then located at the distances m where the accumulated value is sufficiently far above the noise level; the noise level in the individual two-dimensional correlation E_{m,k} is of course known (it is determined, for example, with the computational logic according to FIG. 8 and FIG. 10), and the noise level can be calculated therefrom following non-coherent accumulation according to theoretical relationships- or it can be estimated directly via the resulting values of the non-coherent accumulation, wherein a sufficiently large range of m and, if necessary, different values of the discrete frequency k must then be evaluated. As explained above, the road is seen in an entire range of the discrete distance m which, in the example above, extends over roughly 30 values of m; the center m₀ of said region roughly constitutes the actual distance of the road. Instead of doing the non-coherent integration in each case only over values at a discrete transit time m, it can also be extended over multiple adjacent values of m, since the road is of course also seen over numerous m.

The above evaluation does not have to be done for each discrete frequency, but in principle only for that frequency k₀ where the road reflections are located; since the vehicle's own speed is known (with the aid of the high-quality capturing data from the lidar sensor itself), said discrete frequency is, as a general rule, known fairly precisely, so that the calculation only has to be performed for one or a few discrete frequencies k. When using a computational logic according to FIG. 8 or FIG. 10, the values of the two-dimensional correlation E_{m,k} for said discrete frequencies are to then be output. If said discrete frequencies can vary, a realization of the output is then very complex; for this reason, when using the computational logic according to FIG. 10, it is advantageous to always have the required discrete frequencies at the same outputs of the computational logic by selecting the twiddle factors d_{n,m} depending on the own speed.

Instead of a non-coherent integration over values of the two-dimensional correlation E_{m,k}, the following second approach can also be selected: the receive sequence e(n) of one pixel is split into two sequences of half the length, wherein the first sequence is formed from the even-numbered n and the second sequence from the odd-numbered n. The respective two-dimensional correlation is determined for said two subsequences and then, for each relevant distance m and frequency k, the value of the one correlation is multiplied by the complex-conjugated value of the other. There is a phase difference between the two subsequences, which results from the receive frequency fₑ and the time interval between two sampling values in each case, that is to say the sampling time Tₛ; the product formed from the two correlations has a complex value at the distance m and the frequency k₀ of the road reflections, the phase of which complex value corresponds to said phase difference, wherein said statement of course only refers to the signal component, not to the superimposed noise.

In the case of a value of m, said phase is at least approximately constant over all of the pixels with road reflections, since the relative speed and, therefore, the receive frequency fₑ can be considered to be constant in the small angular range of the road around 0° (cos(α) in relationship (61c) is of course then approximately =1). For this reason, the product can be integrated coherently over the pixels, that is to say added up, which causes a greater improvement in the signal-to-noise ratio than in the case of non-coherent integration. If integration is additionally to be conducted over different m, the distance-dependent frequency component fᵣ in the receive frequency fₑ must be corrected according to relationship (12), preferably as part of the twiddle factors d_{n,m} in the computational logic according to FIG. 10. When using said computational logic, the two two-dimensional correlations for the subsequences of e(n) having even and odd n are also inherently present- and indeed at the output of the penultimate stage of the FFT in alternating sequence. The further considerations and evaluations apply as for the first approach with non-coherent integration.

This second approach with formation of the product from two correlations and totaling over pixels can also be generalized. The important thing here is that the two correlations at least partially utilize received signals which originate from the same reflection points on the road, that is to say the same areas, so that a defined phase relationship is obtained. For example, the first and second half of the receive sequence per pixel could also be used to calculate the two correlations, or the correlations of two adjacent pixels, provided they overlap; however, as the received values associated with the two correlations are then further apart in time, one may be sensitive to a changing speed (the phase difference can then change over the sequence of pixels).

Sign Determination of the Receive Frequency in the Case of a Real-Valued Mixer with the Aid of Non-Binary Phase Modulation

In the case of the binary phase modulation previously considered with the two phase values 0° and 180° and using a real-valued mixer, two peaks occur at (m₀,+k₀) and (m₀,−k₀) in the two-dimensional correlation E_{m,k}, so that only the amount of the receive frequency can be established. It was shown above how said ambiguity can be at least partially resolved with the aid of a superimposed linear frequency modulation. An alternative approach for determining the sign of the receive frequency in the case of a real-valued mixer is presented below.

The phase modulation φ_{TX}(n) should now not consist of the two binary values 0° and 180°, but rather of a set of J phase values φⱼ, where j=0, . . . , J−1 which can assume general phase values; furthermore, the phase modulation changes irregularly, in particular pseudo-randomly, over said J phase values. The phase modulation sequence can then be described by a complex-valued

$$b ( n ) = exp ( \hat{J} \cdot {φ}_{TX} ( n ) ) \qquad ( 63 )$$

and with the relationship (3a) the receive sequence e(n) of a single object is:

$$e ( n ) = a \cdot exp ( \hat{J} \cdot [ 2 π \cdot n / N \cdot {k}_{0} - {φ}_{TX} ( n - {m}_{0} ) ] ) , \qquad ( 64 )$$

wherein the negative sign of φ_{TX}(n−m₀) results from the fact that it is assumed for the complex mixer—consistently with the above derivations—that it forms the phase differences between the received and transmitted signal (in the other case, that is to say if the mixer were to form a phase difference between the transmitted and received signal, the sign would be positive). In the case of a real-valued mixer, the real part is obtained:

$$e ( n ) = a / 2 \cdot exp ( + \hat{J} \cdot [ 2 π \cdot n / N \cdot {k}_{0} - {φ}_{TX} ( n - {m}_{0} ) ] ) + a / 2 \cdot exp ( - \hat{J} \cdot [ 2 π \cdot n / N \cdot {k}_{0} - {φ}_{TX} ( n - {m}_{0} ) ] ) \qquad ( 65 )$$

The two-dimensional correlation E_{m,k} in the form of the relationship (8) is formed as an FFT over the product sequence

$$p ( n ) = e ( n ) \cdot b ( n - m ) = e ( n ) \cdot exp ( \hat{J} \cdot {φ}_{TX} ( n - m ) ) \qquad ( 66 )$$

wherein b(n) is utilized according to relationship (63) and no complex conjugation is utilized for b(n−m), which corresponds to a correlation with the first component of e(n) in relationship (65) to frequency +k₀ (utilizing the complex conjugate of b(n−m) would correspond to the second component at frequency −k₀). With relationship (65) the following is obtained:

$$p ( n ) = {p}_{1} ( n ) + {p}_{2} ( n ) \qquad ( 67 a )$$

$$where$$

$${p}_{1} ( n ) = a / 2 \cdot exp ( \hat{J} \cdot [ {φ}_{TX} ( n - m ) - {φ}_{TX} ( n - {m}_{0} ) ] ) \cdot exp ( + \hat{J} \cdot 2 π \cdot n / N \cdot {k}_{0} ) and \qquad ( 67 b )$$

$${p}_{2} ( n ) = a / 2 \cdot exp ( \hat{J} \cdot [ {φ}_{TX} ( n - m ) + {φ}_{TX} ( n - {m}_{0} ) ] ) \cdot exp ( - \hat{J} \cdot 2 π \cdot n / N \cdot {k}_{0} ) . \qquad ( 67 c )$$

In the case of the discrete transit time, as distance m=m₀ of the object, the first component p₁(n) constitutes a continuously rotating indicator having the discrete frequency +k₀ of the object (since φ_{TX}(n−m₀)−φ_{TX}(n−m₀)=0), so that following the FFT, that is to say as a result of the two-dimensional correlation E_{m,k}, it forms the peak at the frequency +k₀ and the discrete transit time m₀.

In the case of binary phase modulation (phase values 0° and 180°), the second component p₂(n) generates the peak at frequency −k₀ and discrete transit time m₀, because φ_{TX}(n−m₀)+φ_{TX}(n−m₀)=2·φ_{TX}(n−m₀) can only assume the two effectively identical values 0° and 360° (in both cases, the complex indicator formed by them =1). On the other hand, if other phase values are selected, phase jumps occur in p₂(n), since 2·φ_{TX}(n−m₀) does not only assume integral multiples of 360°. As an example, the J=4 phase values φⱼ=0.90°, 180°, 270° are now considered (that is to say the modulation sequence b(n) assumes the 4 values +1, +j, −1, −j). Then, exp(−ĵ·2·φ_{TX}(n−m₀)) assumes the values +1 and −1, between which a jump is made pseudo-randomly. Since all 4 phase values are used with the same probability or frequency, the mean value of exp(ĵ·2·φ_{TX}(n−m₀)) is at least very closely approximated to zero; at the discrete frequency −k₀ of the object, the contribution of p₂(n) to the two-dimensional correlation E_{m,k}, disappears, so that no peak occurs there anymore. Because now only one peak occurs (in the case of the correct-sign frequency +k₀), the receive frequency is clearly and correctly determined.

The disappearance of the peak at the wrong frequency −k₀ can be realized by each set of J over one revolution, that is to say 360° equally distributed phase values

$${φ}_{j} = 360 ° / J \cdot ( 0 , 1 , ... , J - 1 ) where J > 2 \qquad ( 68 )$$

that is to say, a minimum of J=3 phase values φⱼ=0, 120°, 240° are required with phase values which are evenly distributed over 360°. If the phase values are not evenly distributed over 360° J=2 phase values, e.g. φⱼ=0.90° may be enough for a complete disappearance of the peak at the wrong frequency −k₀. If the phase values are selected differently, the wrong peak at frequency −k₀ is generally not completely eliminated, but rather only reduced; in the example of the J=2 phase values φⱼ=0.45°, the reduction is 3 dB. To recognize the correct peak, the larger of the two peaks at ±k₀ is selected; apart from a poor signal-to-noise ratio, even a small nominal difference in the amounts is sufficient for correct recognition. Generally, it can be said that among the J phase values φⱼ used, there must be at least two phase values which are neither in phase nor antiphase in order to be able to determine the algebraic sign of the receive frequency in the case of a real-valued mixer.

Phase values, in particular if they are not only antiphase, cannot mostly be realized with arbitrary precision. As an example, the J=4 equidistant phase values with nominal position φ_{j,nom}=0.90°, 180°, 270° are considered; their real values should be φ_{j,real}=15°, 75°, 195°, 255°, that is to say their distances have large errors of ±30°. In this case, phase jumps of ±30° and, consequently, a non-constant phase (that is to say a phase jitter) occur in the first component p₁(n), which results in a reduction of the peak at the correct frequency +k₀ by only 0.3 dB and, consequently, only a slight loss of sensitivity (the lost energy migrates into a small noise at other Doppler frequencies k, which, however, lies considerably below the noise level produced by the phase modulation itself in the two-dimensional correlation); at the incorrect frequency −k₀, the peak is no longer completely eliminated, but rather a small constant component in the phases of p₂(n) results in a peak which is 11.4 dB below the peak at the correct frequency +k₀, so that it can still be correctly recognized. It is obvious from this example that even fairly large errors in the realization of the phase values are still not critical.

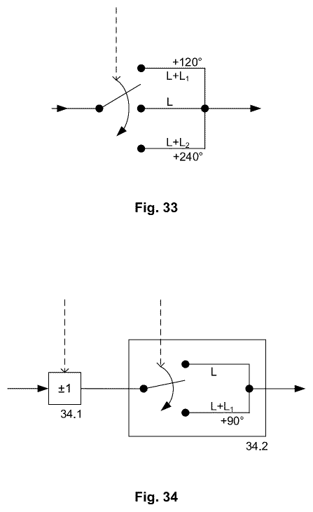

Finally, further possible realizations will be discussed. One approach is to change over between line sections having different lengths; FIG. 33 shows, as an example, the case of J=3 phase values, i.e., a changeover is made between line sections having different lengths, wherein a phase which differs by 120° or 240° is realized by the different length. For the above example of J=4 equidistant phase values, a combination of a switchable inverter 34.1 and a changeover switch 34.2 between two line sections which have a phase difference of 90° can be used—as depicted in FIG. 34.

### Overall System

A lidar system according to the above embodiments comprises or preferably consists of only the following three main components:
a photonic chip, contains:
a frequency-tunable laser source (there is preferably only one; only if the frequency tuning range is too small, are several required),
a phase modulation unit consisting of a switchable inverter,
32 parallel transceiver paths having an optical amplifier, circulator, real-valued heterodyne mixer and photodiode,
32 waveguides (320 waveguides if a switching matrix is utilized for scanning in the second spatial direction),
output with 32 analog received signals in the high MHz range;
a digital chip, contains:
32 analog-to-digital converters for received signals which are output by the photonic chip,
hardwired computational logic for determining the two-dimensional correlation with downstream evaluation,
a microcontroller and/or DSP(s) for further signal evaluation (in particular for determining a detection list) and for calculating the control quantities for laser frequency and scanner for second spatial direction,
control outputs for laser frequency and scanner for second spatial direction (can be analog or digital);
a scanner in one spatial direction (for second spatial direction), realized by:
a material having electrically controllable optical properties, in particular a liquid crystal element or array, or
a switching matrix for each of the 32 parallel transceiver paths, or
a mechanical approach, e.g., in the form of an oscillating or rotating mirror or prism,
wherein a lens unit and/or beam deflection unit is/are still required for some of the approaches.

In an optimal case, all of the electronic components are located on one board; two boards can also be necessary for some arrangements. Costs and the manufactured size can be significantly reduced by the potential for high semiconductor integration of the proposed approach.

In order to reduce the outlay of hardware required, a halved number of parallel transceiver paths can, e.g., be used by halving the data acquisition time per pixel, as a result of which the size and the power consumption of the hardwired computational logic are then halved as well. A general guideline in the case of this concept is that all components are active (that is to say, used) over the entire time and that the total power produced and radiated is utilized for capturing (i.e., in particular, power is only radiated in directions from which data are also being received at the same time).

### Alternative Phase Modulation Form

So far, a pseudo-random binary sequence (that is to say consisting of the two phase values 0° and 180°) repeating with period N according to FIG. 2 has been considered for the phase modulation in the coherent lidar system according to FIG. 1. Instead of a pseudo-random sequence, irregular sequences having another definition could also be used, for example sequences characterized by small side lobes of the autocorrelated part (e.g., a gold code known from the literature). However, at least if high sensitivity is required, irregular sequences always require the complicated determination of the two-dimensional correlation E_{m,k} in particular according to relationship (8) and, consequently, a special computational logic, in particular according to FIG. 8 and FIG. 10. If such a computational logic is not available, but rather only DSPs (in particular having parallel vectorial calculation units), modulation sequences are to be used, which allow a simpler evaluation (but which can also be associated with other disadvantages).

As an example, a sequence and an evaluation approach, which are proposed in the article “Phase-Coded-Based Modulation for Coherent Lidar” by Sebastian Banzhaf and Christian Waldschmidt, published in IEEE TRANSACTIONS ON VEHICULAR TECHNOLOGY, VOL. 70, NO. 10, October 2021, are first considered. There, the binary modulation sequence b(n) of length N is composed of two parts: during the first subsequence b₁(n) of length N₁, the phase is constant, that is to say, e.g.,

$${b}_{1} ( n ) = 1 where n = 0 , ... , {N}_{1} - 1 , \qquad ( 69 a )$$

and the second subsequence b₂(n) of length N₂=N−N₁ is irregular, e.g., pseudo-random:

$${b}_{2} ( n ) = \pm 1 where n = {N}_{1} , ... , N - 1. \qquad ( 69 b )$$

The lengths N₁ and N₂ can be the same, that is to say,

$${N}_{2} = {N}_{1} = N / 2 , \qquad ( 69 c )$$

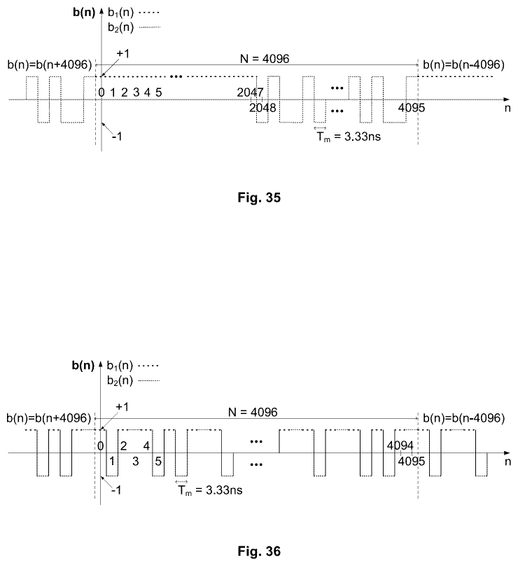

and the modulation sequence can repeat periodically for multiple capturing directions, that is to say pixels; such a modulation sequence is depicted in FIG. 35, wherein the sequence composed of the subsequences repeats with period N=4096.

The following applies to the receive subsequence e_{1,i}(n) generated by an object i regarding the first, constant modulation subsequence b₁(n) according to relationship (3a):

$${e}_{1 , i} ( n ) = {a}_{i} \cdot exp ( 2 π \hat{J} \cdot n / N \cdot {k}_{0 , i} ) where n = {m}_{0 , i} , ... , {m}_{0 , i} + N / 2 - 1 , \qquad ( 70 )$$

i.e., it only carries the Doppler frequency of the respective object which can be determined via a DFT or FFT. Due to the unknown time shifts m_{0,i}, however, the respective exact temporal position of e_{1,i}(n) within the receive sequence e(n) is not known; for the sake of simplicity, it can be assumed, for example, that the time shift is zero, i.e., over the receive subsequence

$${\tilde{e}}_{1} ( n ) = e ( n ) where n = 0 , … , N / 2 - 1 \qquad ( 71 )$$

the FFT is formed

$${\tilde{E}}_{1 , k} = {FFT}_{k} ( {\tilde{e}}_{1} ( n ) ) = {FFT}_{k} ( e ( n ) ) where n = 0 , … , N / 2 - 1. \qquad ( 72 )$$

However, the result of the assumption that the time shift is zero is that there are not any values of the constant modulation subsequence b₁(n) for other actual time shifts m_{0,i}, that is to say in particular for distant targets, in the first m_{0,i}−1 values of the receive subsequence \tilde{e}₁(n), but rather back values of the modulation subsequence b₂(n) of the preceding period; therefore, the height of the respective peak of the FFT, and therefore, its distance from the noise is reduced so that the sensitivity is reduced. The peaks of the FFT \tilde{E}_{1,k} of the receive subsequence \tilde{e}₁ (n) are checked for a detection threshold. The frequencies k_{0,j} of the J peaks lying above the detection threshold are utilized for the further processing; typically, said peaks are seen in two adjacent FFT values (since they do not lie—as previously considered—at an integral Doppler index k₀), so that their exact location, that is to say a non-integral frequency k_{0,j} can then be determined by interpolation in each case. Said frequencies k_{0,j} correspond at least approximately to the Doppler frequencies k_{0,i} of the objects or a subset of these (for objects with very low reflectivity, it can be that they do not result in a peak above the detection threshold).

According to relationship (3a), the second modulation subsequence b₂(n) results, in the receive sequence e(n), in components which are time-shifted by m_{0,i} and multiplied by the respective Doppler frequency k_{0,i}, that is to say modulated

$${e}_{2 , i} ( n ) = {a}_{i} \cdot {b}_{2} ( n - {m}_{0 , i} ) \cdot exp ( 2 π \hat{} \cdot n / N \cdot {k}_{0 , i} ) where \qquad ( 73 )$$

$$n - {m}_{0 , i} = N / 2 , … , N - 1.$$

In order to eliminate the respective modulation by the Doppler frequency, the receive sequence e(n) is, in each case, turned back by the frequency k_{0,j}:

$${\tilde{e}}_{2 , j} ( n ) = e ( n ) \cdot exp ( - 2 π \hat{} \cdot n / N \cdot {k}_{0 , i} ) where \qquad ( 74 )$$

$$n = N / 2 , … , N - 1 + M - 1 and j = 1 , … J - 1 ;$$

the region n=N/2, . . . , N−1+M−1 of the receive sequence e(n) must be considered in which the reception of the second modulation subsequence b₂(n) can lie, wherein M−1 corresponds to the largest object distance which is to be assumed or is of interest. It should be noted that the region n=N, . . . , N−1+M−1 of the receive signal can only be utilized during continual scanning, however, not during switched scanning (then the signal there is not coherent due to the other capturing direction).

The thus modified sequences \tilde{e}_{2,j}(n) include shifted modulation subsequences a₁·b₂(n−m_{0,i}) in the corresponding index j; contributions of objects having other Doppler frequencies k_{0,i} (that is to say, k_{0,i} #k_{0,j}) constitute an uncorrelated modulation sequence for b₂(n), since they are still modulated with the difference frequency k_{0,i}−k_{0,j}. For this reason, the sequences \tilde{e}_{2,j}(n) can now be correlated with the second modulation subsequence b₂(n):

$${\tilde{E}}_{2 , j , m} = {sum}_{n = N / 2 , … , N - 1} ( {\tilde{e}}_{2 , j} ( n + m ) \cdot {b}_{2} ( n ) ) where \qquad ( 75 )$$

$$m = 0 , … , M - 1 and j = 1 , … , J - 1.$$

In said one-dimensional correlations \tilde{E}_{2,j,m}, peaks occur at the points m=m_{0,i}, that is to say at the discrete transit times of objects; in the general case of a non-integral discrete transit time m_{0,i}, the peak extends, during suitable measures (e.g., distortion of the modulation pulses to an approximately triangular shape) over two adjacent values of m, and its non-integral position can be established by interpolation. The Doppler frequency k_{0,i}=k_{0,j} of the object is produced from the index j of the correlation \tilde{E}_{2,j,m}, at which the peak occurs, and the Doppler frequency k_{0,j} belonging to said j. Thus, the distances and radial relative speeds of objects in the respective capturing direction can be determined from peaks of the correlations \tilde{E}_{2,j,m} lying above a detection threshold. It should be noted that contributions of objects having, in each case, other Doppler frequencies k_{0,i} (that is to say, k_{0,i} #k_{0,j}) only result in noise in the respective correlations, that is to say no peaks above a detection threshold, due to the fact that they are not correlated with b₂(n); in the case of roughly equally strong reflection signals from objects, said noise is considerably below the peaks of interest and does not therefore conceal these-only when reflection signals from objects are considerably different can objects having a strong reflection signal conceal weak reflection signals having another Doppler frequency by way of their noise.

With the modulation sequence according to FIG. 35 and the evaluation explained above, in the typical case of one object in one pixel, an FFT is required for the receive subsequence e₁(n) for the first modulation subsequence b₁(n) and a correlation between the second modulation subsequence b₂(n) and the frequency turned-back receive subsequence \tilde{e}_{2,1}(n) for the second modulation subsequence. Said correlation in the time range can also be realized by multiplying the FFTs in the frequency range with a subsequent inverse FFT (an inverse FFT requires the same amount of computational outlay as the FFT itself); the FFT of the modulation subsequence b₂(n) can be determined once a priori, so that only the FFT of the receive subsequence \tilde{e}_{2,1}(n) has to be determined. That is to say that, overall, the outlay of three FFTs is incurred, whereas in the case of the two-dimensional correlation E_{m,k} according to relationship (8), a total of M=500 FFTs are to be calculated, wherein said FFTs have roughly twice the length if the same duration of a pixel is assumed. This therefore results in a very strong reduction of the required computational outlay to a magnitude which modern DSPs having parallel vectorial computing units open up.

In particular, the following points are disadvantageous, compared with a modulation sequence according to FIG. 2 and evaluation by way of a two-dimensional correlation E_{m,k} according to relationship (6) or (8):
The sensitivity is a little more than 3 dB lower when the same duration of a pixel is assumed; half the length of the FFT (from the receive subsequence e₁(n)) as well as half the length of the temporal correlation (from \tilde{e}_{2,j}(n) for the modulation subsequence b₂(n)) results in a loss of 3 dB, and in addition—as explained above—there is the effect that, in particular for distant targets, the first values of the receive subsequence \tilde{e}₁ (n) do not originate from the constant modulation subsequence b₁(n), but rather from back values of the modulation subsequence b₂(n) of the preceding period, so that said values do not effectively contribute to the respective peak of the FFT.
Due to half the length of the FFT, the resolution and accuracy for the Doppler determination, i.e., the determination of the radial relative speed, are worse by a factor of two.
The temporal correlation of \tilde{e}_{2,j}(n) with b₂(n) for determining the distance only has half the length. Therefore, the dynamic range is reduced by 3 dB per pixel in the case of more than one object, i.e., an object having a strong reflection signal increases the noise level relative to the level of an object with weaker reflection signal by 3 dB more, so that the probability of the non-detection of such a second object is higher.
In the case of continuously scanning systems, pixels can fundamentally overlap, i.e., some of the receive values e(n) are utilized for two adjacent pixels, in particular in order to attain a longer data acquisition time per pixel and, therefore, a better sensitivity. In the case of a modulation sequence according to FIG. 35, however, there is only the possibility of an overlap of 50%, since both modulation subsequences are required in each pixel. Smaller overlaps, which are frequently preferred, are not possible.

Said disadvantages of the modulation sequence according to FIG. 35 and of the associated evaluation explained above, which are the prior art, can be remedied to a significant extent by the new modulation sequence according to FIG. 36, without the computing power required for the evaluation significantly increasing. In the case of the modulation sequence b(n) according to FIG. 36, the two previous modulation subsequences b₁(n) and b₂(n) are interleaved in an alternating manner:

$${b}_{1} ( n ) = 1 where n = 0 , 2 , 4 , … , N - 2 , \qquad ( 76 a )$$

$${b}_{2} ( n ) = \pm 1 where n = 1 , 3 , 5 , … , N - 1. \qquad ( 76 b )$$

Consequently, both modulation subsequences extend, in each case, over the full modulation duration, wherein they only take up every second grid value in each case.

The receive subsequence e_{1,i}(n) generated by an object i regarding the first, constant modulation subsequence b₁(n) can either be even or odd values of n, depending on whether the discrete transit time m_{0,i} of the respective object is even or odd (here it is first assumed that m_{0,i} is integral):

$${e}_{1 , i} ( n ) = {a}_{i} \cdot exp ( 2 π \hat{} \cdot n / N \cdot {k}_{0 , i} ) where \qquad ( 77 )$$

$$n = 0 , 2 , 4 , … , N - 2 or n = 1 , 3 , 5 , … , N - 1 ;$$

in the case of this range of the index n, the first values originate from the end of the previous modulation period (due to the transit time of the respective object)—in contrast to the previously considered modulation sequence according to FIG. 35, said values, however, also come from the first, constant modulation sequence, so that they also contribute coherently to the later FFT. Due to the two possible locations of the receive subsequences e_{1,i}(n), the FFT has to now be calculated twice in order to determine the Doppler frequencies of the objects-once over the first sequence

$${\tilde{e}}_{1 , 1} ( n ) = e ( n ) where n = 0 , 2 , 4 , … , N - 2 , \qquad ( 78 a )$$

and once over the second sequence

$${\tilde{e}}_{1 , 2} ( n ) = e ( n ) where n = 1 , 3 , 5 , … , N - 1. \qquad ( 78 b )$$

The two FFTs

$${\tilde{E}}_{1 , 1 , \underline{k}} = {FFT}_{\underline{k}} ( {\tilde{e}}_{1 , 1} ( n ) ) = {FFT}_{\underline{k}} ( e ( n ) ) where n = 0 , 2 , 4 , … , N - 2 , \qquad ( 79 a )$$

$${\tilde{E}}_{1 , 2 , \underline{k}} = {FFT}_{\underline{k}} ( {\tilde{e}}_{1 , 2} ( n ) ) = {FFT}_{\underline{k}} ( e ( n ) ) where n = 1 , 3 , 5 , … , N - 1 \qquad ( 79 b )$$

refer to the output dimension, that is to say the discrete frequency k=0, . . . , N/2−1, which is related to the previously considered discrete frequency k due to the effective half sampling rate over

$$\underline{k} = {mod}_{N / 2} ( k ) \qquad ( 80 )$$

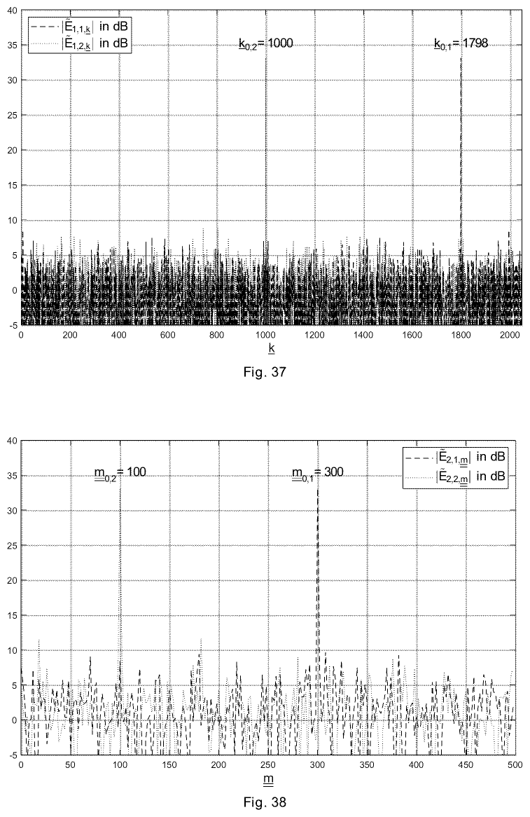

The two FFTs are depicted in FIG. 37 according to relationship (79), as regards amount, for two objects of the same receive amplitude at (m_{0,1},k_{0,1})=(300,3846) and (m_{0,2},k_{0,2})=(101,1000); the first object during the even discrete transit time m_{0.1}=300 forms a peak in the first FFT \tilde{E}_{1,1,k} in the Doppler frequency k_{0,1}=k_{0,1}−N/2=1798, the second object during the odd discrete transit time m_{0.2}=101 forms a peak in the second FFT_{1,2,k} at the Doppler frequency k_{0.2}=k_{0.2}=1000.

The peaks of the two FFTs \tilde{E}_{1,1k} and \tilde{E}_{1,2,k} are checked for a detection threshold. The frequencies k_{0,j} of the J peaks lying above the detection threshold are utilized for the further processing; typically, said peaks are seen, in each case, in two adjacent FFT values (since they do not lie—as considered in the above example—at an integral Doppler index k_{0,j}), so that their exact location, that is to say a non-integral frequency k_{0,j}, can then be determined, in each case, by interpolation. With the exception of a possibly missing component N/2 (due to the modulo function according to relationship (80)), said frequencies k_{0,j} correspond at least approximately to the Doppler frequencies k_{0,i} of the objects or a subset of these (for objects with very low reflectivity, it can be that they do not result in a peak above the detection threshold). For further processing, it must also be taken into account in which of the two FFTs the peak was detected at k_{0,j} that is to say whether the associated discrete transit time is even or odd; to that end, the quantity

$${\underline{m}}_{j} ∈ \{ 0 , 1 \} \qquad ( 81 )$$

is introduced, wherein mⱼ=0 when the peak occurs in the first FFT \tilde{E}_{1,1,k} and mⱼ=1, when the peak occurs in the second FFT \tilde{E}_{1,2,k}.

The second modulation subsequence b₂(n) according to relationship (76b) results, in the receive sequence e(n), in components which are time-shifted by m_{0,i}, and multiplied by the respective Doppler frequency k_{0,i}, that is to say modulated

$${e}_{2 , i} ( n ) = {a}_{i} \cdot {b}_{2} ( n - {m}_{0 , i} ) \cdot exp ( 2 π \hat{} \cdot n / N \cdot {k}_{0 , i} ) where \qquad ( 82 )$$

$$n - {m}_{0 , i} = 1 , 3 , 5 , … , N - 1.$$

In order to eliminate the respective modulation by the Doppler frequency, the receive sequence e(n) is turned back by the frequency k_{0,j}:

$${e}_{2 , j} ( n ) = e ( n + {\underline{m}}_{j} ) \cdot exp ( - 2 π \hat{} \cdot n / N \cdot {\underline{k}}_{0 , j} ) where \qquad ( 83 )$$

$$n = 1 , 3 , 5 , … , N - 1 and j = 1 , … J - 1 ;$$

where the quantity mⱼ introduced into relationship (81) takes into account whether the respective receive subsequence lies in an odd or even grid (that is to say, has an even or odd discrete transit time); and it should also be noted that—as during the determination of the FFT—in the case of this range of index n, the first received values originate from the end of the previous modulation period (due to the transit time of the respective object) which does not, however, violate the coherence for the following correlation due to the periodicity of the entire modulation sequence (which has period N).

The thus modified sequences \tilde{e}_{2,j}(n) include, in the corresponding index, j cyclically shifted modulation subsequences aᵢ·b₂(mod_{N}(n−m_{0,i})). Contributions of objects having other Doppler frequencies k_{0,i} (that is to say, k_{0,i}≠k_{0,j}) constitute an uncorrelated modulation sequence for b₂(n), as they are still modulated with the difference frequency k_{0,i}-k_{0,j}; the same applies to contributions with other mⱼ, as these are modulated with b₁(n). For this reason, the sequences \tilde{e}_{2,j}(n) can now be cyclically modulated with the second modulation subsequence b₂(n):

$${\tilde{E}}_{2 , j , \underline{\underline{m}}} = {sum}_{n = 1 , 3 , … , N - 1} ( {\tilde{e}}_{2 , j} ( n ) \cdot {b}_{2} ( {mod}_{N} ( n - \underline{\underline{m}} ) ) ) where \qquad ( 84 )$$

$$\underline{\underline{m}} = 0 , 2 , … , M - 2 and j = 1 , … J - 1.$$

In said one-dimensional correlations \tilde{E}_{2,j,m}, peaks occur at the positions m_{0,j}=m_{0,i}−mⱼ, that is to say, at the discrete transit times m_{0,i} of objects minus the shift mj applied in relationship (83), so that the discrete transit time of m_{0,i}=m_{0,j}+mⱼ is obtained, in each case. For the above example with two objects, the amounts of the two correlations \tilde{E}_{2,1,m} for \tilde{e}_{2,1}(n) where k_{0.1}=1798 and m₁=0 as well as \tilde{E}_{2,2,m} for \tilde{e}_{2,2}(n) where k_{0.2}=1000 and m₂=1 are depicted in FIG. 38; the peaks lie at the values m_{0.1}=300 as well as m_{0.2}=100 which correspond to the discrete transit times m_{0,1}=m_{0,1}+m₁=300 as well as m_{0.2}=m_{0.2}+m₂=101.

The Doppler frequency k_{0,i} of the object is produced from the index j of the correlation \tilde{E}_{2,jm}, at which the peak occurs, and the Doppler frequency k_{0,j} belonging to said j, only except for a potential offset of N/2—see relationship (80), which takes into account the fact that the Doppler frequency is determined from a sequence with half the sampling rate, i.e., an additional half period, based on the full sampling rate, cannot therefore be recognized. However, such a half period results in the fact that the complex values at the respective peaks in FFT \tilde{E}_{1,1,k} or \tilde{E}_{1,2,k} and correlation \tilde{E}_{2,jm} are rotated by 180° with respect to each other, whilst, in the other case (that is to say no additional half period in Doppler frequency), they have the same phase. With said relationship, the ambiguity regarding the respective Doppler frequency k_{0,i} can be resolved by adding the two complex values corrected by the possible phase shifts (0° and) 180°, that is to say the sum and difference of the two complex values are formed—if the sum has a greater amount than the difference, then the Doppler frequency k_{0,i}=k_{0,j}, in the other case, the Doppler frequency k_{0,i}=k_{0,j}+N/2; in the above example, for the first object (that is to say for k=k_{0,1} and m=m_{0,1}), the difference \tilde{E}_{1,1,k}-\tilde{E}_{2,1,m} is greater than the sum \tilde{E}_{1,1,k+\tilde{E}}_{2,1,m (due to the fact that the two components are approximately in-phase), so that the Doppler frequency k}_{0,1}=k_{0,1}+N/2=3846, and for the second object (that is to say for k=k_{0,2} and m=m_{0,2}), the sum \tilde{E}_{1,2,k}+\tilde{E}_{2,2,m} is greater than the difference \tilde{E}_{1,2,k}-\tilde{E}_{2,2,m} (due to the fact that the two components are approximately antiphase), so that the Doppler frequency k_{0.2}=k_{0.2}=1000. The fact that the Doppler frequency is now determined over the full duration of a modulation period means there is no longer the disadvantage of the modulation sequence according to FIG. 35 (according to the prior art), where the resolution and accuracy are reduced for the Doppler determination by a factor of two, since the FFT is only determined over half the modulation duration.

The distances and radial relative speeds of objects in the respective capturing direction can be determined with the relationships and procedures represented above from the peaks of the correlations \tilde{E}_{2,j,m} lying above a detection threshold. It should be noted that contributions of objects having, in each case, other Doppler frequencies k_{0,i} (that is to say, k_{0,i}≠k_{0,j}) and/or other value mⱼ only result in noise in the respective correlations, that is to say no peaks above a detection threshold, due to the fact that they are not correlated with b₂(n); in the case of roughly equally strong reflection signals from objects, said noise is considerably below the peaks of interest and does not therefore conceal these-only when reflection signals from objects are markedly different can objects having a strong reflection signal conceal weak reflection signals having another Doppler frequency by way of their noise.

As an alternative to the approach that detections are generated from peaks of the correlations \tilde{E}_{2,j,m} lying above a detection threshold, the sums and differences of FFT \tilde{E}_{1,1,k} or \tilde{E}_{1,2,k} where k=k_{0,j} and correlation \tilde{E}_{2,j,m} introduced above can be checked for a detection threshold, since that value of the sum and difference, in which the two components FFT and correlation are phase-correct, i.e., coherent, are added, has a signal-to-noise ratio which is 3 dB better than the correlation itself; this is due to the fact that, in the case of the sum or difference, integration is conducted over the whole modulation sequence b(n), but in the case of the correlation only over half. The sum or difference therefore also has the same signal-to-noise ratio and, therefore, the same sensitivity as the optimal two-dimensional correlation E_{m,k} according to relationship (6). However, this only applies if a peak has already been detected in the FFT at the corresponding position in each case, that is to say at k=k_{0,j}; since the FFT has a signal-to-noise ratio which is 3 dB worse due to half the integration duration; a correspondingly reduced detection threshold has to be applied. Said reduced detection threshold has an increased probability that noise peaks are wrongly detected; however, these are then discarded again at the effectively sharper detection threshold of sum and difference of FFT and correlation, so that the only disadvantage remains a slightly increased computational outlay (because correlation \tilde{E}_{2,j,m} has to be calculated quite often). It should also be noted that the sum and difference do not have to be determined for each m, but rather that the correlation \tilde{E}_{2,j,m} can also be first of all checked for a detection threshold which is reduced by roughly 3 dB and only at those positions where said detection threshold is exceeded are the sum and difference formed. The fact that the new approach of the modulation sequence according to FIG. 36 and the evaluation described above has the same sensitivity as the optimal two-dimensional correlation E_{m,k} according to relationship (6) means that the disadvantage of the modulation sequence according to FIG. 35 (prior art) of a 3 dB worse sensitivity is remedied. It will now be briefly discussed whether the new sum and difference of FFT and correlation approach could not also be applied in the case of the modulation sequence according to FIG. 35: this is only possible if the receive phase is linear, in a stable manner, over the whole modulation sequence (that is to say, instantaneous frequency is constant), which in particular only exists, to a limited extent, during continuous spatial spanning due to speckle effects.

The sum and difference of the FFT and correlation approach also avoids the disadvantage of the modulation sequence according to FIG. 35 (prior art) of a dynamic range reduced by 3 dB when there is more than one object per pixel, because integration is now conducted over the full modulation sequence.

A further advantage of the new modulation sequence according to FIG. 36 is that any overlaps can be realized for two adjacent pixels, since each section of said periodic modulation sequence (period N) has the characteristic property according to relationship (76).

The computational outlay required for the new approach with the modulation sequence according to FIG. 36 differs from that for the modulation sequence according to FIG. 35 (prior art) due to an additional FFT of length N/2 (independent of the number of objects in the respective pixel), whereas the correlations only have half the length, which however does not constitute an advantage during the realization of the correlation in the frequency range (that is to say, by way of FFT and inverse FFT). In the typical case of one object in one pixel, two FFTs and a correlation are to be determined. In the case of the approach explained above having a reduced detection threshold for the FFTs, additional calculations of the correlation can occur in principle. Therefore, the required computational outlay is still within an order of magnitude which modern DSPs having parallel vectorial computing units open up, which results in a low-cost realization and does not require any special computational logic.

For the output dimension of the FFT, that is to say the discrete frequency, the non-symmetrical range k=0, . . . , N/2−1 was considered above (in this section), as is generally the case-equally for the discrete frequency after resolving the ambiguities, the non-symmetrical range k=0, . . . . N−1; the actual relative speeds and, therefore, Doppler frequencies can assume both algebraic signs, so that the upper range, in particular the upper half of k=0, . . . . N−1 is to be mapped for negative values by subtracting N.

As an alternative to the previously considered modulation sequence according to FIG. 36, alternating values (that is to say, in alternating fashion, +1 and −1) can also be utilized for the modulation subsequence b₁(n)—this is depicted in FIG. 39. The only material difference is that the receive subsequences regarding said b₁(n) have an additional frequency with period two (based on the modulation rate of b₁(n)), that is to say the peaks of the two associated FFTs \tilde{E}_{1,1,k} and \tilde{E}_{1,2,k} are shifted by half an FFT length N/4, which is to be corrected accordingly for the further processing.

So far, the case has been considered in this section that the discrete transit time m_{0,i} is integral and the modulation duration Tₘ is equal to the sampling repetition time Tₛ. For a non-integral discrete transit time m_{0,i}, it could happen in the case of an ideally rectangular modulation signal, which retains its ideal form even in the received signal, that it is sampled exactly at the edge where no meaningful information is to be obtained. In order to avoid this, either the sampling repetition time Tₛ of the receive sequence can be provided so that it is smaller, e.g., half the size of the modulation duration Tₘ, and/or the form of the modulation pulse is either directly distorted, e.g., to an approximately triangular shape, when it is generated or in the receiver (a low-pass provided in the receiver realizes the latter inherently). In the case of the approach with distortion of the modulation signal and the general case of a non-integral discrete transit time m_{0,i}, peaks occur in both FFTs \tilde{E}_{1,1,k} and \tilde{E}_{1,2,k} so that the correlation \tilde{E}_{2,j,m} for both mⱼ=0,1 can be determined and, by interpolation of the values of the peaks of both correlations, the non-integral m_{0,i} can be established (the non-integral m_{0,i} could also already be determined by interpolation of the values of the peaks of the two FFTs or by combination, that is to say the sum or difference of the values of FFT and correlation). In the case of the approach of, e.g., half as large a sampling time Tₛ (compared with the modulation time Tₘ), the interleaving of the two modulation subsequences with regard to the sampling time has the period 4 and, in the received signal, two consecutive sampling values originate in each case from the first sequence b₁(n) and the next two sampling values originate from the second sequence b₂(n); for this reason, on the one hand, four possible locations are to be taken into account for the receive subsequences e_{1,i}(n), that is to say four FFTs \tilde{E}_{1,1,k}, . . . , \tilde{E}_{1,4,k} are to be calculated and, on the other hand, the sampling values corresponding to b₂(n) are to be set to zero (because they are no longer located in the grid of period 2 and can, consequently, be simply omitted), so that the FFT is to be calculated over the full number of the receive values (as opposed to half the number so far). In at least a part of said FFTs, three peaks of an individual object then occur; the largest at the correct position, that is to say the Doppler frequency of the object (in contrast to the above, there are no more ambiguities, which is advantageous), and two further peaks which are smaller by 3 dB, a quarter of the FFT length before and thereafter (these are to be ignored for the further processing). As peaks occur in multiple of the four FFTs \tilde{E}_{1,1,k}, . . . , \tilde{E}_{1,4,k}, a nonintegral discrete transit time can be established by interpolation (using the values of the FFTs or the correlations or their combinations).

In addition to the case considered so far that the two modulation subsequences b₁(n) and b₂(n) are interleaved, in an alternating manner, that is to say with period two, longer periods for the interleaving as well as, optionally, an unequal number of elements of b₁(n) and b₂(n) can fundamentally be used per period.

In the lidar system considered so far in this section according to FIG. 1, the mixer has a complex-valued design, which constitutes considerable additional outlay (virtually double) with respect to a real-valued mixer for the receive path. When using a real-valued mixer, only the amount of the relative speed could be established, not the algebraic sign, since there are two peaks at +k₀ and −k₀ in the FFTs. To establish the algebraic sign, approaches by way of plausibility checking and/or tracking, i.e., pursuing over multiple acquisition cycles would be necessary. Alternatively, as explained above, a complex-valued modulation sequence, e.g., consisting of the 4 values +1, +ĵ, −1, −ĵ (regarding the 4 equidistant phase values φⱼ=0, 90°, 180°, 270°), can be used. For the first modulation subsequence b₁(n), rotation then takes place periodically over the four values +1, +ĵ, −1, −j, so that in the case of an object having the relative speed zero, the peak lies at a quarter of the FFT length-negative relative speeds lie therebelow (that is to say, they have a lower frequency), positive ones lie thereabove. Said first modulation subsequence b₁(n) which has, for its part, a period 4, is furthermore interleaved, in an alternating manner, with the second modulation subsequence b₂(n), which can also assume said four values +1, +j, −1, −j, e.g., in a pseudo-random sequence. It is true that the production of such a complex-valued sequence does require an increased circuit complexity (see, e.g., FIG. 34), but this is only needed once, whereas the outlay for a complex-valued receiver is incurred multiple times in the case of a parallel receiver. In the case of a complex-valued modulation sequence, the complex conjugate of the modulation sequence is to be utilized for the correlation. Alternatively, the complex conjugate of the receive sequence can also be utilized, provided that this is complex-valued.

So far, the case has been considered that no window function is utilized for the FFT, that is to say no multiplication of the input values of the FFT by a kind of bell curve; this would only be necessary or useful if two objects having a similar relative speed and considerably different reflectivity can occur at the same distance in one pixel and are to be separated. In particular, when no window function is utilized at the input of the FFT, the sensitivity at the output of the FFT is then reduced (that is to say, the detection capacity of objects having weak reflectivity and high distance), when the Doppler index corresponding to the relative speed is not integral, that is to say the peak is divided between two adjacent FFT values. Said effect can be reduced by selecting the length of the FFT to be higher than that of its input signal, i.e., zeros are appended to the input signal, which is referred to as zero padding.

In terms of the second modulation subsequence b₂(n), it should also be noted that it cannot only be formed from a pseudo-random change between discrete phase values, but rather also from a code, the autocorrelated part of which has small side lobes—e.g., from a gold code known in the literature. This results in a higher dynamic range of the correlation, however only when there are no signal components (e.g., from objects of another relative speed) which constitute noise in the signal to be correlated.

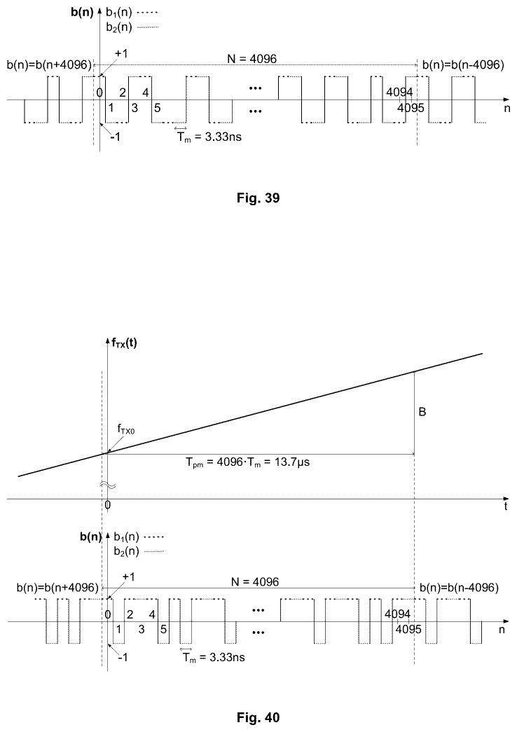

The modulation sequences presented in this section, consisting of two subsequences, which are arranged sequentially according to the prior art or interleaved in a new approach, can also be utilized according to an aspect of the invention in combination with a linearly changing frequency according to relationship (9); FIG. 40 shows an example of this. The only effect is that the receive frequency fₑ has a component fᵣ due to the transit time in addition to the Doppler shift f₀ (see relationship (12)); consequently, all of the above considerations still apply, the only thing to be taken into account is that the transit time-dependent component is to be deducted from the receive frequency for the determination of the relative speed, wherein the transit time is known from the correlation. The superimposed frequency modulation makes possible the system approaches discussed above (in particular, continuous spatial scanning over frequency) and advantages (in particular, sign determination of the receive frequency in the case of a real-valued mixer). The approaches presented in the previous sections are also valid for said phase modulation or can be transferred to it.

It should also be noted that for the recognition of the road surface at greater distances, the constant or periodic subsequence b₁(n) has the advantage that it does not split the received signal over discrete distances, so that the entire beam width is effective and the signal-to-noise ratio is therefore much better, which already results in a high probability of detecting the road surface in the individual pixel.

### Functional Check of Scanning

If scanning in one or both spatial directions were not to function, in particular due to a hardware error, there would be a high energy density in some beam directions (because the system is there considerably more frequently than in the nominal state), as a result of which the allowed limits for eye safety could be exceeded. For this reason, the scanning must be monitored and as soon as an error occurs, the emission of the lidar sensor is to be stopped.

When the sensor no longer scans in one spatial direction, the received signals in said spatial direction are unchanged over all of the pixels for the same other spatial direction in each case—apart from system noise and moving objects. For this reason, changes in the received signals are checked in both spatial directions. A first approach is to compare the object reflections, that is to say the peaks above a detection threshold; as already indicated above, all of the moving objects must be excluded, wherein identification is possible by way of the measured relative speed and the known ego speed. A second approach utilizes the received signal components of internal reflections and couplings, as well as reflections of a cover, which lie approximately at a distance of zero; these are determined anyway for a compensation of the effects (by correction values c₁(n) in hardwired computational logic according to FIG. 8 and FIG. 10)—this was explained above. This utilizes the fact that said received components generally change over the scanning.

Scanning Via Frequency Change in Both Spatial Directions with a Radiative Waveguide Array

In the arrangements considered previously for scanning and focusing in two spatial directions, one spatial direction is implemented via one or more waveguides with coupling points, and the second spatial direction is implemented via other approaches, which requires at least one optical element in addition to the photonic chip (e.g. a lens and/or a liquid-crystal element). For lidar systems that are as simple and small as possible, approaches without additional optical elements should be strived for, i.e. the scanning and focusing are then implemented in both spatial directions on the chip itself, such that the chip emits and receives one or more focused and swept beams through a transparent region in the sensor housing. As a first example, a sensor for the near and medium distance range will be considered, which sensor has a pixel size and beam width of approximately 0.5°×0.5° and uses one transceiver channel.

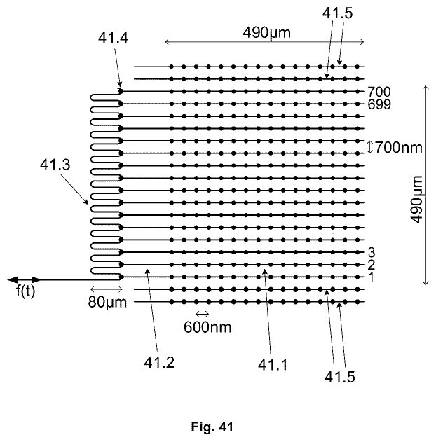

FIG. 41 shows one possible approach with an array of about 700 radiative waveguides 41.1 which is used for transmitting and receiving (as in the examples above, a monostatic system is thus still considered); for the sake of clarity, not all waveguides are shown here, as in all other figures. All of the strip-shaped array waveguides are straight and have the same shape—in particular radiating coupling points of the same kind and the same position, i.e. the same so-called grating, wherein the coupling points are approximately at a distance of 600 nm; the waveguides are arranged parallel to one another and equidistantly at a distance of about 700 nm. The radiation from the waveguides is focused in the first spatial direction defined by them and is scanned in this spatial direction using a frequency change—e.g. by −25° . . . +25°; for this purpose, the frequency f(t) must be changed by approximately ±10% with respect to its mean value f₀=c/λ₀=194 THz, wherein the free space wavelength is λ₀=1550 nm (in addition to the effective refractive index of about 2.5, the dispersive character of the waveguides, i.e. the frequency dependence of their effective refractive index, which they have due to their small width due to their small spacing to one another, must also be taken into account for the required frequency change).

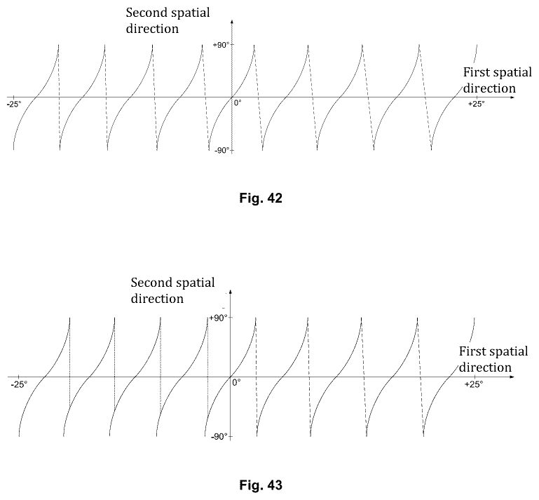

The 700 radiative waveguides 41.1 are fed via connecting waveguides 41.2 of respective equal length from a long meandering waveguide 41.3, wherein there is always the same distance of 160 μm between the feed points 41.4 of two respectively adjacent waveguides. A frequency change thus causes the phase of the feed signals of the waveguides to change linearly across the waveguides; this linear phase change across the waveguides then also applies at the first coupling point and at each further coupling point, as a result of which scanning in the second spatial direction, which is perpendicular to the first, is realized. Since this distance between the feed points of the waveguides is longer than their distance by about a factor of 230, the scanning effect due to frequency change in the second spatial direction is much stronger; while the beam only moves about the pixel width of 0.5° in the first spatial direction, it sweeps a full scan from −90° to ±90° in the second spatial direction. FIG. 42 shows this scanning pattern, i.e. how the beam moves through a change in frequency over time (here decreasing, i.e. from higher to lower frequencies) in the two spatial directions; while the beam moves slowly from −25° to +25° in the first spatial direction, it passes very quickly and multiple times through the entire second spatial direction from −90° to +90° (wherein not all scans are shown for the sake of simplicity) and recedes in between, wherein this requires an increasing dead time in the direction of decreasing frequencies—in this dead time, the beam would be outside ±90° at imaginary angles, since the spacing of the waveguides is less than half of a free space wavelength). The continuous change in frequency proceeds such that a constant scanning rate is obtained in the first spatial direction (the progression of the frequency f(t) required for this purpose is not entirely linear, but rather slightly curved due to dispersion effects, trigonometric relationships and dependencies on the relative frequency change)—thus the axis for the angle of the first spatial direction also constitutes the linear time axis. Due to trigonometric relationships, the scanning rate of the second spatial direction with respect to the outer angles ±90° (and therefore the pixel width) increases greatly, which is not critical for functional reasons, since a less good resolution is also required there (moreover, the beam width is also increased there to the same extent since the effective aperture, that is to say the extent of the waveguide array viewable from these angles, is correspondingly reduced).

If the spacing of the waveguides were chosen to be higher—for example equal to half the value of the central free space wavelength λ₀=1550 with the resulting scanning pattern according to FIG. 43—overlapping of the scans in the second spatial direction, i.e. ambiguity for large angles in the second spatial direction, occurs at frequencies with a wavelength below twice the waveguide spacing; on the other hand, however, the frequency and hence scanning range with respect to the first spatial direction is then reduced, in which the above-described dead time effect occurs on the return of the scan (which occurs only with a wavelength above twice the waveguide spacing). This may be a useful approach in particular if such large angles, where ambiguity then arises in the second spatial direction, are not functionally of interest. As can be seen from the scan patterns according to FIGS. 42 and 43, the effective pixel width increases slightly from left to right in the first spatial direction, i.e. is not entirely constant 0.5°; this is due to the fact that a complete scan in the second spatial direction (i.e. from −90° to +90°) always corresponds to a change in the beam direction of 0.5° in the first spatial direction, and because of the overlapping scanning ranges in the second spatial direction or the dead times, the effective pixel width in the first spatial direction is then less or greater than 0.5°. In reality, there is also the effect, not illustrated in FIGS. 42 and 43, that the pixel width in the first spatial direction is extended to angles which are larger in terms of magnitude (for instance by 10% for a scanning range of −25° to +25°) owing to the sinusoidal and thus non-constant relationship between the beam angle and the phase difference of two coupling points (see also derivation of rel. (55)).

The radiative waveguides of the array are only about half a wavelength apart; thus, in the case of a realization on a photonic chip, it is not possible to avoid a certain coupling between them (even using suitable countermeasures such as partition webs implemented in silicon technology, for example). This means that, in the case of beam angles in the second spatial direction not equal to 0° in the waveguide array (i.e. across the waveguides), a slightly inclined wave field would tend to form, i.e. would almost tend to move slightly laterally, which leads to disturbing reflection effects at the outer waveguides and beam expansion and side lobes caused thereby, especially in the second spatial direction. Therefore, according to an aspect of the invention, it is proposed here that further waveguides 41.5 which are not connected to the feed waveguide and are referred to as dummy waveguides are attached to the side of the waveguide array; this allows the wavefront in the waveguide array to move laterally away—the only uncritical effect is that there is a minimal change in the two-dimensional beam shape (because the radiating surface is no longer exactly square, but rather minimally trapezoidal). Instead of using dummy waveguides, the radiation from the outer waveguides of the array could in principle also be shaded, i.e. absorbed; however, this is difficult to realize (without infringing the equality of waveguide properties) and also destroys performance. It should also be noted that if couplings lead to frequency-dependent and hence angle-dependent distortions of the radiation in one or both spatial directions, the design should be such that they have a minimal effect in the main radiation direction (e.g.) 0° and/or are countercompensated by suitable measures.

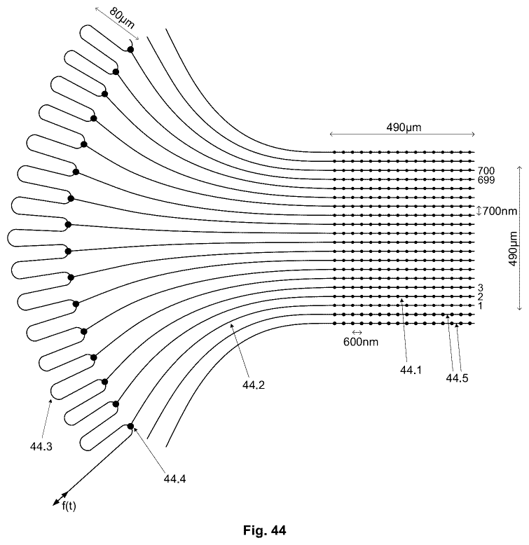

The meandering profile of the feed waveguide 41.3 shown in FIG. 41 is difficult to realize, since the width of this waveguide and the gap between the adjacent sections would have to be very small and very tight bending would be necessary; in addition, there would be a high degree of coupling between the adjacent waveguide sections. Furthermore, thin waveguides and tight bends have quite high conduction losses. This can be improved by the arrangement illustrated in FIG. 44; there, the meandering feed waveguide 44.3 has been pulled apart, so that it can be wider, the bends are less narrow, and less coupling occurs due to the greater spacing between adjacent waveguide sections. Because the feed wave guide now has a larger extent than the waveguide array with the radiative waveguides 44.1, it is offset from the waveguide array in order to create enough space for the connecting waveguides 44.2. To ensure that all connecting waveguides have the same length, the meandering feed waveguide 44.3 is also curved.

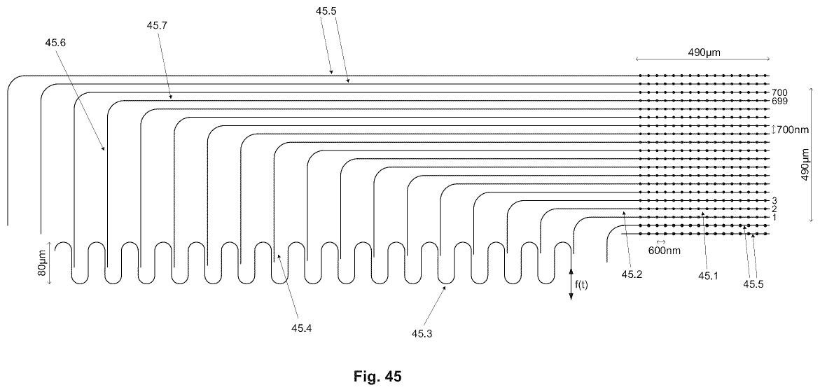

However, in FIG. 44 the inherent geometric consistency with respect to the arrangement in FIG. 41 has been lost—while in FIG. 41 all connecting waveguides automatically have the same length by means of a systematic geometric arrangement, this has to be precisely designed in FIG. 44; and the same applies to the meandering data waveguide, since it is now curved (not exactly on a circular segment). In the alternative arrangement according to FIG. 45 with an expanded feed waveguide, the inherent geometric consistency is once again provided: the meandering feed waveguide is straight again and has a constant shape over its extent, and all of the connecting waveguides have the same 90° bend and their length now increases linearly for geometric reasons (that is to say it is no longer constant), since both straight waveguide pieces have a linear length increase due to their arrangement. This linear length increase of the connecting waveguides adds to the linear length increase in the feed waveguide to their feed points, so that the required linear length change with respect to the radiative waveguides is still maintained (and the length of the meandering feed waveguide is then made somewhat shorter in order to realize the same total length change). It should also be mentioned that such an arrangement also has advantages with regard to the coupling between the connecting waveguides 45.2; the straight sections 45.6 between the feed waveguide and the 90° bend are far apart and therefore have virtually no coupling; the straight sections 45.7 following after the 90° bend have couplings on account of their small spacing, but on account of the fundamentally similar structure and the provided dummy waveguides 45.5 (more are now required at the top than at the bottom), this leads substantially only to a small lateral movement of the wave field.

FIG. 45 illustrates one possible implementation for the couplings 45.4 using the feed waveguide 45.3 into the connecting waveguides 45.2; both waveguides run a short distance next to one another with a small spacing—in the process, the coupling can be further intensified by fault points (not shown in FIG. 45). If the length and waveguide spacing of these coupling points were constant over all feeds 45.4, the strength of the coupling would decrease exponentially across the feed waveguide. In order to counteract this and in order to implement amplitude assignment (see also the following paragraph), the coupling sites are configured differently-if the waveguide spacing of the couplings is constant, then the length of the coupling points changes (as also illustrated in FIG. 45).

In order that the formed beam has as sharp a shape as possible and the smallest possible side lobes in both spatial directions, a suitable allocation in amplitude and/or phase is required (referred to in English as “tapering”). For the first spatial direction, not all coupling points of the array waveguides radiate with the same intensity, but rather the outer ones tend to radiate less than the middle ones (due to corresponding configuration of the coupling points), and possibly there is also a slight deviation from an exactly linear phase profile across the emitters (due to an arrangement of the emitters that is not quite equidistant). The same also applies to the second spatial direction by means of appropriate design or position of the coupling points between the feed waveguide and the connecting waveguides, wherein the spacing of the radiative array waveguides could also be slightly modified for the phase. In the event of amplitude and/or phase errors in the allocation (e.g. because the desired linear phase is not achieved due to geometric tolerances), undesired side lobes may occur in the beam characteristic; if the side lobes are known, they can be partially compensated in digital signal processing (e.g. by the so-called relaxation method). An advantage of the side lobes is that a monostatic system is used here (i.e. sending and receiving with the same array), so that their effect is reduced quadratically (i.e. logarithmically speaking, the side lobe spacing is doubled).

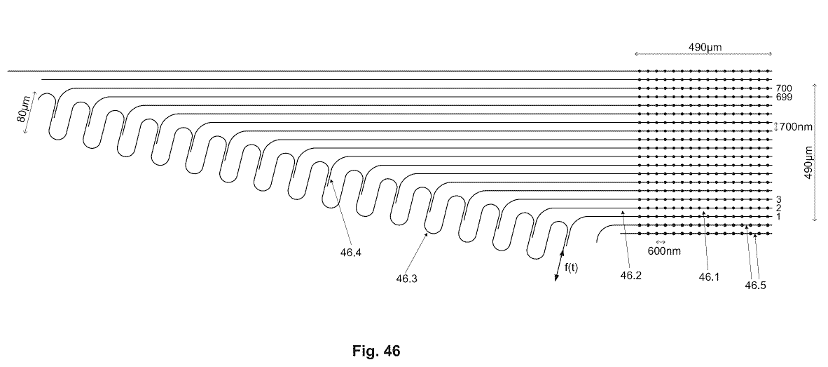

While the axis of the meandering feed waveguide 45.3 extends in the same direction as the radiative waveguides 45.1 in FIG. 45, FIG. 46 shows an oblique axis of the feed waveguide 46.3, whereby the first straight piece is omitted in the connecting waveguides 46.4.

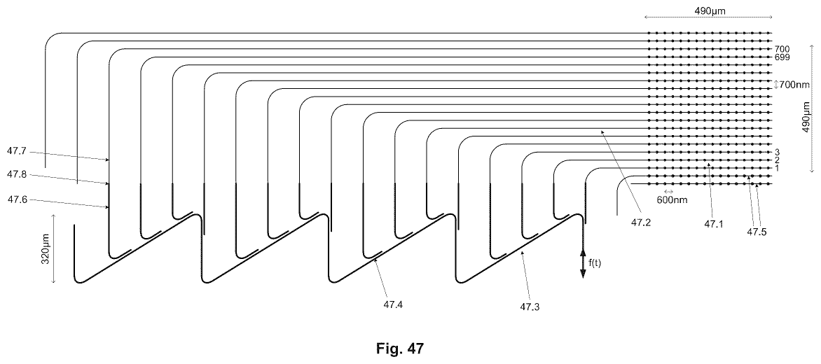

A further disadvantage of these arrangements is the high number of 180° bends, since these have comparatively high losses. With the arrangement according to FIG. 47, the number of bends through which the waves have to pass is reduced. The feed waveguide 47.3 has only a quarter of the original number of bends, since in each case four connecting waveguides 47.2 are coupled in a meandering period in order to feed the associated radiative waveguides 47.1; the respective location of the coupling 47.4 is in this case chosen such that the distance to be traveled by the wave to the radiative waveguides 47.1 of the array increases linearly over said waveguides. In principle, all waveguides (radiative waveguides 47.1 of the array, connecting waveguides 47.2 and common feed waveguide 47.3) can have the same width (and the same cross section) and thus the same effective refractive index and the same dispersive behavior. As indicated in FIG. 47, in order to reduce conduction losses, it may be advantageous if the feed waveguide is wider (which generally reduces the losses). Then, as illustrated in FIG. 47, such a type of section 47.6 of the connecting waveguides should in each case also have this higher width such that the distance to be traveled by the wave increases linearly in this higher waveguide width across the radiative waveguides of the array. The distance to be traveled by the wave in the respective section 47.7 of the connecting waveguides with a smaller waveguide width also increases linearly with respect to the radiative waveguides of the array. In all connecting waveguides, there is a transition region 47.8 (which is designed in such a way that the wave mode is maintained) from the higher to the smaller waveguide width. With this design, despite a different effective refractive index and different dispersive behavior of the two waveguide cross sections, it is ensured that the signal phase changes linearly for each frequency over the radiative waveguides in order to ensure correct focusing. A different dispersive behavior of the two waveguide cross sections (more pronounced with smaller waveguide width) also somewhat changes the progression of the ratio of the scanning speeds of the two spatial directions (which is generally not constant with respect to the same angle in each case in the second spatial direction); this can counteract the slightly different pixel spacing in the first spatial direction (according to the scan patterns shown in FIGS. 42 and 43) as explained above—it may even be overcompensated.

It should also be mentioned that the feed waveguide could also assume a different position or orientation again; for example, it could lie in curved form in front of the waveguide array, analogously to FIG. 44—however, an exact design is then difficult due to a lack of inherent geometric consistency.

In FIG. 47, the connecting waveguides have the region with wider waveguides 47.6 directly after their coupling from the common feed waveguide; these regions could also be pushed away from the coupling points and thus the region of the meandering feed waveguide, in particular in order to have more space for this feed waveguide, whereby its width could be increased further (FIG. 47 is not true to scale; in fact, the geometric conditions in the region of the feed waveguide are much denser than shown in FIG. 47).

In FIG. 47, only four radiative waveguides are coupled per period of the meandering feed waveguide; in general, more couplings are realized in order to have even more space for bends and widths of the common feed waveguide.

The radius required for a bend increases with the width of the waveguide; otherwise there would be higher losses in the bend. Therefore, it is advantageous to use a smaller waveguide width for the bends in the feed waveguide than in its straight sections; in that case, however, the transitions between the small and large waveguide widths must also be designed in such a way that they have only low losses (and no partial mode conversion takes place there). Both these transitions and the shape of the bends are advantageously configured in an adiabatic form.

The number of traversed bends (of almost 180°) increases by two per meandering period of the feed waveguide, and the number of transitions between small and large waveguide widths by four. In the case of an arrangement according to FIG. 47, the transit times in these bends and transitions must be known exactly in order to design the coupling points between the feed waveguide and the connecting waveguides at the transitions between the meandering periods (where these two bends and four transitions are added) in such a way that no phase discontinuities (i.e. phase errors over the signals of the radiative waveguides) occur- and this must also be the case over all frequencies, which would not be possible in the case of a different dispersive behavior of the transitions between the different waveguide widths and in connecting waveguides with constant width. Therefore, it makes sense to achieve an inherent geometric consistency with respect to these bends and transitions as well; for this purpose, such bends and transitions must also be inserted in the connecting waveguides, their number decreasing by two and four respectively per meandering period—the connecting waveguides from the meandering period n thus have 2. (N−n) bends and 4. (N−n) transitions (wherein the first meandering period has the index n=1 and there are N meandering periods). Since the transit times of the bends are known quite accurately and the realization of 2n bends in the connecting waveguides requires significant space, it is possible if appropriate to dispense with the realization of these 2n bends in the connecting waveguides and instead correspondingly long straight waveguide sections with small width can be realized.

Since the connecting waveguides from the anterior meandering periods require most of the additional structures (bends and/or transitions), it is advantageous that these have a greater length than the rear ones. This can be achieved by feeding into the feed waveguides in FIG. 47 from the other direction (that is to say seen from above in the illustration according to FIG. 47). This also has the advantage that the long connecting waveguides with their higher attenuation (especially in the sections with a small waveguide width) do not additionally have the higher attenuation due to the long path in the feed waveguide, which facilitates suitable amplitude tapering and reduces the total losses.

In FIG. 47, a plurality of connecting waveguides are fed directly to radiative waveguides from one period of the meandering feed waveguide. Alternatively, coupling could also be carried out into a waveguide only at one point per period, which waveguide has a meandering profile, and from which e.g. four connecting waveguides to radiative waveguides can then be fed; there is then a primary feed waveguide and a plurality of secondary feed waveguides. However, such a concept is likely to be more critical in terms of design and robustness; thus, in percentage terms, the coupling points must have much stronger coupling, especially in the case of the secondary waveguides.

In all arrangements, the common feed waveguide has a length of about 11 cm. If the cross sections of waveguides are not too small, they can be implemented in photonic chips, e.g. by silicon on or surrounded by silicon oxide, with conductivity losses <0.1 dB/cm (i.e. pure conduction losses without power couplings), so that only very low and thus acceptable losses arise for such a waveguide length (based on half the waveguide length ≤0.5 dB, wherein losses of a similar order of magnitude can also occur due to the bends).

As mentioned above, the frequency has to be changed by about ±10% (i.e. by 20% in total) in order to achieve the desired scanning range. Lasers with a tuning range of 20% are difficult to realize. Therefore, a plurality of lasers with different frequency ranges could be used to feed the array (in this and the next two paragraphs, for the sake of simplicity the entire arrangement of radiative array waveguides, connecting waveguides and common feed waveguide is understood as an array, in later sections also referred to as a complete array). Alternatively, multiple arrays of different structure fed by the same laser can be implemented; the structures are designed here such that they address different scanning ranges in the first spatial direction for the available frequency range, which scan regions are preferably arranged one next to the other without gaps. In the above example of a capturing range of ±25° and two arrays, the first addresses the range −25° . . . 0°, the second array the range 0 . . . 25°, whereby the laser requires only a tuning range of about ±5%. Because of the reduced frequency range, the design of the arrays is simpler (e.g. with regard to the effects due to frequency dependency of the coupling points and the refractive indexes) and the change in pixel width in the first spatial direction is smaller. The multiple arrays can be operated either sequentially or in parallel. In the case of sequential operation, only one transceiver channel is required, to which one of the arrays is respectively connected via a multiplexer or switchable amplifier. In the case of parallel operation, there is a separate transceiver path for each array (each fed by the same modulated laser signal), whereby a higher number of pixels or a longer integration time per pixel or a reduced cycle time can also be realized. The arrays are preferably placed relative to one another in such a way that the total cone of radiation at the surface of the sensor or its vehicle-side covering is as small as possible; by way of example, an array that radiates upward is located at the bottom in the arrangement of the arrays relative to one another.

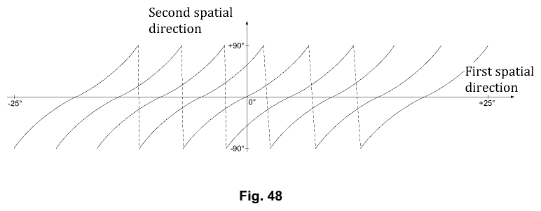

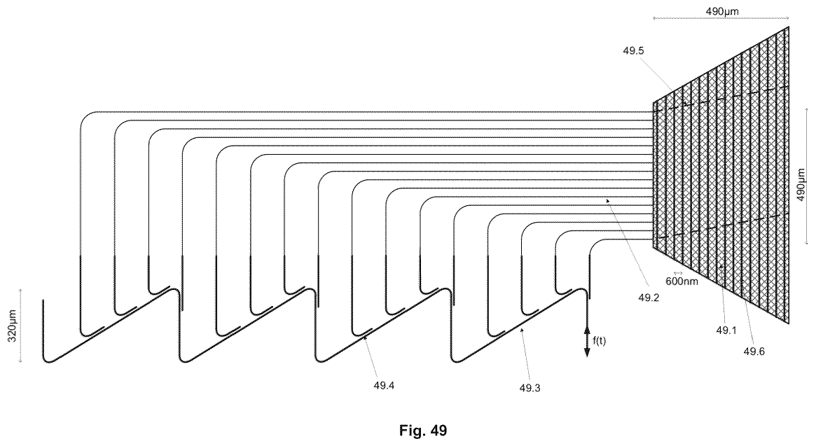

An approach with multiple arrays can also be used to keep the feed waveguide shorter, with it now being again assumed that the frequency can be tuned over the full range of about ±10%. If, for example, the feed waveguide has only one third of the original length (and thus also the distance between feed points for adjacent radiative waveguides), then the scanning distance in the first spatial direction during a complete scan in the second spatial direction is greater by a factor of 3, i.e. approximately 1.5°; if there are now three arrays in which the spacing of the coupling points of the radiative waveguides is so slightly different that, at the same frequency, they each have a beam direction that differs by approximately 0.5° in the first spatial direction, then a scanning pattern according to FIG. 48 is formed, in which the scan patterns of the 3 individual arrays are interleaved and together have the same scan density as in the original scan pattern according to FIG. 42. It should also be noted that if there are enough arrays in such an approach, a purely straight feed waveguide becomes feasible; in the example of the original arrangements according to FIGS. 45 and 46, the feed waveguide would no longer be meandering but would be straight.

So far, monostatic operation has been considered, i.e. an array is used both for sending and for receiving. For this purpose, a transceiver switch is required, which, in order to circumvent a costly circulator that cannot be photonically integrated, is generally implemented by way of an annular coupler, with a loss of in each case 3 dB when transmitting and receiving. To circumvent these losses, a bistatic approach with two separate identical arrays can be used for transmitting and receiving. These arrays should be as close as possible to one another in order to enable detection even at close range (the relatively large beam width being considered here is also advantageous in this case).

In the previous arrangements, the radiation was realized via an array of many parallel strip-shaped waveguides with coupling points. As an alternative, a single wide waveguide, that is to say a waveguide surface 49.1 (marked with hatching), could be used, as illustrated in FIG. 49. In the case of beam angles in the second spatial direction not equal to 0°, the phase changes linearly at the input of this waveguide surface (that is to say at the connecting side of the connecting waveguides), with the result that oblique wavefronts propagate in the waveguide surface, resulting in a correspondingly inclined wave field 49.5 (marked by dashed lines in FIG. 49). Therefore, with increasing distance from the connecting side of the connecting waveguides, the waveguide surface must have an increasing width, that is to say it has to open (it could of course also have the increased width over the entire length). Instead of individual coupling points, there are now parallel equidistant coupling lines 49.6 which extend over the entire surface and are perpendicular to the center axis of the waveguide surface. It should also be mentioned that, because of the inclined trapezoidal wave field, the two-dimensional beam shape changes slightly with the beam angle in the second spatial direction.

### Scanning for Change in Effective Refractive Index of Waveguides

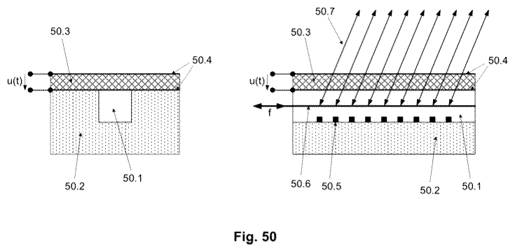

The beam direction of a waveguide has been changed by way of the frequency in all approaches and arrangements considered so far. Instead of changing the frequency, however, the beam direction of a waveguide can also be influenced by changing the effective refractive index, because then the number of wavelengths (generally not an integer) and hence the phase position between two coupling points also change. There are different approaches to changing the effective refractive index. For example, by applying a cross voltage to silicon-based waveguides (as used on photonic chips), their refractive index can be slightly affected; however, because of the small effect, very long waveguides would be necessary, which is unfavorable in terms of the space required and high conduction losses. Another approach would be to realize a waveguide through liquid crystal material, since the change in the refractive index by applying an electrical voltage is much stronger in this case. A third approach will be considered hereafter: the liquid crystal material is to be used in the surroundings of a silicon-based waveguide, which is illustrated by way of example in FIG. 50 and can thus be realized on a photonic chip. FIG. 50 shows, on the left, a section through the arrangement perpendicular to the direction of extent of the waveguide: the waveguide 50.1 is surrounded by silicon oxide 50.2 on three sides (bottom, right and left); liquid crystal material 50.3 is located above the waveguide, bearing on both sides a thin electrically conductive layer 50.4, which is transparent to the laser frequency used. On the right in FIG. 50, a section through the waveguide in its direction of extent is shown: at the bottom of the waveguide, interference points 50.5 are introduced at regular intervals, which serve as coupling points, that is to say via which, during transmission, a respective part of the wave 50.6 traveling through the waveguide is coupled out and coupled in upon reception; these out- or in-coupled waves 50.7 pass through the optically transparent liquid crystal material 50.3 and the transparent conductive layers 50.4 and reach the surroundings. In the case of a waveguide, not only is there a field within the waveguide itself, but the field also penetrates to a certain extent into its surroundings—this field component is called an evanescent field. The evanescent field is thus also located in the liquid crystal material above the waveguide. The optical properties of the liquid crystal material can be changed by means of the voltage u (t) applied to it, and thus also its effect on the evanescent field within it. The evanescent fields are also relevant for the effective refractive index of a waveguide, and hence the material properties in which these evanescent fields run. Therefore, in the case of a waveguide according to FIG. 50, its effective refractive index can be changed by means of the voltage u (t) applied to the liquid crystal layer; this is also described in the article “Liquid Crystal Waveguides: New Devices Enabled by >1000 Waves of Optical Phase Control” by Scott R. Davis et al., published in Proc. of SPIE Vol. 7618. The effective refractive index is influenced to a greater extent the more of the wave passes as an evanescent field in the liquid crystal, which can be made possible by a small waveguide cross section and/or a suitable choice of wave mode. Instead of applying a conductive layer continuously on both sides of the liquid crystal material (which must then be transparent to the laser frequency), two strips of electrically conductive material (which run in the direction of extent of the waveguide) could only be applied to the underside to the right and left of the waveguide and a voltage could be applied between them—these electrically conductive layers then do not have to be optically transparent. It would also be conceivable for there to be a continuous, electrically conductive layer or electrically conductive strips (which then do not have to be optically transparent) only on the upper side of the liquid crystal material and for the conductive layer subject to a different electrical potential to be located in a plane below the waveguide. Instead of above the waveguide, the liquid crystal material could also be to the right and left of the waveguide; if there are a plurality of parallel waveguides, then the waveguides themselves could be subjected to electrical voltage in an alternating manner (in which case the silicon would have to have a sufficient conductivity due to appropriate doping). Of course, numerous other configurations are conceivable.

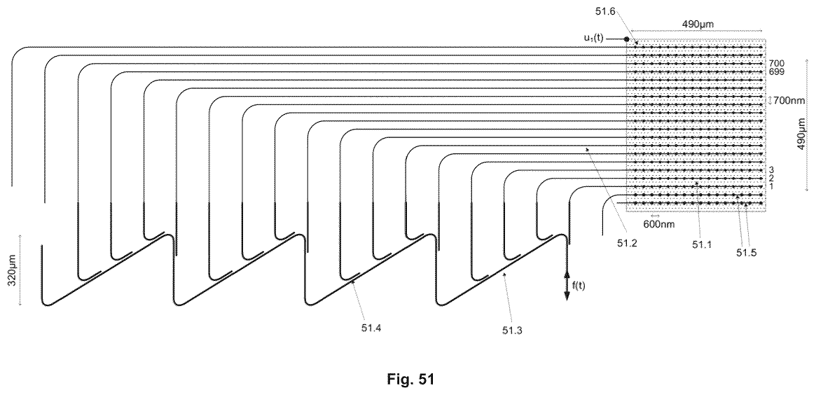

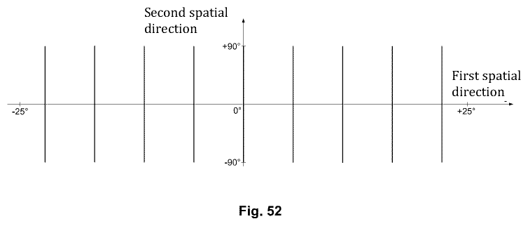

The above arrangement according to FIG. 47 is considered as an example. As illustrated in FIG. 51, a liquid crystal layer 51.6 is now laid over the array of the radiative waveguides 51.1, a voltage u₁(t) being applied between the upper and lower side of said liquid crystal layer. By changing this voltage u₁ (t), the beam can be swept in the first spatial direction. The effect of the frequency change is also used for the second spatial direction, i.e. that the radiative waveguides 51.1 are fed with different phases from the common waveguide 51.3. In contrast to the approach according to FIG. 47, in which the scans for both spatial directions are realized by frequency change, the frequency change range in the second spatial direction does not have to cover many (approximately 100) 180° scans, but only one (possibly even with less than 180°, e.g. only over −50° . . . +50°), so that the required frequency change is smaller by at least a factor of 100. i.e. only in the order of magnitude of ±0.1%. The same frequency change is then applied 100 times in succession (for 100 scans in the second spatial direction), while a slow continuous scanin the first spatial direction (−25 . . . 25°) is performed via the voltage u₁(t) on the liquid crystal layer. The frequency change in each scan in the second spatial direction also causes a slight scan by a pixel width of approximately 0.5° in the first spatial direction, which is superimposed on the scan of equal magnitude due to the voltage change; if the sign of these two 0.5° scans is chosen in the opposite direction (by accordingly choosing the sign of the frequency change and voltage change), approximately perpendicular lines are obtained in the scan pattern—see FIG. 52. In principle, the fast scan, which is repeated numerous times, can also be realized in the first spatial direction by repeated change in voltage of the same type on the liquid crystal layer; the continuous frequency scan for the second spatial direction is then performed only once. This requires a sufficiently low inertia of the liquid crystal changeover (that is to say both for the liquid crystal itself and for voltage control, characterized by the electrical resistance and capacitance thereof), while the effect of the distance-dependent frequency shift in the received signal is greatly reduced as a result of the then very slow continuous frequency change. It should be noted that the change for the slow scan could also take place in steps, that is to say a stepwise change in the voltage u₁(t) or the frequency f(t) before each fast scan for a different spatial direction. Furthermore, it should be mentioned that in the case of liquid crystals the inertia may differ between voltage switching on or increasing and switching off or lowering, which should advantageously be taken into account in the choice of sign of the voltage changes used for scanning and for the scan return (in particular in order to apply the less sluggish direction of change for a rapid return).

As explained above, with this approach according to FIG. 51, only a small frequency change of the order of magnitude of ±0.1% is required. Since the frequency tuning range of lasers is typically higher, the common feed waveguide could be significantly shortened and possibly the meandering shape could be completely dispensed with; however, as a result of the then significantly increased frequency change, the frequency-related scanning effect in the first spatial direction also becomes stronger and must possibly be compensated by means of different voltage changes u₁(t) for different planes of the second spatial direction (then the rapid scan has to be performed in the first spatial direction).

It has been assumed up to now that the realizable change in the effective refractive index of the waveguides via voltage-controlled liquid crystal material in their surroundings is large enough to cover the required scanning range in the first spatial direction. However, this is generally difficult or impossible to realize, especially for liquid crystal material that is not too inert, since only changes in the effective refractive index of, for example, 0.05 are possible. In order to cover the full scanning range, different frequencies could be used (in the example above about 17), which cover the scanning range in a rough grid and in between a fine scan is performed by changing the effective refractive index. Frequency changes are therefore again required over almost the large range of ±10%; an advantage may arise if the laser used can only operate in individual modes with small frequency ranges (because it is no longer necessary for the entire frequency range to be tunable continuously).

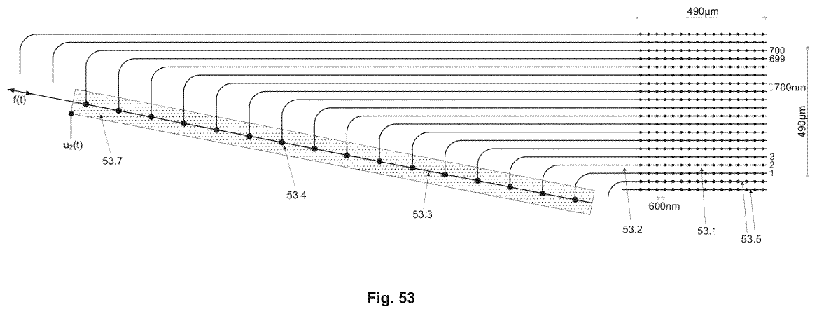

Instead of using the voltage—controlled liquid crystal layer in the case of the radiative waveguides, it could—as illustrated in FIG. 53 and designated by 53.7—also be superimposed over the common feed waveguide 53.3 in order to change its effective refractive index and thus the linear phase profile by means of the feed signals of the radiative waveguides, resulting in a change in the beam direction in the second spatial direction. The common feed waveguide 53.3 can now have a much shorter length (approximately 1.5 cm in the case of a realizable change in the relative refractive index of 0.05) and thus no longer has to be meandering, but can instead run in a purely straight line. Scanning in the first spatial direction is realized by frequency change. If the feed waveguide were to run in the direction of the radiative waveguides (and not in the position shown in FIG. 53), the frequency change would also influence the beam direction in the second spatial direction (because the path length to be traveled through from the wave to the radiative waveguides increases linearly over these); the voltage control u₂(t) at the liquid crystal would then have to be selected in a correspondingly countercompensating manner in order to realize the desired beam direction. As a result of the oblique position shown in FIG. 53 at a suitable angle (which can be geometrically calculated), the frequency influence on the second spatial direction is at least approximately avoided (since there is a constant path length to all radiative waveguides, wherein a liquid crystal layer, not explicitly shown in FIG. 53, is expediently also situated above the connecting waveguides, to which the mean value of u₂(t) is applied as a constant voltage), while maintaining the inherent geometric consistency; consequently, a change in the effective refractive index does not require the covering of a complete scan in the second spatial direction of −90° to +90°, but rather only the functionally required scanning range. Instead of the 90° bend in the connecting waveguides, a bend with the angle of the oblique arrangement of the feed waveguide could be used directly after the coupling point (at which connecting waveguide and feed waveguide run parallel for a short distance) and in the further course of the connecting waveguide (downstream of the feed region of the feed waveguide) a similar, generally small, bend in the other direction could be used for a constant path length to all radiative waveguides.

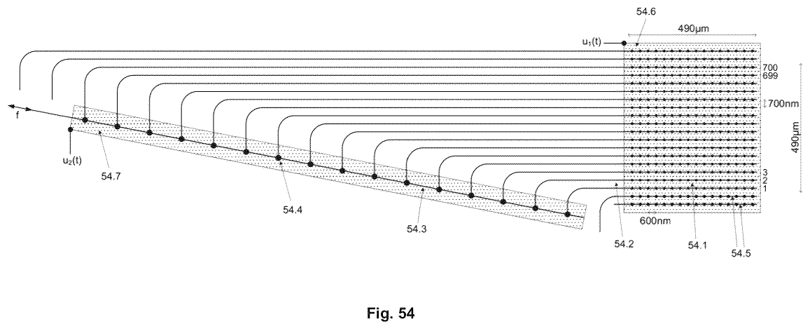

FIG. 54 shows an approach in which voltage-controlled liquid crystal layers 54.6 and 54.7 are used both above the radiative array waveguides 54.1 and above the common feed waveguide 54.3 in order to change their effective refractive indexes for scanning in both spatial directions; thus, there are now two control voltages u₁(t) and u₂(t) for scanning. Scanning is performed multiple times (and therefore rapidly) in one spatial direction and only once (and therefore slowly) in the other spatial direction, which can be carried out continuously or step-by-step. Owing to the very small extent of the liquid crystal layer over the feed waveguide in one dimension and thus also the smaller area or length of the electrically conductive layer to be controlled, it can be more favorable to rapidly scan the second spatial direction due to reduced electrical inertia effects. As stated above, the feasible change in the effective refractive index will generally not be sufficient to cover the entire scanning range for the first spatial direction; then different frequencies are to be used, which cover the scanning range in a rough grid and in between a fine scan is carried out by changing the effective refractive index. Since frequency scanning is no longer used for the second spatial direction, only single constant frequencies are required, which is generally easier to implement.

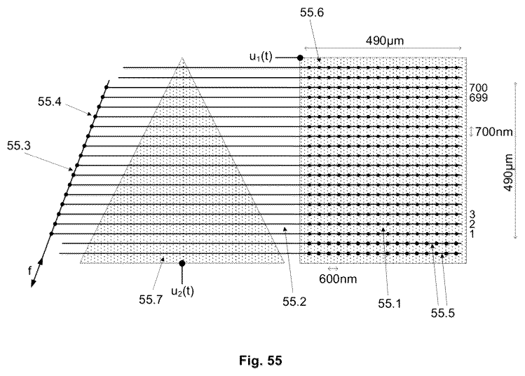

Instead of applying the change in refractive index to the feed waveguide, this can be applied to the connecting waveguides, which is shown in FIG. 55. The liquid crystal layer 55.7 lying over the connecting waveguides 55.2 has a triangular shape, so that the length of the connecting waveguides covered by the liquid crystal layer increases linearly and hence the waveguide length with an influenced refractive index; this results in a phase shift that changes linearly across the connecting waveguides, which can be changed by the control voltage u₂(t) at the liquid crystal layer, as a result of which the scanning is realized in the second spatial direction. Since a phase which changes linearly across the connecting waveguides can already occur due to the feed waveguide itself (due to the linearly increasing length to the feed points) and the effective refractive index of the connecting waveguides is influenced in general (i.e. also at the average voltage used), the feed waveguide 55.3 can be placed obliquely for compensation—as illustrated in FIG. 55. Because of the comparatively low changeability of the relative refractive index, the triangular liquid crystal layer 55.7 above the connecting waveguides must be selected to be correspondingly wide (FIG. 55 is not to scale here).

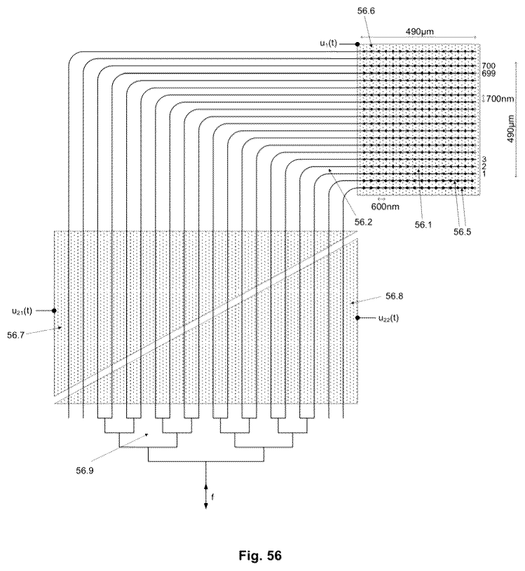

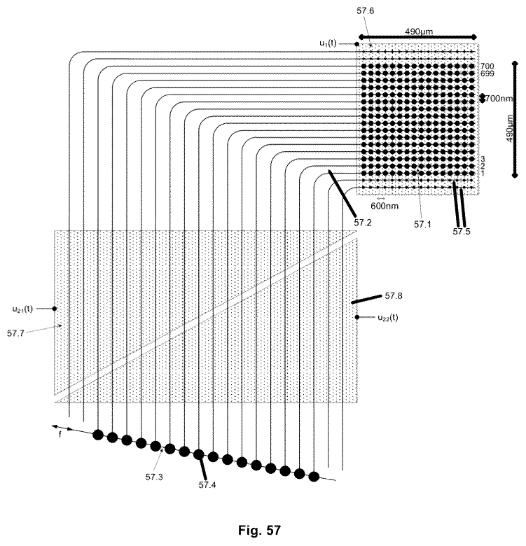

FIG. 56 shows three possible modifications with respect to FIG. 55. First, the distribution of the wave is no longer realized by means of a common feed waveguide, but rather by means of cascaded splitters 56.9—for amplitude and/or phase tapering, the splitters must be designed to be correspondingly asymmetrical. Second, the connecting waveguides 56.2 in the region covered by the liquid crystal layer are pulled apart in order to keep the coupling small. And thirdly, the triangular liquid crystal layer 56.7 with control voltage u₂₁(t) has a triangular liquid crystal layer 56.8 with control voltage u₂₂(t) that is complementary in terms of area, wherein the two control voltages are complementary to one another with regard to a center voltage u₂₀ (thus u₂₁(t)=u₂₀+u₂(t) and u₂₂(t)=u₂₀−u₂(t), such that furthermore effectively only one variable voltage u₂(t) has to be realized, which is used with different polarity for the two layers). By using two complementary triangular liquid crystal layers, the realized scanning range doubles in comparison to a triangular liquid crystal layer according to FIG. 55 (if the same size is assumed in each case). The portion of the connecting waveguides that follows the liquid crystal layer is designed in such a way that the length increases linearly over the connected radiative waveguides 54.1 for geometric reasons. If an integer multiple of the wavelength fits into the length increase of two respective adjacent connecting waveguides, then perpendicular radiation occurs in the second spatial direction at u₂₁(t)=u₂₂(t)=u₂₀; when using a plurality of frequencies to cover the scanning range in the first spatial direction, this condition can be satisfied only for one frequency, for other frequencies this must be taken into account for the control voltages to be used. This frequency-dependent behavior in the second spatial direction would not exist if the course of the connecting waveguides upstream of the liquid crystal layers were geometrically complementary to their course downstream of the liquid crystal layers, so that the total length of the connecting waveguides were constant; for this purpose, the cascaded splitter network would have to be rotated by 90°, have the same waveguide spacing at the output as the waveguide array, and be arranged to the left below the two triangular liquid crystal layers—the connecting waveguides would then also have two straight sections and a 90° bend in front of the liquid crystal layers. This means that it is no longer necessary to cover a complete scan in the second spatial direction of −90° to +90° over the liquid crystal layers, but only the functionally required scanning range.

Alternatively, the frequency dependency of the beam direction in the second spatial direction can also be prevented with the arrangement as per FIG. 57; there, the connecting waveguides are again fed via a straight and suitably oblique waveguide 57.3 (the required angle can be calculated geometrically).

Of course, such modifications are also possible in other combinations. In an arrangement such as in FIG. 57, scanning in the first spatial direction, where it is realized by means of a voltage-controlled liquid crystal layer, could thus again be replaced by pure frequency scanning, which, in contrast to earlier examples, no longer influences the scanning in the second spatial direction (and thus no longer needs to be countercompensated there).

The approach with two liquid crystal layers with complementary voltages can be transferred to the arrangements according to FIGS. 53 and 54, if a liquid crystal layer is also located there above the connecting waveguides and the voltage applied to them is complementary to the voltage on the liquid crystal layer above the optical waveguide; this roughly doubles the effect for the change in beam direction in the second spatial direction.

In the above examples for scanning in both spatial directions by means of voltage-controlled liquid crystal layers, a plurality of different frequencies are required because the possible change in the effective refractive index of the radiative waveguides alone is too small for scanning in the first spatial direction. Instead of a plurality of frequencies, however, a plurality of complete arrays (consisting of radiative array waveguides, connecting waveguides and a common feed waveguide) can also be used, wherein the coupling points of the radiative waveguides are at correspondingly different distances. Then, the laser no longer requires a frequency tuning capability, and all elements can be designed optimally for one frequency (and do not need to be operational over a frequency range and have the required optical properties). Of course, in addition to the changes in the effective refractive indexes of the waveguides, a slight frequency change could also be applied—in particular in order to superimpose a linear frequency change on the phase modulation, in order to be able to determine the sign of the receiving frequency in the case of a real mixer; the generally small changes in beam direction brought about by this slight change in frequency could optionally be taken into consideration for controlling the liquid crystal layers.

It should also be noted that an approach using multiple complete arrays for the same total output power also has advantages in terms of eye safety, since the power is distributed locally.

Beam Deflection of Waveguide Arrays with Prisms

Approaches where a plurality of complete arrays (comprising radiative array waveguides, connecting waveguides, and common feed waveguides) are used have already been explained above. In the following, three arrays according to FIG. 47 will be considered by way of example, which scan for both spatial directions via frequency. In the second spatial direction, each array scans over the entire capturing range. For the first spatial direction, the beam direction is deflected in each array by a respective prism (or a prism-shaped part of a common, larger body) above the radiative array; the choice of shape and position of the prisms and of the immediate scanning ranges of the arrays (that is to say without the deflection of prisms) is selected here such that the three scanning ranges resulting from the prism deflection adjoin one another and thus, for example, realize a 180° wide scanning range with high resolution even in the edge regions up to ±90 (without prisms, there is a poor resolution in these edge regions, because the effective aperture is progressively getting smaller). In principle, such an approach can even be used to realize a capturing range that is over 180° wide.

By means of a prism over a radiative array, the scanning range of said radiative array can also be amplified, in particular if the beam angles in the prism are close to the limit of total reflection. Furthermore, amplification can be achieved via a prism composed of dispersive material, if a frequency scanning approach is used.

Finally, it should be noted that if only a comparatively small scanning range is required for a sensor and a small change in frequency or effective refractive index is to be sufficient for the change in the beam direction, this can also be realized without a prism by using a scanning range of the array that is not centric but oblique—i.e. the array is not perpendicular, but is oriented obliquely with respect to the central beam direction, resulting in an amplifying effect for geometric reasons (for the same beam direction width, however, the extent of the array must then be increased, since the effective aperture is reduced when viewed from an oblique direction, which is de facto also responsible for this amplifying effect; if the oblique position is used for the first spatial direction, the radiative waveguides must become longer).

### Waveguide Array Fed by Parallel Transceiver Paths Via a Planar Lens

In the arrangements with direct radiation from a waveguide array (that is to say without further optical element) considered so far, mainly a single-channel sensor has been considered, that is to say having only one transceiver path. For sensors with a long range and high resolution, however, a plurality of transceiver paths are required, because the product of the number of pixels and the necessary data recording time of a pixel is much higher than the typically used cycle time of 50 ms—as also explained above, about 16 . . . 32 parallel transceiver paths are required. One basic approach is for each transceiver path to have a separate waveguide array, each with a different configuration (in order to address different scanning ranges when using the same frequencies and/or the same or similar control voltages for liquid crystal layers); however, this requires a high amount of space, also in particular because the high resolution means that the individual waveguide array has to be much larger than in the arrangements shown above (in the range of 0.2 . . . 2 cm²).

Therefore, a solution should be sought in which the same waveguide array can be used for preferably all transceiver channels. One possible realization is to use a planar lens, similar to the Rotman lens known from the microwave range, or the circular Lüneburg lens with a radially dependent refractive index. For the realization of such a planar lens on a photonic chip, either a constant refractive index that differs with respect to the environment (classical lens approach) can be used in a planar region of corresponding shape or a suitably locally varying refractive index (in particular in a continuous manner, as in the case of a Lüneburg lens). Different refractive indexes can be realized via different silicon-based materials or by a liquid crystal layer over a homogeneous or inhomogeneous silicon-based layer functioning as a wide waveguide for modification of the effective refractive index, wherein there are possibly different control voltages for different regions of this liquid crystal layer, also in order to be able to compensate tolerances or frequency dependencies.

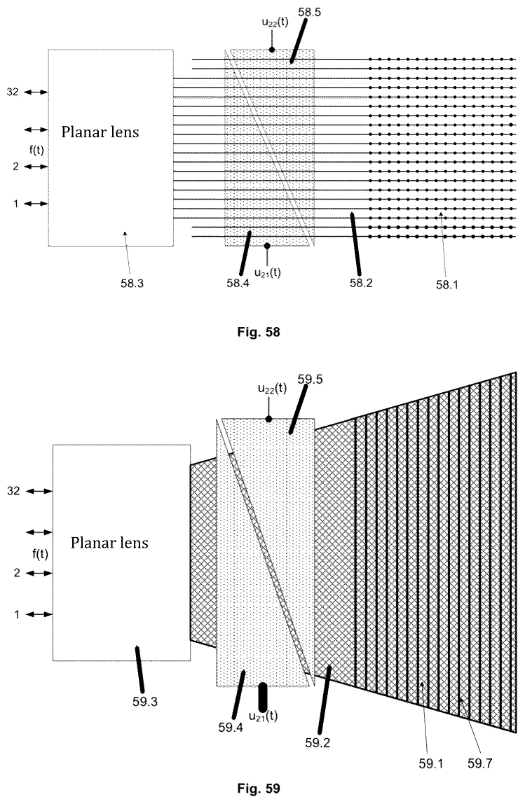

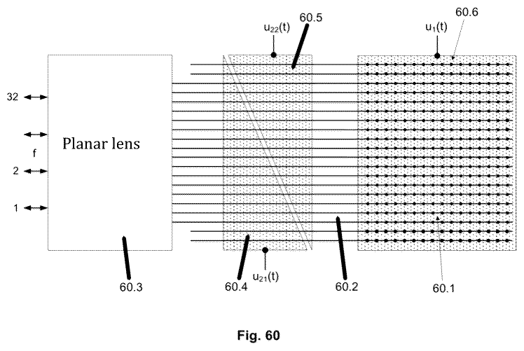

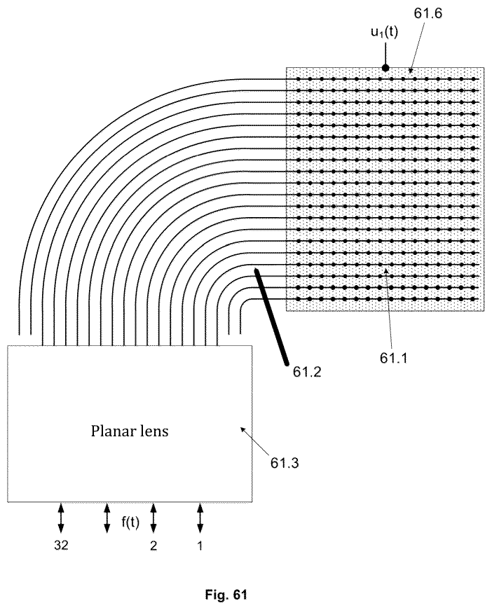

FIG. 58 shows a possible arrangement with such a planar lens 58.3, which is only shown symbolically by a block with 32 evenly distributed inputs (left) and about 10000 equidistant outputs (right) (without showing the exact structure and realization on the photonic chip; labels “input” and “output” refer to transmitting; for receiving it is the other way around). When fed at an input, the wave arriving at the outputs is planar with a generally oblique wavefront, i.e. the phase changes linearly over the outputs. The gradient of this linear phase response depends on the input chosen for the feed; it changes at least approximately linearly over the inputs n=1 . . . 32 from a negative value to a positive value of equal magnitude (owing to symmetrical arrangement and configuration). Connecting waveguides 58.2 run from the outputs of the planar lens to the array of radiative waveguides 58.1, wherein the connecting waveguides are controlled by two complementary triangular liquid crystal layers 58.4 and 58.5 with the variable voltages u₂₁(t)=u₂₀+u₂(t) and u₂₂(t)=u₂₀−u₂(t). For the control voltage u₂(t)=u₂₀, no change in the phase relationships between the signals of the connecting waveguides takes place as a result of the liquid crystal layers, i.e., the linear phase response from the output of the planar lens arrives unchanged at the radiative waveguides, which leads to focused and generally inclined radiation in the second spatial direction; the planar lens should be designed here such that the beam angle changes by 0.5° each from −7.75° to +7.75° across the inputs. In order to realize pixels spaced apart by 0.05° in the second spatial direction (i.e. 10 pixels per input), the control voltage u₂(t) is changed accordingly; as a result, a 16°-wide scanning range in the second spatial direction is covered with 320 pixels. Since a change in the radiation direction of only 0.45° has to be realized via the liquid crystal layer, a small longitudinal extent of the liquid crystal layers and/or a relatively small change in voltage is sufficient, which supports rapid scanning and a rapid return for this change in the radiation direction.

The scanning in the first spatial direction, i.e. the change in beam direction of the individual waveguides 58.1 of the array, is realized by changing frequency.

For parallel operation, i.e. parallel detection of 32 directions and thus 32 pixels, the same modulated laser signal is present at all 32 inputs; the 32 pixels acquired in parallel have different angles in the second spatial direction (because of different lens inputs) and identical angles in the first spatial direction (because of the same input signal and therefore the same frequency). In which spatial direction fast (i.e. repeated) and in which slow (i.e. only once) scanning is carried out can be freely chosen in principle; mixed forms are also conceivable.

Both the connecting waveguides 58.2 running in parallel and the radiative array waveguides 58.1 of the arrangement according to FIG. 58 can—as shown in FIG. 59—be replaced in each case by a single wide waveguide, that is to say a waveguide surface 59.2 or 59.1 respectively (marked with cross-hatching). Because oblique wavefronts now propagate in the waveguide surfaces, which results in correspondingly inclined wavefields, the waveguide surfaces must have an increasing width, i.e. open up, with increasing distance from the planar lens (it could of course also have the increased width over the entire length). In the case of the radiative waveguide surface 59.1, instead of individual coupling points, there are parallel equidistant coupling lines 59.7, which extend over the entire surface and lie perpendicular to the center axis of the waveguide surface. It should also be mentioned that, because of the inclined trapezoidal wave field, the two-dimensional beam shape changes slightly with the beam angle in the second spatial direction.

Instead of scanning in the first spatial direction via frequency, a voltage-controlled liquid crystal layer 60.6 can be used over the radiative waveguide array of waveguides 60.1—as illustrated in FIG. 60. All 32 pixels acquired in parallel furthermore each have the same angle in the first spatial direction, which angle is defined by the control voltage u₁(t) of this liquid crystal layer across the waveguide array. Since only a comparatively small change in the effective refractive index of the radiative waveguides can be realized, a plurality of different discrete frequencies are generally required to cover the required scanning range. In principle, the spatial direction in which scanning is carried out rapidly or slowly can be freely selected; since it is only possible to scan over 10 pixels in the second spatial direction and thus over much fewer pixels than in the first spatial direction, it should be better to choose the second spatial direction as the one to be scanned slowly because of the inertia on return and the associated time losses.

In order to scan in the second spatial direction, i.e. to realize the 10 pixels per input in a grid of 0.05°, frequency scanning with the aid of connecting waveguides 61.2 of different lengths shown in FIG. 61 can be used instead of the above approach of the two triangular liquid crystal layers over the connecting waveguides (of course only if scanning via frequency is not added for the first spatial direction, but rather a voltage-controlled liquid crystal layer 61.6 is used above the radiative waveguides 61.1). The parallel-running and equidistant connecting waveguides 61.2 have a circular-segment-shaped bend of, for example, 90°, as a result of which their length increases linearly. Exactly two waveguide wavelengths fit into the constant length increase between two adjacent connecting waveguides for the mean frequency f₀, so that for each input signal of the lens 61.3 at the radiative waveguides 61.1, the respective linear phase response from the output of the planar lens arrives unchanged. Changing the frequency results in an additional linear phase shift over the signals arriving at the radiative waveguides (because the length increase between two adjacent connecting waveguides no longer corresponds exactly to two waveguide wavelengths), as a result of which the beam angles change in the second spatial direction; for the necessary change of 0.45°, a frequency change of only about ±0.07% is required (the small change in beam direction in the first spatial direction that also results therefrom can be taken into account during the control of the liquid crystal layer 61.6). It should also be noted that the bending of the connecting waveguides is generally not 90°, since the condition to be implemented is that exactly one integral multiple of the waveguide wavelength fits into the length increase between two adjacent waveguides for the mean frequency f₀. If a plurality of discrete frequencies are required in order to be able to cover the required scanning range in the first spatial direction (because the realizable change in the effective refractive index is not sufficient for this), then the above condition would have to be satisfied for each of these frequencies, i.e., that exactly an integral multiple of the waveguide wavelength fits into the increase in length between two adjacent waveguides, which is generally difficult to realize.

The 32 inputs of the lens could also be pushed together such that their associated beam directions are separated only by a pixel width of 0.05°. Scanning is then necessary with the help of the liquid crystal layers or with the aid of a frequency change over 14.4°, i.e. 32 times more than in the first approach. For this purpose, the mutually close inputs of the planar lens can simplify the design thereof and improve its robustness over different frequencies. If scanning is carried out rapidly in the second spatial direction (and the first spatial direction is scanned slowly in a continuous manner), the number of returns for the second spatial direction is reduced by a factor of 32 with this approach, which is particularly helpful when using voltage-controlled liquid crystal layers because of their inertia. Of course, mixed forms with far and close adjacent inputs are also possible—for example, groups with waveguides close to each other, which in turn are far apart (this also reduces the number of returns required for fast scanning in the second spatial direction).

In the case of inputs that are closer to one another, coupling between them may occur in their supply lines, resulting in fuzzy surroundings recognition; in order to avoid this, signals having different pseudo-random phase modulation could be used for different inputs, such that couplings to other, in particular adjacent inputs and thus adjacent pixels represent non-coherent signals there, which thus act there only as noise on the receiving side, but do not generate power peaks in the two-dimensional correlation (and hence no detections). Such an approach according to an aspect of the invention with differently modulated signals for transceiver paths operated in parallel can, of course, be applied to all of the above approaches and arrangements with a plurality of transceiver paths. If the received sequences are evaluated in a hard-wired circuit as in FIG. 8 or 10, the values of the modulation sequence b(n) need to be changed via the transceiver paths.

So far, the case has been considered in which the number of inputs of the planar lens corresponds to the number of parallel transceiver paths and 10 pixels per transceiver path are realized in the second spatial direction by influencing the wavelength in the connecting waveguides (by changing the frequency or the effective refractive index). However, the 10 pixels per transceiver path could also be realized by virtue of the lens 320 having evenly distributed inputs and being able to switch each of the 32 transceiver paths between 10 different lens inputs in each case via a switching matrix.

Finally, the following should be noted: The approach with a planar lens could also be used for a single-channel sensor, i.e. with only one transceiver path, in combination with a switching matrix on the inputs thereof; either there are in this case as many inputs of the planar lens as beam directions in the second spatial direction, or only a smaller number with additional change in their beam directions via a comparatively small change in the frequency or in the effective refractive index of connecting waveguides. Scanning in the first spatial direction is implemented, as above, by changing the effective refractive index or the frequency of the radiative array waveguides.

### Waveguide Array Fed by a Signal Containing Multiple Frequencies for Realizing Parallel Transmission and Reception

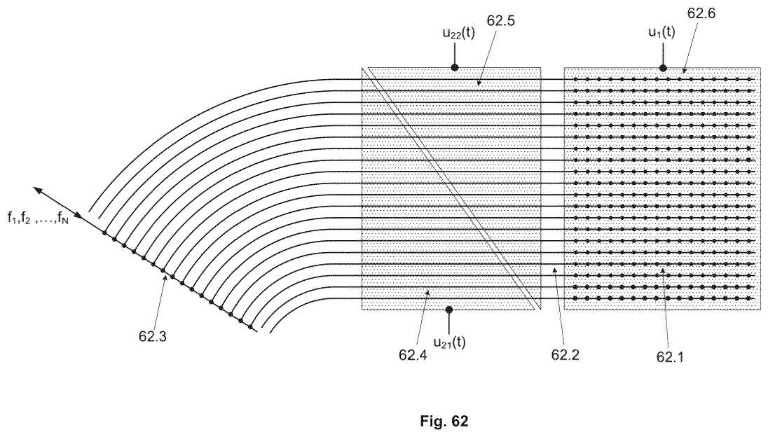

In the previous section, parallel sending and receiving were implemented by multiple inputs of a planar lens operated simultaneously, as a result of which parallelism in the second spatial direction has arisen (i.e. a plurality of pixels with different angles in the second spatial direction and the same angle in the first spatial direction were acquired simultaneously). Alternatively, the parallelism in the first spatial direction can be realized; for this purpose, as illustrated in FIG. 62, a signal is to be used which represents a plurality of different frequencies fₙ, n=1, . . . . N, (e.g. N=32 different frequencies), as a result of which the waveguide array 62.1 radiates in N different directions at the same time, that is to say the signal of a frequency fₙ is transmitted and received in each of these N directions. In order to separate the N different frequencies in the received signal, it is distributed over N mixers with a respective mixing frequency fₙ, n=1, . . . , N (the mixers are not illustrated in FIG. 62); thus, the low-frequency reception signals are at the outputs of the mixers at the respective transmission frequency fₙ, that is to say at the respectively associated beam direction. The N beam directions thus detected in parallel in the first spatial direction are scanned with the aid of a voltage-controlled liquid crystal layer 62.6 over the radiative waveguide array 62.1 in order to address the full capturing range; if the N beam directions of different frequencies fₙ are distributed equidistantly over the entire capturing range, a small range, thus obtainable by the voltage-controlled liquid crystal layer, is sufficient to change the effective refractive index of the radiative waveguides.

The scanning in the second spatial direction is realized by two complementary triangular liquid crystal layers 62.4 and 62.5 above the connecting waveguides 62.2, which are fed from a common waveguide 62.3. The N beam directions in the first spatial direction, which are detected in parallel and belong to different frequencies, have the same beam direction in the second spatial direction, since—seen from above in the figure—the decrease in length of adjacent connecting waveguides 62.2, due to their circular-segment-shaped bend of 360°/(2π)=57.3°, precisely compensates for the distance between their feed points and the common waveguide 62.3, such that the second beam direction is independent of the frequency. Alternatively, a combination of an oblique feed waveguide and in each case exactly the same bends (that is to say also with a constant bending radius) in the connecting waveguides could be used, analogously to the arrangement according to FIG. 53. And instead of a feed waveguide, a cascaded splitter network could also be used to feed connecting waveguides, which would then be straight; however, amplitude and/or phase allocation is then more difficult to realize.

Either different lasers are required to generate the plurality of frequencies fₙ, or a laser which generates an entire frequency comb is used, or different frequencies are modulated onto one laser frequency. Of course, the approach of a signal that includes a plurality of frequencies can also be used in other arrangements in order to realize parallel transmission and reception.

### Scanning by Changing the Effective Refractive Index of Waveguides for the First Spatial Direction and Focusing and Scanning in the Second Spatial Direction Using Non-Waveguide-Based Approaches

For scanning and focusing in two spatial directions, in arrangements according to an aspect of the invention considered earlier, which also refer in particular to FIGS. 20-29, the first spatial direction is implemented by means of frequency scanning by means of one or more waveguides with coupling points, and the second spatial direction is implemented by other approaches, for which at least one optical element is required in addition to the photonic chip (e.g. a lens and/or a liquid crystal element). Instead of changing the radiation of the waveguides via frequency, this can also be done by changing their effective refractive index, e.g. by changing the applied voltage to a liquid crystal layer in the vicinity of the waveguides. In the case of arrangements with multiple waveguides, the same voltage across the liquid crystal material can be used for all of them. Since the achievable change in the effective refractive index via a voltage-controlled liquid crystal layer is limited, arrangements in which there are multiple waveguides for respectively different and thus low width scanning ranges in the first spatial direction—that is to say analogously to the example with scanning patterns according to FIGS. 28 and 29 with a plurality of waveguides realizing different beam angles at the same respective frequency—are advantageous.

One advantage is that, during such scanning by changing the effective refractive index of waveguides with coupling points, the laser frequency can be constant; thus, the laser does not need a frequency tuning capability, and all elements, in particular those required for changing the beam direction for the second spatial direction, can be designed optimally for one frequency (and do not have to be operational over a frequency range and have the required optical properties). Of course, in addition to changing the effective refractive index of waveguides, the frequency can also be changed-either with the aim of increasing the scanning effect or in order to superimpose a linear frequency change on the phase modulation, in particular in order to be able to determine the sign of the receiving frequency in the case of a real-valued mixer.

Accurate Determination of Distance and/or Relative Velocity Given a High Modulation Bandwidth

In close-range lidar systems, a high accuracy of the distance measurement is required. For the distance measurement by means of the phase modulation, a very short modulation time Tₘ is then required, and hence a very high sampling frequency, which also results in a high level of computation complexity. In order to avoid this, a high modulation bandwidth can be used for a linear frequency change superimposed on the phase modulation; then a very accurate distance measurement can be derived from the receiving frequency, provided that the frequency shift produced by the Doppler effect, that is to say the relative speed, is known (according to rel. (12), the receiving frequency is indeed composed of the distance-dependent component resulting from the linear frequency modulation and the component dependent on the relative speed).

An important application for short-range systems is autonomous parking, where the stationary surroundings (infrastructure and other stationary vehicles) is primarily of interest and must be detected with a high degree of distance accuracy. Relative velocity is known for reflections of infrastructure a priori—not only when the ego vehicle is stationary, but also when it is moving, since the relative speed of stationary objects can be calculated from the vehicle's own speed and the angles in both spatial directions.

If the relative velocity is not known a priori, then an approach with two inverse linear frequency changes can be used (e.g. from two successive cycles or from two adjacent scanning planes; this has also been explained in more detail above). By means of the sum and difference of the reception frequencies resulting from the two inverse modulation bandwidths, it is possible to separate the Doppler shift and the distance-dependent frequency component, which allows the relative speed and distance to be determined very accurately; this also prevents a situation in which less accurate distance determination by means of the phase modulation in combination with a high modulation bandwidth leads to a very inaccurate measurement of the relative speed.

### CONCLUDING REMARKS

On the basis of the above application examples, the represented considerations and explanations according to an aspect of the invention can be simply transferred to general designs and parameter interpretations, i.e., they can also be applied to other numerical values. For this reason, general parameters are also frequently indicated in formulas and images.

Some of the new approaches represented are not only new in combination with others, but are even new in their own right with respect to the prior art; examples include:
the approaches for determining and realizing the correction values in order to compensate for the effects of couplings and reflections within the lidar system or its immediate surroundings, in particular a cover, can also be utilized without superimposed frequency modulation,
the approaches with a transceiver unit having one or more waveguides for scanning via frequency in the first spatial direction and a scanner for the second spatial direction can also be utilized in combination with other modulation forms, in particular if the frequency is changed gradually, or even for non-coherent lidar systems,
the approach for determining angular errors (e.g., by changing hardware properties or misalignment of the sensor) can also be made use of in the case of other modulation forms, since it is substantially only based on the inherent Doppler measurement capability of coherent lidar systems,
the approach for determining the position of the road surface at greater distances can also be utilized in the case of other modulation forms, that is to say, for example in the case of pure linear frequency modulation (mostly consisting of two frequency ramps, the slopes of which have opposite algebraic signs); the correlation values utilized are then based on a correspondingly different correlation calculation (in the case of pure linear frequency modulation in the form of one FFT per frequency ramp),
the approach for determining the algebraic sign of the receive frequency in the case of a real-valued mixer with the aid of non-binary phase modulation can also be utilized without superimposed frequency modulation.

1. A lidar system for sensing surroundings, in which
a waveguide array consisting of a plurality of radiating, identical and parallel waveguides with a respective plurality of coupling points or a radiative waveguide surface having multiple, in particular strip-shaped, coupling structures is provided for transmitting and/or receiving light beams, wherein the coupling points or coupling structures serving for radiative emission lie in an approximately equidistant grid,
by changing the frequency of the wave and/or the effective refractive index in the radiative waveguides or in the radiative waveguide surface, the beam direction is swept in a first spatial direction,
the array of radiative waveguides or the radiative waveguide surface is fed from a feed waveguide having a plurality of coupling points,
by changing the frequency of the wave and/or the effective refractive index in this feed waveguide, the beam direction is swept in a second spatial direction, which is preferably-perpendicular to the first spatial direction,
wherein one of the two spatial directions is horizontal and the other is then vertical, and
the waveguide array of the radiative waveguides or the radiative waveguide surface and the feed waveguide are realized on a photonic chip.

2. The lidar system according to claim 1, which operates in a coherent manner and in which a continuous frequency change is superimposed on a modulation, in particular a phase modulation, wherein the continuous, in particular linear, frequency change is carried out within and across pixels.

3. The lidar system according to claim 1, in which the feed waveguide is designed at least approximately as a uniform meander and is coupled, per meander period, via a connecting waveguide, to a radiative waveguide of the waveguide array or to an input of the radiative waveguide surface, wherein the length of the connecting waveguides over the connected radiative waveguides or inputs of the radiative waveguide surface changes at least approximately linearly, being realized such that the axis of the feed waveguide runs straight and the connecting waveguides consist of one or more straight sections and one or more bends, wherein these bends are of the same type across the connecting waveguides and the straight sections run parallel and have the same or linearly varying lengths.

4. The lidar system according to claim 1, in which the feed waveguide is designed at least approximately as a uniform meander and is coupled, per meandering period of the same type, at multiple locations via connecting waveguides to radiative waveguides of the waveguide array or inputs of the radiative waveguide surface, wherein the length traveled by the wave in the feed waveguide and in the connecting waveguide changes at least approximately linearly over the connected radiative waveguides or inputs of the radiative waveguide surface, the axis of the feed waveguide runs straight and the connecting waveguides are formed, if necessary with the exception of the region at the feed waveguide, by one or more straight sections and one or more bends, wherein across the connecting waveguides these bends are each of the same type and the straight sections run parallel and have the same or linearly varying length.

5. The lidar system according to claim 4, in which at least straight sections of the feed waveguides and a respective section of the connecting waveguides have a width that is increased compared to the rest of the waveguides in order to reduce the conduction losses, wherein the section of the connecting waveguides with increased width has in each case such a length that the length traveled by the wave in feed waveguide sections with increased width and in this section of the connecting waveguide changes at least approximately linearly over the connected radiative waveguides or inputs of the radiative waveguide surface.

6. The lidar system according to claim 3, in which the beam direction is scanned in both spatial directions via a frequency change, wherein the meandering feed waveguide is much longer than the transverse extent of the waveguide array of the radiative waveguides or of the radiative waveguide surface, so that a plurality of scans in the second spatial direction are performed during a scan in the first spatial direction, in order to realize a two-dimensional capturing range.

7. The lidar system according to claim 1, in which liquid crystal material is located in the immediate vicinity of the radiative waveguides or of the radiative waveguide surface, of the connecting waveguides and/or of the feed waveguide, in particular superficially above these, the optical properties of which material are influenced by means of a respective applied voltage in order to change the effective refractive index of the radiative waveguides or of the radiative waveguide surface, of the connecting waveguides and/or of the feed waveguide in order to thereby implement a change in the beam direction in the first and/or second spatial direction.

8. The lidar system according to claim 7, in which different frequencies are used to change the beam direction in a rough grid, while only a smaller region is scanned in each case by changing the effective refractive index, whereby a reduced changeability of the effective refractive index is sufficient.

9. The lidar system according to claim 1, in which there is amplitude and/or phase occupancy, that is to say so-called tapering, in amplitude and/or phase via the array of radiative waveguides or the radiative waveguide surface in both spatial directions, in order to keep side lobes in the radiation as low as possible or to avoid them, wherein the amplitude tapering is implemented via couplings of different strengths and the phase tapering is implemented via a non precisely equidistant arrangement of coupling points and/or of radiative waveguides or inputs of the radiative waveguide surface.

10. The lidar system according to claim 1, in which there are further waveguides of the same type parallel to the radiative waveguides and possibly parallel to the connecting waveguides, which further waveguides are not coupled to the feed waveguides in order to avoid or at least reduce the effects through coupling between waveguides.

11. The lidar system according to claim 1, in which a signal that comprises a plurality of frequencies at the same time is used such that a radiative waveguide array or a radiative waveguide surface is sent and received in parallel in different beam directions.

12. The lidar system according to claim 1, in which there are a plurality of radiative waveguide arrays or radiative waveguide surfaces with associated feed waveguides which are connected in series or parallel operation to the same modulated laser source and have different structures, so that they open in different beam directions at least in one spatial direction at the same frequency, whereby the required range of the change in frequency and/or effective refractive index is reduced.

13. The lidar system according to claim 1, in which there are a plurality of radiative waveguide arrays or radiative waveguide surfaces with associated feed waveguides and, for beam deflection, prisms or prismatic partial regions of a larger, common body are respectively located above the radiative waveguide array or radiative waveguide surfaces, in particular in order to obtain a large capturing range and/or a high resolution also in the edge regions thereof.

14. The lidar system according to claim 1, in which deviations in the beam directions can occur, in particular due to misalignment, frequencies which are not precisely known and/or the dependence of the effective refractive index on the respective control variable which is not precisely known, wherein said deviations are determined from the measured radial relative speeds of stationary objects in order to later take said deviations into account and/or to correct them.

15. The lidar system according to claim 14, in which the road surface is used as stationary objects, with determination of its angle in the vertical direction from the measured distance and the sensor installation height.

16. The lidar system according to claim 1, in which the devices for changing the beam direction are provided and used to compensate for a misalignment and/or to adjust the capturing range adaptively, in particular depending on the traffic situation.

17. The lidar system according to claim 1, in which monitoring of the beam direction change or of the devices for changing the beam direction, in particular for ensuring eye safety, is realized by checking received signals for changes in the respective spatial direction in terms of object reflections or in terms of the components of internal reflections and couplings as well as reflections of a cover.
